(19) United States
(12) Patent Application Publication
(10) Pub. No.: US 2005/0055222 A1
(43) Pub. Date: Mar. 10, 2005

(54) Genetic people's health: the biocultural microcomputers and microprocessor toys for grown-ups and kids and for all the world, and the science and technological art of the computerized global humanitarian biocultural genetic 'public health' (health without the medical 'health service')

(76) Inventors: Valery Leonov, St. Petersburg (RU); Pavel Leonov, St. Petersburg (RU)

Correspondence Address: LEONOV, Valery, 47 - 2 - 137, Vitebsky Street,, St. Petersburg, 196 233, RU

(21) Appl. No.: 10/651,008

(22) Filed: Aug. 29, 2003

(51) Int. Cl. G06F 17/60; G09B 19/00

(52) U.S. Cl. 705/1; 434/127

(57) ABSTRACT

What do we, the people, have?—We have only the life. Our proposed BIOcultural microcomputers and microprocessor toys are to remind, what does shorten and depreciate our life. These microprocessor devices, as it turns out, have no analogs in the world are assigned for simple, easy-to-understand self-enlightening of an individual in fundamentals of BIOlogy concerning Life as such, as BIO, as natural phenomenon on the Globe and in organism of everybody. The BIOcultural microcomputers and microprocessor toys—these BIOenlightening microprocessor tools, autonomic and build-in, for instance, into cellular phones and personal computers, by auto-text or other audiovisual means, in playing or serious form, are to remind several times a day, on our private life as a constituent of the global Life, single and exclusive on the Globe and in our organism, non-submittable to us, existing beyond and independently of our consciousness—that is, on its turn, to remind on the existence of the Creator of Life and of us upon it. The databases in the said devises do contain a biological knowledge for an illustration to the user, that the “BIOcultural Way of Thinking” is a method, or an intellectual tool, or a mental technique, helping those who possesses it to come to correct conclusions in an analysis of four the most important and urgent methods for everyone on the Globe independently of sex, age, occupation, race, color of skin and place of residence: firstly, WHAT is correct to eat; secondly, HOW is correct to eat; thirdly, HOW is correct to live; and at last HOW is correct to support and restore the own health,—that is, from the point of biology, physiology and genetics. The algorithms in these devices enable the user to cognize this biological knowledge in an easy playing manner and then, gradually, to induce the user to live more comfortably by the further self-enlightening in the educational subject “BIOculture of the Individual” and by gradual turn to the own “BIOcultural Way of Thinking”.

### CROSS REFERENCE TO RELATED APPLICATIONS

The given patent application is being a further development of the commenced by us in U.S. Pat. No. 6,179,778 B1 (LEONOV et al.) Jan. 30, 2001, Title: Computerized method of health prophylaxis through Food Combining, microcomputer for Food Combining, software product for Food Combining; and of later prolonged by us in the U.S. Patent Application Publication No.: US-2003-0023147-A1 (LEONOV et al.), Publication Date: Jan. 30, 2003, Title: Biocultural microcomputers and microprocessor toys for preliminary self-enlightening of an individual in Bioculture and Natural Hygiene and for subsequent simple, plain, easy-to-understand using of the American Natural Hygienic system.

### BACKGROUND OF THE INVENTION

1. Field of the Invention

1.1. The Genetic People's Health science.

The Field as a whole—clarifies General Provisions and substantiates the necessity of a new science named here as the Computerized Global Humanitarian BIOcultural Genetic ‘public health’ (briefly: Genetic People's Health—Health without the medical ‘health service’).

1.2. The Genetic People's Health principles.

1.3. The Genetic People's Health technique—the BIOcultural microcomputers and microprocessor toys for grown-ups and kids, and a method of production of these devices in the part of preparing theirs internal informative stuffing, and the specialized “Computerized Global Humanitarian BIOcultural Genetic Public Health” Internet-site system as means specially intended for realization of this method.
All parts of the Field are used as internal informative stuffing in production of microprocessor devices (the BIOcultural microcomputers and microprocessor toys) claimed by us.

For the first time, the necessity to clarify the subject and matter with the title “Public Health” (if literally: as “People's Health”—Genetic People's Health—Natural Hygiene—Health without the medical “Health Service”) was set forth brightly and reasonably in the American Natural Hygienic System, which is a generalization of clinical and theoretical sesquicentennial experience of the science of the Natural Hygiene on the American continent.

The American Natural Hygienic System:
1) “Natural Hygiene (The Pristine Way of Life)”, 638 pages;
2) “The Science and Fine Art of Natural Hygiene (Hygienic System: I)”, 420 pages;
3) “The Science and Fine Art of Food and Nutrition (Hygienic System: II)”, 591 pages;
4) “The Science and Fine Art of Fasting (Hygienic System: III)”, 384 pages;
all by Herbert M. Shelton and published by the American Natural Hygiene Society (http://anhs.org).

The American Natural Hygienic System had been elaborated for century and a half in the United States, and it is addressed to everyone on the Earth with its efficiency and prescription. But the actual half-centennial experience further of popularization of this System in America and throughout the world has proved, that such a desirable (broad, mass and universal) publicity of the System is impossible for two following reasons. Firstly, the American Natural Hygiene System-printed in the form of four scientific books—is not interesting at all for the Commerce due to meager profit of books' sale—therefore, broad, mass and universal advertisement of the System is simply impossible. Secondly, if even free copies of Shelton's books on local languages would be put on every table, then 99 men of 100 would not find time, strength and desire to study these 2033 pages of complicated scientific-popular text. To solve these two problems of broad, mass and universal popularization of the System, we proposed, in foregoing Patent documents, an alternative performance of the American Natural Hygienic System-microcomputerized in the form of educative (BIOcultural) microcomputers and microprocessor toys. These devices are, firstly, more attractive for adults and children than 4 thick volumes, and, secondly, microprocessor toys can stimulate the Commerce to advertise these toys and, sore, the American Natural Hygienic System as such.

Having proposed, in the foregoing Patent claims, our technical and technological solution of these two problems (connected mainly with popularization of the American Natural Hygienic System), we make the next step in the mission. Namely, we segregated more generalized and more serious problems of the System, now mostly social, to find more generalized and more earnest ideological, methodological and technological decision, for the American Natural Hygienic System only attracts attention to this problem, but it (as such) seems unable to solve it. We call it “Social Problem of Natural Hygiene and the Individual” for the sake of determination.

This humanitarian problem, was put by us in a center of discussion in our publications, where all technical, technological, and methodological decisions of it were given, including those proposed in the given patent application.
Concepts “BIOculture of the Individual” and “Computerized Global Humanitarian BIOcultural Genetic ‘public health’ (briefly: Genetic People's Health—Health without the medical ‘health service’)” are proposed, as a conceptual decision of the “Social Problem of Natural Hygiene and the Individual”, in our publications:
1) “BIOculture of the Individual, and the Individual Natural Hygiene, and Enlightening Microcomputers & Microprocessor Toys Specially for the Same (Our Not Light Way to Health via BIOenlightenment)”, 2004, 816 pages;
2) “BIOphilosophy of the Individual, the principles of science and art of The Computerized Global Humanitarian BIOcultural Genetic public health, Part 1: Genetic and Biological Essence of the Natural Hygiene”, 2004, 64 pages;
3) “BIOphilosophy of the Individual, the principles of science and art of The Computerized Global Humanitarian BIOcultural Genetic public health, Part 2: Problem of Foodstuffs' Choice as a Social Problem of the Natural Hygiene and the Individual”, 2004, 64 pages;
4) “BIOphilosophy of the Individual, the principles of science and art of The Computerized Global Humanitarian BIOcultural Genetic public health, Part 3: Problem of Choice of a Way of Life as a Social Problem of Natural Hygiene and the Individual”, 2004, 64 pages;
5) “BIOphilosophy of the Individual, the principles of science and art of The Computerized Global Humanitarian BIOcultural Genetic public health, Part 4: Problem of a Dyspepsia Danger”, 2004, 64 pages;
6) “BIOphilosophy of the Individual, the principles of science and art of The Computerized Global Humanitarian BIOcultural Genetic public health, Part 5: BIOculture of the Individual as a Mean of His Self-Defense Against Foolish AntiBIOlogical Proposals of Human Society Commercialized to the Core”, 2004, 64 pages;
7) “BIOphilosophy of the Individual, the principles of science and art of The Computerized Global Humanitarian BIOcultural Genetic public health, Part 6: Genetic BIOcultural Public Health—it is Healthcare Based on the BIOculture of an Individual and His Trust in The Creator”, 2004, 64 pages;
8) “BIOphilosophy of the Individual, the principles of science and art of The Computerized Global Humanitarian BIOcultural Genetic public health, Part 7: Internet Oasis Club: the principles of science and art of The Computerized Global Humanitarian BIOcultural Genetic public health”, 2004, 256 pages.
All these publications were written by Valery Leonov, Tatjana Malish (Leonova), and Pavel Leonov in Russian and issued in the authors' publishing house BIOcult, Saint-Petersburg, Russia.

After these general notes we pass directly to the description of the Field of the Invention. The Field is described in following sub-clauses:

1.1. The Genetic People's Health Science.

The Field as a whole—clarifies General Provisions and substantiates the necessity of a new science named here as the Computerized Global Humanitarian BIOcultural Genetic ‘public health’ (briefly: Genetic People's Health—Health without the medical ‘health service’).

1.2. The Genetic People's Health principles.

1.2.1. Code of the Genetic People's Health.

This part Field of the given patent application contains our concrete theses of the Computerized Global Humanitarian BIOcultural Genetic ‘public health’ principles as our vision of future the Computerized Global Humanitarian BIOcultural Genetic ‘public health’ science (briefly: the Genetic People's Health science—the science of Health without the medical ‘health service’). But, to create and to develop these principles properly, we do propose to biologists and geneticists of the world as a humanitarian assistance to common people of the Globe for solution of the following problem.

1.2.2. “Social Problem of Natural Hygiene and the Individual”.

1.2.3. “BIOphilosophy of the Individual” based on philosophy of Life as BIO, or natural phenomenon on the Globe and in each man's organism.

1.3. The Genetic People's Health technique.

This part of the Field contains theses of the BIOcultural microcomputers and microprocessor toys for grown-ups and kids, and a method of production of these devices in the part of preparing theirs internal informative stuffing, and the specialized “Computerized Global Humanitarian BIOcultural Genetic Public Health” Internet-site system as means specially intended for realization of this method.

All parts of the Field are used as internal informative stuffing in production of microprocessor devices (the BIOcultural microcomputers and microprocessor toys) claimed by us.

The “Social Problem of Natural Hygiene and the Individual” as a global humane problem was raised 50 years ago by the American Natural Hygienic System, but is not solved yet unless our modest attempts in the foregoing Patent claims. We continue to make attempts in the given claim also. It seems that, without humanitarian efforts of the global scientific community, this problem would never be solved—its social roots are too hard for eradication as they threaten to profits of the most powerful corporations specialized in (1) nutrition supply and (2) facilities of health care as a whole. The business on supply of the common public with nutrition and healthcare is very capacious financially as here the finance of the world are acting and do generate the greatest resistance to threat of corporate financial interests. The thorny sesquicentennial experience of popularization of the American Natural Hygiene System in US and subsequent half-centennial popularization of the System throughout the world is an impressive testimony of that.

The matter with, yet unsolved, “Social Problem of Natural Hygiene and the Individual” is the following.

Through corporations' activity—for example, in the sphere of mass organization of human nutrition, or in public healthcare and other spheres of satisfaction of human needs and demands—mutually beneficial economic interactions among separate personalities are appeared and so the modern human society is being formed. For formation of it, the role of corporations is prior. It is poorly understood, however, that, in this servicing individual the by society, financial and economic corporeal interests are prevailing, being laid over the biological interests of human organism. That is, economy and money are dominating above biology and genes. Thus situation is not considered to be reasonable and perspective for the human society as a whole.

Economic and financial interests of corporations are with no doubt important and are to be realized. But human interests, biological and genetic, are also important and are also to be realized. Otherwise, the reasonable balance of corporate interests and biological (genetic) human ones is to be attained, but not enough attention is paid to it except the matters of ecology. That is not enough, however.

The ecology (from Greek “oikos”—homeland, home) broaches the interrelations of the man with the environment, but ecology doesn't deal with the relationship of a man and a society. However, the human society is also an environment for an individual, an environment even more dangerous in comparison with the nature in ecological sense. It's a high time to make some further steps, to broaden ecological problems up to social ones, and, in particular, it's a high time to turn to the reasonable balance of economical interests of corporations and biological interests of man in the sphere of organizing of social nutrition and social organization of health care. In the American Natural Hygienic System, it is said on the necessity and extreme hardship of these steps to reach that balance, and we call it all “Social Problem of Natural Hygiene and the Individual”.

To resist corporate interests, discordant with human health and his biological demands, to hold out against money power for the health of men,—only a might of scientific reason is capable to it: ecology can be an example. But ecology, as a science, protects only the external biological environment of man from the human.

There is no science for protection of the “internal biological environment” of man from the same unreasonableness. Proposed by us, the Computerized Global Humanitarian BIOcultural Genetic ‘public health’ science (briefly: the Genetic People's Health science—the science of Health without the medical ‘health service’) may fill that gap, and the tools, also proposed by us, are able to contribute in popularization of this science among common people including schoolchildren.

Half of a century ago, the might of scientific reason did create the science of ecology to solve the definite problem. Nowadays the fruits of that science of ecology are enough noticeable and are used by common people all over the world. So it is a high time to make a next step in the direction having noticed that, at the very time of rise of the science of ecology, 50 years ago, the progressive physicians of USA raised a problem related to one of ecology but hundred times more difficult and more vital, for it is linked with providing the biologically justified nutrition and health care to the people. For the sake of distinctness, we have called it “Social Problem of the Natural Hygiene and the individual” and we proposed to create the Computerized Global Humanitarian BIOcultural Genetic ‘public health’ science (the Genetic People's Health science—the science of Health without the medical ‘health service’); principles of this science and technical means are given for 1) centralized formation of that science by efforts of biologists of the world, and, 2) for the further popularization of that science among common people that is practically the whole humanity.

The discussed social problem of the “Public Health” (as such—literally: as “People's Health”) is global in its totality, its essence, its depth and necessity; but, having been raised in the American Hygienic System, it was not discussed in other publications and it was not formulated for a practical decision—it was not presented in theory and technique being extremely complicated for comprehension. Our vision of the whole problem, our technical solution of it—all was described in above-mentioned editions in Russian and in given Patent claim. That's why for the explanation of the Field of the Invention we are to spend a lot of words and paper, otherwise it is difficult to get what we are talking about and what is the essence of our proposals.

1.1. The Genetic People's Health Science.

The Field as a whole—clarifies General Provisions and substantiates the necessity of a new science named here as the Computerized Global Humanitarian BIOcultural Genetic ‘public health’ (briefly: as the Genetic People's Health—Health without the medical ‘health service’), as proposed in given Patent claim, theoretical and methodological decision of the social problem of the “Public Health” (as such—literally: as “People's Health”).—This part of the Field is used as internal informative stuffing in production of microprocessor devices (the BIOcultural microcomputers and microprocessor toys) claimed by us.

For every separate person and for the whole human community there is nothing more important than what is hidden in the notions “Health” and “Public Health” (literally: as “People's Health”)—it is evident and it does not require any speculations. It is not evident at all, that real scientific comprehension of these notions is clear and there is no soil for extra meditations. It seems, satisfying means of attained understanding in notions of “Health” and “Public Health” (literally: as “People's Health”) is inadmissible for extreme depth of these interrelated and indissoluble ideas.

It's true, the notion “Public Health (People's Health)” is inseparable from “Health”, notion “Health” is inseparable from the notion “Life”, but the biologists don't know what is “Life”-they cannot give scientific term for this phenomenon of Nature, having referred it to unique and extremely difficult comprehend natural phenomenon. The biologists tried only to formulate a list of features by which living matter (protoplasm filling up the living cells) differ from non-living one, but the exhaustible scientific definition of this phenomenon is too far from perfection. It seems that notions “Life”, “Health”, and “Public Health (People's Health)” would be always clarified. We shall try to define these three notions.

Firstly, human Health is a correct, normal activity of a human organism and nothing more; another comprehension of the term “Health” is beyond the biology's limits, that is it is not scientific, too speculative and too corporative. Secondly, and it is doubtless, “Organism”—is a form of Life existence, as only living organisms represent the Life on the Globe: from microbe and virus to human organism. It is sound: Health is an inner, obligatory, and inalienable attribute of the Life. Really, Life without Health would cease instantly even having originated. So, each organism, and a human one particularly, at the moment of its appearance is supplied by Life and Health, as an inalienable attribute of Life.

Further, 1) Life as a whole with processes of its realization; 2) construction and functioning of organism; 3) algorithms and mechanisms of organism's return from abnormal wrong activity to the normal and correct one, that is algorithms and mechanisms of Health support within the organism,—all above-mentioned, 1, 2, and 3, exist beyond and independently from human consciousness, it exists as a foundation of the Man himself and is located out of the Man's competence. Otherwise, a man cannot improve all the above-mentioned—1), 2), and 3)—but he is capable to spoil it if his technical, social and private activity is not based on natural laws and requirements. From it, the second logical conclusion follows: Health in a human organism as well as Life within it comprises the reality to any man and it requires reason and attention in its application the from the man, otherwise this reality will transform into worthlessness.

At least, the third completely logical and practical conclusion is drawn: blind, unreasonable and too confident habit to purchase the artificial health in drugstores and clinics—is the most vicious and dangerous habit from the point of biology, inoculated for the financial enrichment of corporations specializing on artificial health. Non-artificial Health as such (or, more correct, normal activity of organism of given individual) can be found in no drug stores or medical clinics. Non-artificial Health (correct normal activity of organism) can be assisted only by the reason of the individual on the base of biology, physiology and molecular genetics, that is an individual can create his own health himself—his health and reason-mind are not market goods. The logic of all above is contended and simple but it doesn't evident to everyone, therefore we shall repeat it in a bit another way.

The Life as such, as a phenomenon of Nature is exclusive and unique for all the living organisms on the Earth. In any organism the base of organization of Life is common and sole. Namely, this base of Life in any organism is genetic one, that is, in so-called genes (particles of DNA molecules) from those and only from them, the Life as such is started. Genes are material bearers of genetic information and operators of its realization 1) for support of the organism in a living state, 2) for supporting the correct and normal activity of an organism and 3) for turning back the organism to healthy state if its activity has came out of narrow limits of normal activity. The any and the every organism is generated from its genes, which are obligatory given at the moment of its birth, without which it is not existing under which control it is functioning and even is utilized after death. The Human organism does not differ from the other organisms on the Earth.

The first conclusion: genes in general and human genes including are the receptacle of huge information of Nature's experience in Life support during Its existence on the Globe.

The second conclusion: this genetic information on support of Life and Health in human organism has no relationship to the scientific information on support of Life and Health in human-genes and coded information have appeared, are existing and operating beyond and independently of human consciousness.

It means that, from size and quality of scientific information on Life and Health layout and to the size and quantity of genetic information on Life and Health layout, the distance is not less than from ground to skies.

The third conclusion: it is reasonable and useful to bear always in mind the very size of this distance. It is reasonable and useful to shorten this distance scientifically, to understand better the Nature and a role of a Man as a component of living nature and leader in its development, always remembering that no Man and no science can rise over the Nature or substitute the latter or subordinate it—this is the essence of the Nature and sciences dealing with it; natural laws are open to notion, but inaccessible for alteration. Modern orthodoxal medicine obviously ignores this elementary truth, acting as a rival of Nature in normalization of human organism's activity.

Modern orthodoxal medicine advertises intensively its paid drugstore pills alien to the human body and its paid services in diagnostics and prescriptions for these pills having forgotten or been intentionally silent on that such commercialized actions in alien interference in human organism's activity being an arrogant praising of man and his actions against the Nature and nature's activity in a human organism.

We are repeating, for physicians, the biological truth (either they refuse to notice or they don't want to announce to patients): total genes and human beings' genes—are a receptacle for a huge amount of information on the Nature's experience on support Life (and Health!) during its existence on the Earth. This genetic information has no relation to the scientific information—genes and the information codified within them have appeared, do exist and are acting outside and independently of the conscience; these genes create the man, form the construction of a human organism and supplied it with Life and Health as Life's attribute. The questions arise—what is the role of physicians, their commercial goods and services, how do they compete with Nature, how has medical scientific information succeeded upon the genetic information on normalizing of organism's activity? Why these matters are not discussed widely on easily understood to common people? Is not the ability to explain the essence of the matter briefly, simply to everybody, the criterion of real understanding the matter by the same specialist? Is it possible that these problems are not discussed in the audience due to hypocrisy of the physicians and not to damage corporative financial interests of the medicine?

Yes, to prevent damage of its financial interests, the medicine covers with silence the natural (biological, physiological and genetic) remedies and mechanisms of support and recovery of Health as normal, regular activity of organism. This hypocrisy seems to be logical from the commercial viewpoint: the profit from enlightening is an absolute zero in comparison with the profit of sales of medicines and prescriptions. Such situation of modern “Commercial (medicinal, pharmaceutical) public health” is not logical, plausible and has no biological perspective: from the viewpoint of biology and genetics, the “Health” cannot be an object of sale in drugstores and medicinal clinics, but it would be an object of scientific study and of further popularization of these knowledges among people; by the means of choice of 1) foods, 2) way of eating and 3) way of life the people may help to natural means and mechanisms of support and recovery of Health as of normal activity of organism, but they would not run to drugstores and clinics in case of the slightest indisposition—the latter suits greatly orthodoxal medicine and the corresponding corporations but it is contrary to the needs of human organism being the same in all the persons including physicians, owners and workers of those corporations. Nowadays, economic and financial interests of corporations are dominating and are placed above biological interests of human organisms; economy and money are still prevailing over the biology and genes. This situation is not reasonable and perspective for human society's development.

The logics of the above mentioned is simple and non-disputable but not evident to an ordinary person, that's why he does not understand that medicine cannot substitute the biology and genetics and “Commercial (drugstore, medicinal) public health” cannot substitute “Natural (genetic, biological) public health”. At the base of “Medical ‘public health’ (‘health service’)”, Commerce and Money lay, while the base of “Real (genetic, biological) ‘public health’-Genetic People's Health” are Nature and Genes. The distance between the first and the second is like between the earth and the sky. But we are living on the Earth and not in the Sky and we are to look for the way to turn “Public Health” (as such—literally: as “People's Health”) from the rails Commerce and Money on the rails Nature and Genes, in other words, from commercial-medicine basis onto the enlightening-biological and genetic one. (Linguistic references: genetic—referred to genesis; genesis, from Greek “genesis”—origin, beginning; gene—part of DNA molecules and bearer of vitality genetic Program).

Let us repeat once again: genes of human organism are a receptacle of the huge information of Nature's experiment on support of all the Life (and Health!) for the time of its duration on the Earth and this genetic information has no relationship to the scientific information—the distance is not less than from Earth to Sky between the volume and quantity of scientific information to the volume and quantity of genetic information on organization of Life (and Health!). We repeat again—for everyone and for the whole humanity nothing is more important than “Health” and “Public Health”. Again we say: we are looking for a way to transfer “Public Health” from the questionable rails of Commerce and Money on to Nature and Genes rails—we are to look for a way to turn the Public Health (as such—literally: as “People's Health”) from medicinal basis onto the biological, physiological, genetic one.

But all above mentioned is a theory, logics, philosophy not a practice. Common people, being far from serious sciences, including schoolchildren—that is practically all humanity—are not interested in the theory of the “Public Health” but in its practice. One can ask, how would real “Public Health” (as such—literally: as “People's Health”) look like practically, being based on Nature and Genes not on Commerce and Money. It is not an idle question: practically everything beyond the limits of Commerce and Money looks like as non-applicable and utopian . . . we shall attempt to find the logical adjectives to real (natural, scientific-biological) “Public Health”, to observe its practical method of application, way of its usage by an ordinary person (Health without medical “Health Service”) based of scientific-biological and genetic knowledge, but not upon commercial-medical and pharmaceutical money (Health via medical “Health Service”).

On our opinion, the real (natural, scientific-biological) “Public Health” is to be somehow an independent branch of biology and molecular genetics, a kind of new science called: the Computerized Global Humanitarian BIOcultural Genetic ‘public health’ science (briefly: the Genetic People's Health science—the science of Health without the medical ‘health service’). We shall try to substantiate such a name for making it practical “Public Health” (Health without medical “Health Service”) being really human (genetic-invented and prescribed by the Nature) not corporate (monetary-invented and prescribed by the Commerce). Ordinary people, distant from serious sciences, including schoolchildren (practically all humanity) urgently need now, that the scientific community will reorient them in “Public Health” from the doubtful “rails” of Commerce and Money onto Nature and Genes “rails”. It is the worldwide scientific community (1% of humanity) is to take care of 99% (where third consists from children, future of humanity), for nobody else can do it.

So, we shall try to substantiate the proposed concept of Computerized Global Humanitarian Genetic BIOcultural ‘public health’ (briefly: the proposed concept of Genetic People's Health—the concept of Health without the medical ‘health service’) within those limits the content and technical proposal of given patent claims is laid.

We are talking on “Health” and on “Public Health” as well. The accepted combination of words, “Public Health”, if it is interpreted literally as “People's Health” is a very successful one, as it emphasizes biological truth: Health as an inner attribute of Life, as correct and normal activity of organism—the reality given to everyone by the Nature for support of the Life and Health as the inner unalienable attribute. That's why this natural reality is located out of Commerce and Money. To protect this natural reality (correct and natural activity of organism) must the man—owner and user of this organism, owner and user of his own life but not alien persons, physicians for instance, being anxious firstly in sales amount and convincing the man on their ability to compete with Nature in the normalization of the Health (as the “Correct and Natural Activity of Organism”). Biologists and geneticists assure in reverse order: the Man as such can not compete with the Nature in the normalization of Health (“Correct and Natural Activity of Organism”), otherwise, medical means cannot principally compete with the genetic means. Natural Laws in the human organism can be learned and followed by for the sake of support and recovery of Health by the means of organism, but not to compete with Natural Laws for Money, not to substitute these laws and their natural requirements by various commercial profiteering and artificial pharmaceutical stuffs, alien for human organism, for genes, for codified information on normalization of the organism's activity. Questions of “Health” (“Correct and Natural Activity of Organism”) and “Public Health” (as such—literally: as “People's Health”) are referred to BIOlogy (logics of Life as BIO, as natural phenomenon) simultaneously these questions are situated in economy (logics of money). Now these matters are combined with each other as biology and economy are coincided, that is, not combined at all, possibly a bit in the matters of ecology.

Further we'll follow the BIOlogy (logics of Life as BIO, as natural phenomenon) but not the economy (logics of Money). That's why word combination “Public Health” accepted here is treated not as “Health Service” but as “People's Health” (“Genetic People's Health”, Health without the medical ‘health service’)—a prerogative of man's property and his private care, possible to study and impossible to trade. So “Public Health” is directed entirely on the Nature, genes and mind-reason of a man. Otherwise, “Public Health” is completely linked to biology, physiology and molecular genetics but not to medicine incapable to substitute the biology's separate branches, or a whole biology. The elaboration of “Public Health (People's Health)” may be scientific: BIOlogical, physiological, genetic but not commercial-medicinal. “Biological (genetic) ‘public health’” accepts the human organism as an undivided entity and organism,—it is presumed, that an organism is supplied by the Nature by genetic means of Life and Health support as Life's attribute, when “Medicinal (commercial) ‘public health’” treats an organ separately of entire organism, using means and service of non-natural (non-genetic) but of a commercial (medical) origin.

Further it seems logical to the “Genetic” ‘public health’ (Genetic People's Health) to add an adjective “BIOcultural” [our term “BIOculture of the Individual” is explained in details in the U.S. Patent Application Publication No.: US-2003-0023147-A1 (LEONOV et al.), Publication Date: Jan. 30, 2003, Title: Biocultural microcomputers and microprocessor toys for preliminary self-enlightening of an individual in Bioculture and Natural Hygiene and for subsequent simple, plain, easy-to-understand using of the American Natural Hygienic system].

As it has been noticed, “Health from Nature” and “Genetic ‘public health’ (Genetic People's Health) from Nature”—is a reality given to everyone, it is a property, given to him by the Nature, with the organism and all the bioprocesses within to support Life and Health (“Normal Correct Organism Activity”) and man himself may and has to guard this natural given reality (“Normal Correct Organism Activity”), being an owner and user of the organism, and not the alien persons, physicians for example. Nobody can reside life instead of the other person, nobody is capable 1) to choose instead biologically, physiologically and genetically justified foods of anybody else, 2) to choose the physiologically justified way of eating, 3) to choose genetically justified way of living instead of the other person—these three choices (foods, way of eating and living) do determine the Health as a correct normal activity of a human organism. To eat and drink all the proposed by the Commerce and its refined advertisement, to lead the life proposed by the Commerce and then to be treated by medicinal drugs and services proposed by the Commerce and advertisement,—it is not the best vital position for a reasonable person, that's why there is a necessity and utility of BIOeducation and BIOculture as a compound and main part of a general culture of any individual living in a completely commercialized society where everything is bought and sold: drugs, tobacco, alcohol, human body, separate organs and whole life, decisions of judges and officials, parliamentary laws and state decrees. We repeat: the matters of “Health” and “Public Health” are laying in biology (logics of life) and simultaneously in economy (logics of money), but nowadays these spheres are not coincided absolutely. We repeat: the common people—practically all the humanity! practically all the humanity!!—are needing urgently, from the scientific community, to reorient them in the matters of “Health” and “Public Health” from Commerce and Money to Nature and Genes, from logics money to logics of Life in the sense of BIO, from commercial Medicine to educational BIOlogy (logics of Life). Urgent, mass and total BIOeducation is a necessity of worldwide scientific community, as, firstly, it is absolutely required and, secondly, nobody else can do it.

So, real (biological, physiological, genetic) “Public Health” can only be the BIOenlightening, in other words, it must be the “BIOcultural Public Health” [see our book “BIOculture of the Individual, and the Individual Natural Hygiene, and Enlightening Microcomputers & Microprocessor Toys Specially for the Same (Our Not Light Way to Health via BIOenlightenment)”, 2004, 816 pages].

Further, an adjective “genetic” is suitable to add to “Public Health” due to the following reason. There is no Life outside the genes. No Health exists outside the Life. There is no Public Health outside the Health. Public Health is to be genetic; it is an area of applied Molecular Genetics, being advanced branch of Molecular Biology, based on the experimental and theoretical ground of the Biophysics. There is no place for an Orthodoxal Medicine here. The Public Health as such—is a Genetic Public Health, other options are unnatural now, being obsolete, not coincident with the modern state of a science on Life understood as a BIO. Life is to be understood as a BIO, as a natural phenomenon, both Life as a whole, on the planet of Earth, and, at the same time, inside the every organism, for the Life as a BIO, as a natural phenomenon is the one, the unite and the common for all the living creatures on the Earth—this is a very important moment in the question of healthcare, and we shall mention it later, for the underestimate of this fact leads to the greatest losses in the health of an every human being. From the viewpoint of biology and genetics, the real “Public Health”, both in its scientific elaboration and in the prospects of its further application by common people, may occur only as the “Genetic Public Health”, that means: “Life is created under the conduction of genes”, “Health (as Correct Normal Activity of Organism) is created under the conduction of genes”, “Public Health is created under the conduction of genes”—it all is at first a subject of molecular genetics, but not of medicine, and, secondly, it treated like a certain limited resource for an organism, which may be used reasonably or not reasonably.

So, “Public Health” is to be the “BIOcultural Genetic Public Health”, both in its scientific elaboration and in its further application.

As molecular genetics is referred to fundamental sciences, the science “Genetic Public Health” belongs to the same category; concerning the practical usage, “Genetic BIOcultural Public Health” is an enlightening (cultural, or, more correct, BIOcultural) subject. But, as it is known, neither fundamental studies nor culture are able to bring the money rapidly, so they are off the interest of the Commerce. The humanity is however unable to survive with money only, with no reason, no fundamental sciences and no common culture of the people. Because of the same reason and in the same degree, the humanity is however unable to survive without the “BIOcultural Genetic Public Health”, also. The current “Public Health” is practically incarnated into the plenty of drugstores and medical clinics, that is: colossal financial interests of specialized corporations are laid into the basement of practical “Public Health”, so these corporations are not sparing money for massive and total advertisement of current commercial-medical “Public Health”. The common people have even no idea of the existence of non-commercial “Public Health”, having no habit to be based on their own knowledge of school-level biology and genetics, and being satisfied with the commercial advertisement of current “Public Health”. It all is so mighty and common, that even a child, just being born, is well knows on the existence of pills and physicians, while common people, have even no guess of existence of “Genetic Public Health” in an every human organism.

Preservation of such a state of things, in the human society, is evidently unpromising and rather alarming. The mightiest corporations are interested in it, not the common people including the staff and shareholders of these corporations, for the human organism is just the same for all of the people.

Then, for the “BIOcultural Genetic Public Health”, by its nature and essence, lays off the Commerce, the advertising of “BIOcultural Genetic Public Health” will not be financed by anybody ever, and this is the bitter truth of our highly commercialized life. Therefore, the majority of a human race including medical men and businesspeople themselves, have no guess on the existence of “BIOcultural Genetic Public Health”, paying for that BIOignorance with the health loss. Nobody will ever finance the advertising of the “BIOcultural Genetic Public Health” for it is unable to bring even a millionth part of profits of the modern “Public Health” (“Medical Public Health”). And, if the “BIOcultural Genetic Public Health”, as an enlightening subject, is unable to bring a noticeable profit, then practically all the humanity will never learn to use the “BIOcultural Genetic Public Health”? Perhaps, it would be so. It is a bitter truth of a modern community based entirely on the Commerce, so that practically all the people are firmly convicted: “Money rule the world”. And only the paltry minority of the human race, the global scientific community, is absolutely convicted: reason rules the world. In other words, if the human majority would learn to use the BIOcultural Genetic Public Health, it would be the absolute merit of the global scientific community, and first of all, the humanitarian contribution of biologists and geneticists to the improvement of organization of modern human society to reasonable, so to speak, BIOlogistical development. The humanity seems unable to remain without this humanitarian contribution—they say, the XXI^{th} century will be the first of the long expected “Era of Biology”, when interests of the corporations will receive more humanitarian features, i.e. these interests will follow the requirements of Life in spite of profits: the worldwide ecological movement has already started, but more determined steps are necessary.

So, from the viewpoint of biology and genetics, as well as from the viewpoint of urgent necessities of individuals and the whole human community, the true “Public Health” is to be the “Humanitarian BIOcultural Genetic Public Health” with roots in biology and genetics and with enlightening activity of world biologists and geneticists, similar to their activity in matters of ecology.

Pathway of the realization of ecology was and remains rather difficult due to resistance of separate industrial corporations. Realization of the Humanitarian BIOcultural Genetic Public Health will be much more difficult for desperate resistance of food and medicine corporations—they are the most powerful financially and most influential in the engagement of legislative and executive authority, and of mass media also. It is evident and quite natural, that the turn of “Public Health” sources from commercial medicine into biology and genetics is inevitable but it will face with a huge resistance of corporations not interested in a future progress—this is a global problem on establishment of “Humanitarian BIOcultural Genetic Public Health” waiting for the decision of worldwide scientific community. We repeat: matters of “Health” and “Public Health” are located in biological sphere (Life logic) and in economic sphere also (Money logic), but now these spheres are absolutely incompatible. Once again we say: practically all the humanity needs urgently to be redirected by the worldwide scientific community, on a humanitarian base, from “Public Health” of Commerce and Money on route of Nature and Genes, i.e. from “Money logic” to “Life logic in BIO, in human culture, in BIOculture”. Vital, mass, and total BIOeducation does remain a duty of the worldwide scientific community, for it is to be done and nobody can do it except the scientists.

So, the adjectives “BIOcultural”, “Genetic” and “Humanitarian” are to be pertinently added to the term “Public Health” for its widened scientific interpretation and development, and for its further application; the attribute “Global” is to be added due to the following reason.

The clarifying of notion of “Public Health” to the “Global Humanitarian BIOcultural Genetic Public Health” is caused not only by the fundamental achievements in molecular genetics over the threshold of XX-XXI^{th} centuries, but with social circumstances typical for this time span, producing the phenomenon of “globalization”. The interest to the term is generated by the following reasons.

Modern level of the humanity's organization is gradually and inevitably comes out of the frames of separate nationalities, nations, and states and, then, becomes global—the Western Europe has demonstrated it obviously and visibly. Globalization of capital, globalization of economic interaction of people and countries, globalization of organization of all human community—these processes are quite natural and inevitable in the essence for the globalization is to unite the reason and intellect of the humanity increasing their might and useful practical realization, useful both for separate personalities and for separate countries and so being progressive and natural.

Any progress is linked, of course, with the substitution of the old by the new and it does not occur painlessly—it is always hard to refuse of accustomed old and to go over to more developed. Here many problems and defects are being exposed, which were previously being invisible or decision of which was not actual.

Among the problems and defects revealed and uncovered by the globalization process in modern humanity, first rate ones are problems connected with “Public Health”, as Life and Health are absolutely paramount for everybody and for the whole human community.

The XXI^{th} century will be an “Age of Globalization”—the age of decision of urgent problems by joint efforts and united intellect of the humanity. For instance, the ecological movement is global and common nowadays, but not private and national, and it has global means of impact and separate states and corporations are to obey to human community and to make financial contributions ecology. This is one of the achievements of globalization process.

The globalization of the capital, the globalization of the human relations, the globalization of the mechanisms of community building—all these processes of globalization are seeming to be natural and unavoidable, for they (these processes) are uniting the reason and intellect of the whole humanity and sore increasing the might and efficiency of the reason. It seems to be evident, that the globalization of the economic mechanisms is impossible without the merger or a fusion (or the common denominator) of the Western and Eastern civilizations, without the globalization of the spiritual heritage especially as of the Bible and the Koran, with which the humanity is not parting for the next millennia and with which it will hardly part in the future.

Yes, the Western and Eastern civilizations are different. They are, however, unite because of the unity of the Man as such. That's why the way to the Globalization is opened here.

Yes, the Bible and the Koran are different. They are, however, unite because of the unity of the God as such. That's why the way to the Globalization is opened here, too.

Yes, the way of life and the very scale of spirituality of the Western and Eastern people are different, in particular in the area of spiritual culture, in the understanding of the woman's role in a basement of a family life, in the relation to an alcohol and so on. They, the Western and Eastern people, are, however, unite because of the unity of the human Health as such, for it is unite for the every human organism and for it depends on the human way of life, first of all. That's why the way to the Globalization is opened here, too.

And, moreover, all the processes of the economic and managerial globalization are to be initiated, reasonably, starting from the search of the reasonable common denominator of the spiritual cultures, that is: from the best or the logicalmost and reasonablemost of the Western and Eastern cultures. That means, the logicalmost and reasonablemost from the viewpoint of the Biology and Genes, not of Commerce and Money (first the Health, then the rest).—This is the miraculous motive for the Western and Eastern cultures to leave the announced pathway of force, bellicosity and deadlock, and to enter the perspective, reasonable and concordant pathway (first the Health and the Reason, then Commerce and Money, for it is hard to live with no money, but it is impossible to live with no health).

Some suitable linguistic reference. The Culture is a combination of the human achievements in the areas of production, social life and intellectual life. The cultural means the occupying a relating high level of culture. The spiritual means the relating to an intellectual activity and to the spiritual area. The spirit is an element determining the behavior and the psychical abilities of a human being, its internal moral force. The conscience is a human ability to think, to meditate and to determine an attitude to the reality. The thinking is a process of reflection of the objective reality in the intelligible terms, notions and judgments. The Man is a living creature having the abilities of thinking and speech, an intellectual leader of living matter's development, the leader of Life development and its master on the Earth. Life is a specific form of an existence and movement of the matter, revealed in the existence and activity of organisms, including the human one. Matter (and Life! as a form of movement of the matter) is an objective reality existing beyond and independently of the human consciousness;—that is this point, these circumstances are a solid motive of necessity to talk on science and religion, spiritual culture and spiritual heritage of humanity, as on the excellent mark in the human activity and the reliability of this mark and its non-contradictive character (with the scientific reference points) has been checked with centuries;—that is why one should find firstly the common denominator in spiritual culture of the East and the West, otherwise the globalization process may face with the insurmountable obstacles.

And the science of “Global Humanitarian BIOcultural Genetic Public Health” may serve as such a common denominator, for it first talks about the human way of life, and spiritual culture as such talks about the same: the way of life, that, in its turn, determines the man's health. The ways of life preferred in the East and in the West are differed strikingly, but the human organism is single, the sciences of biology and genetics are the same, but the spiritual marks and relations to the heritage are clearly different. What way of human life is more reasonable from biology's and genetics' points, what way of life is more preferable for human organism? The reply would be given by the science of “Global Humanitarian BIOcultural Genetic Public Health” and it (the science) may be an independent and objective arbiter in the discussion of persons preferring spiritual cultures either of the East or of the West. The already advertised solution pathway of force and bellicosity seems to be a blind alley. The decision of the discussion in the frames of “Global Humanitarian BIOculture Genetic Public Health” science is perspective in its definition, as in biological notion everybody is Homo sapiens (Human thinking being) whose occupation is better at the negotiation table than in the field of battle and blood.

Processes of globalization accelerate the appearance of “Global Humanitarian Genetic BIOcultural Public Health” science on the base of respect to no contradiction and reciprocal addition of biology and religion. On the other hand, creation of this science will smooth the pathway of Globalization and clean off stones and prickles from its hard but inevitable route.

To sum up, the authors of given Patent claim are proposing, at “Globalization Age”, to talk of “Public Health” only in the frames of the “Global Humanitarian BIOcultural Genetic ‘public health’ concept (briefly: the Genetic People's Health concept—the concept of Health without the medical ‘health service’)” instead of the current “Commercial-Medical ‘public health’ (the concept of health via the medical ‘health service’)”. We repeat: blind, unreasonable and too confident habit to purchase the artificial health in drugstores and clinics—is the most vicious and dangerous habit from the point of biology, inoculated for the financial enrichment of corporations specializing on artificial health. Non-artificial Health as such (or, more correct, normal activity of organism of given individual) can be found in no drug stores or medical clinics. Non-artificial Health (as the “Correct and Natural Activity of Organism”) can be assisted only by the reason of the individual on the base of biology, physiology and molecular genetics, that is an individual can create his own health himself—his health and reason-mind are not market goods.

In particular, only within the Global Humanitarian BIOcultural Genetic ‘public health’ concept, it is possible to decide global all human, universal “Social Problem of Natural Hygiene and the Individual”, which had been set 50 years ago in the American Natural Hygienic System and remains still unsolved yet; it seems, that without humanitarian efforts of worldwide scientific community this problem will never be solved as so hard are its social roots, eradication of which may destroy the financial basement of the most powerful corporations. To withstand money power, only the only power of scientific reason is able—ecology is an example.

A modest mite in the solution of “Social Problem of Natural Hygiene and the Individual” is contributed by authors of the given patent application, having continued further development of started in U.S. Pat. No. 6,179,778 B1 (Leonov et al.), Jan. 30, 2001, Title: Computerized method of health prophylaxis through Food Combining, microcomputer for Food Combining, software product for Food Combining, and later prolonged in the U.S. Patent Application Publication No.: US-2003-0023147-A1 (LEONOV et al.), Publication Date: Jan. 30, 2003, Title: Biocultural microcomputers and microprocessor toys for preliminary self-enlightening, of an individual in Bioculture and Natural Hygiene and for subsequent simple, playing, easy-to-understand using of the American Natural Hygienic system.

To formulate the essence of our efforts, we are trying to add an adjective “Computerized” to denoted concept of “Public Health”, that is to say on Public Health within the limits of the Computerized Global Humanitarian BIOcultural Genetic ‘public health’ concept.

The essence of our inventory efforts is in following:

The Computerized Global Humanitarian BIOcultural Genetic ‘public health’ science is based on the principles of biology, physiology and molecular genetics. For practical application it is addressed to common people including schoolchildren who are far from biology, genetics, and any serious sciences.

It is clear, that common peoples will never take in hands the editions of the Computerized Global Humanitarian BIOcultural Genetic ‘public health’ science, surely 99 people of 100 will find no time and no strength to learn it completely, otherwise it seems impossible to get success.—This is the first problem of popularization of the Computerized Global Humanitarian BIOcultural Genetic ‘public health’ science, if it is proposed in traditional book form being directed to common peoples including schoolchildren.

Besides, the Computerized Global Humanitarian BIOcultural Genetic ‘public health’ science in a form of a scientific book will have no interest for the Commerce, the commercial advertising will be insignificant, and therefore common public will not know about this science.—This is the second problem of popularization of the science: in a form of a thick scientific book it is absolutely non-attractive for the Commerce.

These two problems of popularization of the Computerized Global Humanitarian BIOcultural Genetic ‘public health’ science-printed (in a form of a scientific book) make absolutely senseless the idea for self-enlightening of common people and schoolchildren. Where is the exit?

It exists surely, as the exit is purely technological or technical: so, how, in what form are these scientific knowledges to be popularized among the ordinary people if generally accustomed method does not suit?

In the given Patent claim, we propose, for practical application, firstly to formulate the Computerized Global Humanitarian BIOcultural Genetic ‘public health’ science in form of principles (condensed but convincing and understandable to everyone) and secondly to refuse from the Computerized Global Humanitarian BIOcultural Genetic ‘public health’ science-printed having substituted it by an alternative to the Computerized Global Humanitarian BIOcultural Genetic ‘public health’ science-microcomputerized.

For the accomplishment of that, we propose the specialized enlightening microcomputers and microprocessor-toys as future embodiments of the present innovation. These devices are presented firstly as microprocessor-toys for the Computerized Global Humanitarian BIOcultural Genetic ‘public health’ science, permitting to their user to pay attention on the science, on the level of his own BIOculture and on the necessity of his own BIOeducation and later on, as in a playing manner to start the usage of the Computerized Global Humanitarian BIOcultural Genetic ‘public health’ science for the support and recovery of own health. Otherwise, we propose the Computerized Global Humanitarian BIOcultural Genetic ‘public health’ science-microcomputerized as an alternative to the Computerized Global Humanitarian BIOcultural Genetic ‘public health’ science-printed, that is, for popularization of the science, we propose not the thick scientific books (absolutely non-attractive for the Commerce), but more profitable goods as “microprocessor toys for grown-ups and kids” useful for any individual businessman or non-businessman, physician or non-physician, atheist or believer, resident of East or of West, as the Computerized Global Humanitarian BIOcultural Genetic ‘public health’ science is useful to anybody, for the human organism as such is similar in everyone.

This is our the Computerized Global Humanitarian BIOcultural Genetic ‘public health’ concept (briefly: the Genetic People's Health concept—the concept of Health without the medical ‘health service’). These are our motifs of urgent necessity of creation of the Computerized Global Humanitarian BIOcultural Genetic ‘public health’ science (briefly: the Genetic People's Health science—the science of Health without the medical ‘health service’) by humanitarian efforts of the worldwide scientific community.

These motifs of our innovational activity within the frames of the given Patent claim. This is the whole Field of the invention. Now we shall start a detailed description of the constituents of this Field.

1.2. The Genetic People's Health principles.

1.2.1. Code of the Genetic People's Health.

This part Field of the given patent application contains our concrete theses of the Computerized Global Humanitarian BIOcultural Genetic ‘public health’ principles as our vision of future the Computerized Global Humanitarian BIOcultural Genetic ‘public health’ science (briefly: the Genetic People's Health science—the science of Health without the medical ‘health service’). But, to create and to develop these principles properly, we do propose to biologists and geneticists of the world as a humanitarian assistance to common people of the Globe for solution of the following problem.

1.2.2. “Social Problem of Natural Hygiene and the Individual”.

1.2.3. “BIOphilosophy of the Individual” based on philosophy of life as BIO, or natural phenomenon on the Globe and in each man's organism.

All these parts of the Field are used as internal informative stuffing in production of microprocessor devices (the BIOcultural microcomputers and microprocessor toys) claimed by us.

The definition and the meaning of the Computerized Global Humanitarian BIOcultural Genetic ‘public health’ science (briefly: the Genetic People's Health science—the science of Health without the medical ‘health service’) are given below as principles being a kind of certain embryo of the coming science.

### Code of the Genetic People's Health

The 1^{st} principle of the Genetic People's Health and of the “BIOphilosophy of the Individual” (Individual is now under condition of human society commercialized to the core):
We shall discuss the human health from the position of biology, physiology and genetics, that is we shall discuss the human health as a normal correct activity of an organism—organism as a certain device already ready and arch complex, living (not hand-made), made by the Nature independently from the human consciousness and given to a man since his birth for approximately 100 years of exploitation. For a normal and correct or an abnormal and non-correct exploitation of our organism (as of a ready device given for usage) the Nature, as the Creator of the device, has no responsibility; for literacy of usage of our organism in external environment, the Nature put complete responsibility on our mind-reason and consciousness, thus simulating self development of both mind-reason and consciousness of each of us. But the inner functioning of our organism, its efficiency, its correct and normal activity (read: its health) as of a ready arch complex living device—this all is achieved by the Nature, firstly out of and independently of our mind-reason and secondly beyond of the consciousness of the Man as such. Thus, within the organism, we have the Nature's reason and, out of it, there is our reason: “What I want, I eat” (our choice of food, is it reasonable or not, biologically justified or not), “How I want, so am I eating” (our choice of the way of eating, reasonable or not, physiologically justified or not), “How I want, so am I living” (our choice of way of life, whether is reasonable or not, genetically justified or not).
This is the first principle of the Computerized Global Humanitarian BIOcultural Genetic ‘public health’ (briefly: the Genetic People's Health—Health without the medical ‘health service’). Detailed commentary of this principle is given below.

The following analogy is completely appropriate. We purchase a car as a certain device ready for usage, it has own constructor-creator, completely responsible for the car's efficiency, for its normal and correct activity (read: for its “health”). But the responsibility for normal and correct usage of this car is laid completely on our own mind-reason. Really, even the finest and the most powerful car refuses to work normally (“falls ill”), 1) if its “food” is not good enough, 2) if its way of driving is not normal enough, 3) if the road we have chosen is wrong. It is completely analogical, that the best and the most powerful organism refuses to work normally (“falls ill”): 1) if the food is wrong, 2) if the way of eating is not normal, 3) if the way of living is not correct. So we shall discuss further: 1) the biologically and genetically correct choice of food, 2) the physiologically justified choice of the way of eating, 3) the genetically justified choice of the way of living.

So these three choices (food, way of eating, way of living) are given to a man by the Nature for his own health support, other means of health support and recovery are not from the Nature-Creator but from Satan. Really, if we had purchased a car as a ready industrial product and we should have tried to “improve” it we shall demonstrate only our ignorance and worsen we possess. Our advise: we need using own brains to learn how to exploit our organism as made arch complex living (not made by hands) device and nothing more. Other means of health support and recovery are not of Nature-Creator but from the Satan.

We are to remember, that the Creator of our organism will have no competitors, even highly qualified, in health support ever in future, as the inner structure of our organism and its bioprocesses of functioning are out of Man's competence. All it is done and functioning independently and out of our consciousness. If some enterprising personalities would start to assure you in the opposite and to propose their services and means to support your organism in a healthy state, it means that they are evidently concerning with your pocket money, but non your health. You ought to remember about it all.

The 2^{nd} principle of the Genetic People's Health and of the “BIOphilosophy of the Individual” (Individual is now under condition of human society commercialized to the core):
Life is not universal—any living organism feels well only in the conditions differing inconsiderable from optimal ones, given by the Nature. When our living conditions overstep these rather narrowly attainable limits, we, at once, are feeling worse, and when this breach of living conditions is continued or becomes aggravated our bad general state transforms into a disease. For the support of health and its recovery, we are to supply these natural optimal conditions of life, we are to meet the Nature's requirements but not run, in the case of weakness, to purchase commercial drugstore pharmaceuticals or commercial medicinal services. The health as well as the mind-reason is not a market good at all. It is clear, if we would proclaim, that we are short of health and reason, but we possess money and are ready to pay for health and reason, at once proper suppliers and found-hunters for your ready money will appear. We are to remember the matter. Life is not universal, omnipotent and it demands strict fulfillment of Nature's orders, as we ourselves are representatives of this Life but not its creators.
This is the second principle of the Computerized Global Humanitarian BIOcultural Genetic ‘public health’ (briefly: the Genetic People's Health—Health without the medical ‘health service’). Detailed commentary of this principle is given below.

The next three notions are accepted by the biologists: the inner medium of an organism, external medium (environment) and homeostasis. Some words are to be said on these useful notions.

The organism of a man as any vegetable or animal organism can be determined as physical—chemical system, existing in environmental medium in stationary state: human almost constant body temperature, almost constant blood pressure, almost stable glucose content in blood, etc.

The environment supplies three types of food to organism: 1) substantial food—molecular material for construction and recovery of organism, 2) energetic food—energy necessary for processing of organism's work, 3) informative food—information necessary to proper reaction of organism on environmental conditions.

Organism as such is alive due to occurrence of three metabolic processes within inner environment: 1) basal metabolism (exchange of substances), 2) energetic exchange, 3) informative exchange. Organism's activity products are excreted back to the environment.

Thus, the substances, energy, information pass continuously through human organism uniting its inner and external medium; the later is changing permanently. Inner medium is to be stationary to prevent a breach of physical-chemical processes of an organism for the supporting of life supply and vital activity. Life is not universal—any living organism feels himself better in environmental conditions only non-essentially deviating from those given by the Nature. When our life conditions deviate from rather narrow natural ones, we realize it at once immediately feeling bad, and when disturbance is prolonged or intensified, our state turns into a disease. So, the health depends upon: 1) quantity and quality of our food (quantity and quality of molecules of proteins, carbohydrates, fats and nucleic acids), 2) quality and quantity of our work (physical and intellectual), 3) quality and quantity of the information used (quantity and quality of intellect as an indicator of individual life experience).

To provide the stationary state, all the living organisms, vegetable and animal, have elaborated diverse mechanisms (1) anatomical, (2) physiological and (3) behavioral. To designate all them, the biologists have proposed the term ‘homeostasis’ (from Greek homoios—the same, stasis—the state).

The parameters of the environment—medium of dwelling are changing uninterruptedly, whether we want it or not, while the parameters of an inner medium are to be supported almost unaltered by all the physiological resources. The later parameters depend on anatomical and physiological homeostatic mechanisms of our organism, being achieved by cellular activity regulated by the entire genetic program, and this is not connected with our intellectual activity. It depends on our behavioral homeostatic mechanism, that is, on our way of living being obeyed to our mind-reason.

We have a way of living probable in the given living conditions. Certainly, we cannot change a lot, but too much depends on our free choice. Our behavior, way of life are considerably linked with the community we are living in. The modern individual is not separated from the human society and he can not survive without it. Each of us is a particle of human society. So, the human society is a part of an environment of everybody. This specific environment is subject to the continuous change also—all depends on reasonable organization of a community on coverage of the vital necessities.

The human society as a community of people is not yet organized so optimally as Nature has managed to do in human organism as in a cellular aggregate.

Fortunately enough, the optimal and permanent state of an environment for living cells (for cells!) as the particles of human organism, that is, optimal and constant parameters of tissue liquids of our body are already organized by Nature fixing it in a safe genetic program of activity of any living cell in optimally acting vital interests of everyone and of the whole organism. The “mind-reason” of any living cell is fixed by the Nature, as a vital experience of million years, on a material bearer in form of definite sequence of genetic codes in DNA structure of cell nuclei.

Unfortunately enough, the permanent state of an environment for living men (for men!) as the particles of social organism, that is, optimal and constant parameters of commercial food and other living conditions, are not yet organized by Nature, not fixing it in a safe genetic program of activity of any man in optimally acting vital interests of everyone and of the whole human community. The “mind-reason” of any living man is not fixed by the Nature, as a vital experience of thousands of years, on a material bearer in a form of definite sequence of genetic codes or somehow else.

To support a viability of human society, something has been already legislated, but all this is too far from the Nature's laws, as the first are written by the men and are reflecting their reason being too distant of the Supreme Reason reflecting the Life as such in our body.

The Nature had created our genes (long before our birth) and had generously supplied them by information on multimillion-year experiences of life support on the Earth and in our body. It had ordered to the genes to protect us of unfavorable conditions of the environment. Our genes are using this experience each second ruling every activity act of every living cell of a body.

Simultaneously, the Nature has created our brain able to make decisions and ordered to defend us from unfavorable conditions of the environment.

The Supreme Reason of Its Highness Nature reigns within our body—DNA and RNA molecules with codified genetic information in them. For decision-making in our relations with the environment, we use own mind-reason on the base of information collected in our memory during our short life.

We dress ourselves warm when it is cold, take umbrella when it is raining,—everywhere our consciousness is revealed, the experience we have obtained for several dozen years of our short life being unfixed by Nature on genes' level.

These actions under a regulation of our reason are necessary and clear to any child: protect yourself from unfavorable conditions of external environment. But non every grown up realizes, that a human society is a part of the environment and the Nature is not responsible for events occurring there.

It is unknown generally (except the biologists) that the cavity of the gullet is also environmental to our body. Consequently, the Nature does not take responsibility on situation within our oesophagus. Considerable part of responsibility is put on our mind-reason. Let us clarify it.

Digestion and resorption of products are performed in a human gullet. External surface of the gullet is covered with mucus.

Pay attention: the external surface of our body goes over to mucus cover on both ends. Really, where oesophagus or gullet begins by mouth where face skin turns into mouth mucus, further mucus oesophagus stomach, small and large intestine reaches anus and turns gradually into an external surface of body.

Oesophagus' walls are a natural continuation of body's external surface. That's why the food mixture in gullet, from the points of biology and physiology, is external and is not ruled by a genetic control. The matter is the following.

Our body consists of living cells rather tightly packed, and located on thousandth fractions of millimeters—these are cell's dimensions. In such a tight, packing all the cells are living independently and segregated, and their actions are coordinated with the informative exchange on genetic level without our conscientious participation.

This intracellular and intercellular information exchange process and the uniting of cells into a whole organism—are attained by tight cell packing. Where cells are closely packed—the body is there.

The oesophagus cavity does not suit these conditions—there is no dense packing of living cells. Everything which is out of skin and mucose—is of our body as of physical-chemical system with the regulation on genetic level.

Walls of gullet as well as our body are pierced by a dense network of nerve fibers for communication and regulation by impulses from central nerve system, but a cavity of a gullet is not pierced by the network and when no informative communication is available, no control is achieved.

We have to add: the control and the regulation of bioprocesses in our body by the endocrine system are impossible due to the lack of blood vessels. On physiologists' estimation total length of blood vessels with capillars totals in millions of kilometers forming a fine communication system for regulation and control of bioprocesses in our body by endocrine system. This dense network is piercing oesophagus walls but no circulatory system presents in cavity, and if transfer of information is lacking, no control and regulation exists.

The conclusion: oesophagus cavity is the same external medium surrounding our body, so the control and direction within its cavity has been given by the Nature considerable to our reason. For example, the Nature has left for itself the processes of production and extraction of necessary digestive enzymes into oesophagus cavity but their abilities are very restricted—digestive enzymes are not almighty: (*) they cannot optimally digest the natural products being overprepared in cookery: when we ignore it we are not to blame the Nature for troubles in abdomen; (*) enzymes are recognizing nearly 200 nutritive substances we see in garden, field or kitchen garden—this is a complete menu of the of Natural (God's) Table, but they are often being wrong, dealing with 40 000 products from the Industrial-Commercial Table (we see them in shops, restaurants), in case of our ignorance of this fact, we must not blame the Nature for abdomen troubles; (*) protein digestive enzymes can not act simultaneously with carbohydrates' enzymes, but we eat starchy potato or bread with protein bearing meat or fish; again, we must not blame Nature for abdomen troubles; (*) digestive enzymes cannot work effectively if we decrease their concentration in abdomen by tea, coffee and other drinks—it is our invention and our own way of eating, and here also we cannot blame the Nature for abdomen troubles; (*) enzymes extracted too few if we overeat, if we start eating in haste of intensive working day, if we start eating being ill, if we have dinner during family battles; (*) digestive enzymes are secreted insufficiently if we are inclined to sexual excesses spending physiological resources given to us once forever, instead of spending of great amount of substances demanded for proteins and hormones to sexual excesses.

Thus, the underlined circumstance that oesophagus is the environment and its internal conditions within are determined mainly on a conscientious level, can assist us to take notice of biological information for making our nutrition more reasonable and not distantiate too far from Nature's requirements—natural restrictions and other systems of life supply.

To sum up the above mentioned—(1) inner medium of organism with genes control and codified information of multi-million-years experiment of Nature on Life support and (2) external medium (environment) of an organism where we use our own experience for several dozens years of short life.

From the biological viewpoint, there are two media in a human organism. The “external biological medium of individual organism”-1) an arch complicated and easily vulnerable “ecological inhabitant medium” of this individual as definite biological object and plus 2) an arch complicated “human society” with its common traditions, customs, service, laws and goods for an individual life. The “inner biological medium of organism”—is an extra-complicated and easily vulnerable body of an individual as a certain biological object. Both media of individual, external and inner ones do require a protection from the human ignorance as such; the non-acceptance of that is equal to the negation of the Man's development.

Now, to defend “the natural medium of habitat” the Ecology is predestined and to defend “the social medium of habitat” from long ago so-called “Legislation” and “Legitimation” are predestined—both are achieved by the reason and forces of society, where individual is living, and of the worldwide community. But (*) to defend the proper “inner medium” as a definite extra-complicated and easily vulnerable biological object, (*) to protect the proper body from an impact of the commercialized social environment, weakly ruled by modern commercialized “Legislation” and “Legitimation”, (*) to defend us from noisy and silly proposals of the society: 1) from the hidden advertising of drugs and the open publicity of tobacco and alcohol—these three goods are the most profitable and suitable for maximal pumping money out from common people; 2) from powerful publicity of sensual, entertaining, feckless, fashionable lifestyle, by means of which, it is suitable to take maximal money off from the same common people; 3) from powerful spoiled commercialized nutrition products whose huge turnover is extremely useful for money extortion from common people,—from all this above mentioned; to defend own body as definite and highly vulnerable biological object, the individual himself is able and obliged, for the society is not ready to perform these functions yet.

To do it, the individual must and can use his reason and his own culture, better to say BIOculture—the knowledge of biology on Life as such is complex and easily vulnerable organism. That's why the Homo sapiens is nowadays needing in the BIOenlightening in BIOculture, as the modern commercialized community is his first and the most dangerous environment.

The every vegetable or animal organism is obliged to defend himself from the unfavorable conditions of life—otherwise it will no longer be the dweller in this world. Without the self-defense, as BIOlogists do assure, any life of any organism is impossible. In the same BIOlogical sense, the BIOculture is natural, BIOlogical, that is, completely natural and logical, intellectual weapon of the self-defense of an individual against disastrous antiBIOlogical conditions from completely commercialized society as from the first and disastrous habitat additional to the medium (habitat) defended by Ecology.

The 3^{rd} principle of the Genetic People's Health and of the “BIOphilosophy of the Individual” (Individual is now under condition of human society commercialized to the core):
Life of any organism is impossible without self-defense, as BIOlogists affirm—specialists, studying BIO (Life as natural phenomenon) and its logic; any vegetable, any animal and any human organism are to defend themselves from unfavorable conditions of habitat-otherwise it is no longer a dweller for this God's world.
This is the third principle of the Computerized Global Humanitarian BIOcultural Genetic ‘public health’ (briefly: the Genetic People's Health—Health without the medical ‘health service’). Detailed commentary of this principle is given below.

Human organism, in contrast to other organisms on the Earth, has not only “ecological natural surrounding” supplying the human organism with all necessary for life and with given natural laws of life supply and behavior (way of living) as a whole, but also the “economical social environment” as “human society”, by traditions, customs, commercial services, goods and laws of which everyone is to live, being a particle of a society.

The human organism obtains all the necessary for the life supply via Commerce but not Nature, so was it accomplished and we are not to change that. But we must bear in mind that the Nature has one interests and the Commerce has quite the different ones; everybody is to know and to defend the proper interests—biological interests of the proper organism—BIOinterests (Life interests) and logical (reasonable) interests. Without self-defense, as the BIOlogists assure us, no life is possible for any organism, vegetable and animal, so that it is no longer a dweller in this God's world.

To accomplish it, an individual can and must be using his own reason and culture (better to say, BIOculture)—knowledge of biology's elements on the Life as such, part of its extra-complicated and easily vulnerable organism he is. That's why Homo sapiens now needs BIOenlightening, BIOculture, science and art of the Computerized Global Humanitarian BIOcultural Genetic ‘public health’ (briefly: science and art of the Genetic People's Health)—the science and art of Health without the medical ‘health service’, science where the essence is given by data of the Genetic People's Health principles.

The methods of popularization of the science are—thematic entertaining individual and collective games on the specialized “Computerized Global Humanitarian BIOcultural Genetic Public Health” Internet-site, but firstly the method of the science popularization for common ones including schoolchildren is being a specialized playing microprocessor devices: the Computerized Global Humanitarian BIOcultural Genetic ‘public health’ microcomputers and microprocessor toys for preliminary self-enlightening of an individual in the BIOculture and in the Computerized Global Humanitarian BIOcultural Genetic ‘public health’ principles and for subsequent simple, playing, easy-to-understand using of the science and art of Computerized Global Humanitarian BIOcultural Genetic ‘public health’ (Health without medical ‘health service’).

The BIOculture of an individual is being an intellectual method of self-defense of this individual from disastrous antiBIOlogical conditions from completely commercialized human society as the first and dangerous habitat environment of the Individual, additional to the medium habitat defended by Ecology science.

The 4^{th} principle of the Genetic People's Health and of the “BIOphilosophy of the Individual” (Individual is now under condition of human society commercialized to the core):
The modern completely commercialized human society is for everyone his first and the most dangerous habitat environment.—It is a high time to realize that without merciless and aggressive Commerce (it cannot be principally another) there is no more effective mechanism for formation human society as such and its further strengthening and cementing; and the Nature is interested in it. But, nevertheless, the human society has no perspective, no future without the Biology (without BIOlogy—the science on life logic on Earth and same life logic in human organism) and without the BIOenlightening, without BIOculture of the people and firstly of our children as humanity's successors and ones less defended from aggressive and merciless Commerce without which we are however unable to survive. There is no society without the individuals. Without the cultural enlightened individuals there is no Development, no Life as such, for it is a result of development. The enlightening is a distribution of knowledge. The culture is an aggregate of human achievements in industrial, social and intellectual areas. Cultural means the located on a high level of culture corresponding to it. The BIO . . . (Greek “bios”—life)—is the first part of words, terms denoting the relationship to the Life accomplished as a natural phenomenon on the Earth and within every human organism. The BIOculture means a level of human cognition of elements of BIOlogy, the Logic of Life at any rate in the proper human organism. It is a time to everyone to realize it all, to all usual and common people, the foundation and the functional elements of a society. Each of us is linked with the society, but, in parallel with, it is inseparable from his own mind, for, according to the following scientific-biological definition each of us is to be the Homo sapiens (Man rational, Man as intellectual being, Man from the capital letter as Life itself and its Creator, Whom we can cognize by our mind, but it is not given to us to climb above Him, above His Supreme Reason, creating the Life on the Earth and within our organism).
This is the fourth principle of the Computerized Global Humanitarian BIOcultural Genetic ‘public health’ (briefly: the Genetic People's Health—Health without the medical ‘health service’). Detailed commentary of this principle is given below.

Human society on the Earth—it is just only a forming new living global system consisting of 5 billions of individuals, who, in a process of activity, do provide their own and common life; this interaction of people within society is regulated by the laws of Economy, Commerce and Money, once invented and proclaimed by the Man, and too distant, in the aspect of life supply, from Nature's laws regulating the Life as such.

The human organism as a certain living system is more huge and more functionalist system than a modern human society. To be concrete, the human organism as a living system functions by living cells, those number is 1000 times more than of human beings on the Earth.

Nevertheless, in spite of cumbersome structure of human organism as a whole, these cells' function more organized and more optimal than humans in society.

A human organism in contrast to a human society, is a living system, formed long ago, of 5 trillions living cells interacting within an organism. This interaction is regulated by the natural laws of Biology, Physiology and Genes once established by the Creator. These natural laws are set not for the Man's realization and we are to detect them scientifically and to follow them humbly, talking on the “Supreme Reason” of the Creator.

In the human organism, in the life supply of the separate cells and the whole organism this Supreme Reason of the Creator is reigning, being called in science the Nature, in religion—the God. In human organism Supreme Reason of the Creator governs, while in human society the Man's “reason” reigns, the distance from it to the Supreme Reason of the Creator is not shorter than from the ground to the Heaven.

For the supply of a human organism nearly, 200 natural foods was created—we see them in garden, fields, kitchen garden, but modern man is to get them not from the Nature but from the Commerce as commercialized and spoiled foods fostered by manufactures of foodless foods. Their types are running to 40 000 names, invented by enterprising men for the sake of so called “value added”. We feed ourselves not from the Nature but from the Commerce. The modern commercialized human society is the most dangerous medium of habitat; it concerns all of us: merchants and non-merchants, businessmen and non-businessmen—all of us, the usual ones, obliged to eat from the table of Commerce. We have one more example: the human organism is consisting of water for ½ and the Nature filled the rivers and springs with the water (H₂O is the human drink No.: 1) but we are instructed by the Commerce to drink thousands of commercial drinks invented for ourselves by enterprising men for the sake of so called “value added” and for money extraction from the pockets of simpletons, those distant from the BIOlogy, BIO and its logics. So we are drinking also from the table of Commerce. The modern commercialized human society is the most dangerous medium of habitat; it concerns all of us: merchants and non-merchants, businessmen and non-businessmen—all of us, the usual ones, obliged to eat and drink from the table of Commerce. That's why we need the BIOeducation and BIOculture urgently.

One example else, for the support and recovery of a human health: the Nature has created biological and physiological means and mechanisms being given to everyone in a moment of his conception in the mother's womb. To know about the natural means and mechanisms each man is obliged simply for assistance to his organism to be in a healthy state or to recover after unsuitable food, or physiologically incorrect way of eating and genetically unjustified way of living. The modern commercial medicine is not interested in the enlightening activity as financial gain of it does not form a millionth part of incomes amount in: (*) sale its drugstore drugs, (*) sale its commercial services of diagnostics, (*) sale its commercialized prescriptions of those drugstore drugs.

The modern commercialized medicine is not interested in the BIOenlightening and BIOculture. But it concerns everyone—businessmen and not, physicians and not, ordinary men who eat something and drink something, who has this or that way of life, being unwell or seriously sick, afterwards complaining of Nature's imperfection but never of the mind's.—That's why Homo sapiens needs now BIOenlightening, BIOculture, the science and art of Computerized Global Humanitarian Genetic BIOcultural ‘public health’ (briefly: the science and art of Genetic People's Health)—the science and art of Health without the medical ‘health service’, science where the essence is given by data of the Genetic People's Health principles.

We shall repeat: the methods of popularization of the science are—thematic entertaining individual and collective games on the specialized “Computerized Global Humanitarian BIOcultural Genetic Public Health” Internet-site, but firstly the method of the science popularization for common ones including schoolchildren is being a specialized playing microprocessor devices: the Computerized Global Humanitarian BIOcultural Genetic ‘public health’ microcomputers and microprocessor toys for preliminary self-enlightening of an individual in the BIOculture and in the Computerized Global Humanitarian BIOcultural Genetic ‘public health’ principles and for subsequent simple, playing, easy-to-understand using of the science and art of Computerized Global Humanitarian BIOcultural Genetic ‘public health’ (Health without medical ‘health service’).

The BIOculture of an individual is being an intellectual method of self-defense of this individual from disastrous antiBIOlogical conditions from completely commercialized human society as the first and dangerous habitat environment of the Individual, additional to the medium habitat defended by Ecology science.

The 5^{th} principle of the Genetic People's Health and of the “BIOphilosophy of the Individual” (Individual is now under condition of human society commercialized to the core):
The term “Health” is connected tightly with the term “Life” and, in its turn, with “Genes”—all it forms a feature of living beings on the Earth from a microbe to a human being, that is, it has a global character. The Life as such and the Health as an inner attribute of Life are global, not private this is rather poorly realized by the common people who are concerned with a private life in the society (wages, costs, affairs, prestige, etc.) and don't take care of global Life whose representative their own organisms are. Commercial interests and the interests of the Living Nature are interconnected somehow within the frames of ecology—science defending the inanimate matter (soil, water, atmosphere), supporting the living matter (living organisms) from the total human foolishness. The frames of the ecology, in a defense of human organism's nature from the corporate commercial interests, are too slight. The broader science and more resolute measures in the direction of BIO-Life are necessary. To cover the gap, the science and art of Computerized Global Humanitarian Genetic BIOcultural ‘public health’ (briefly: the science and art of Genetic People's Health—the science and art of Health without the medical ‘health service’) is elaborated.
This is the fifth principle of the Computerized Global Humanitarian BIOcultural Genetic ‘public health’ (briefly: the Genetic People's Health—Health without the medical ‘health service’). Detailed commentary of this principle is given below.

The man lives in a human society according to the private social laws and private economic requirements—both are too distant from the natural laws and requirements. Human organism lives according to quite another laws and requirements not connected with the economy, according to the global natural ones, which the living Nature does dictate to the individuals, living organisms including human.

The very two lives of human being (the first one: biological life within his own organism, one and single for all the living beings on the Earth, and the second: social life as an individual in human society) are interlinked by ordinary people quite to the contrary: the first is not observable, poorly known and it does not get a proper attention to, while the second is known from the very childhood and they are worried about it from dawn till dusk—the opposite situation is desirable. These lives—in society and in organism—are interlinked as economy and biology, that is, are not in an interconnected state, except first timid attempts of ecology. Nowadays, more decisive attempts on human life protection, from the total unreasonable behavior, are to be made.

The life in a human society actually comprises only tiny part of a global life of a man, a visible part of a huge iceberg. Unfortunately, the ordinary man is entirely anxious in that tiny part of his own life (social life) not knowing that his health is breaking in the underwater part of iceberg. Social laws and economic requirements are dictated to the man by the corporative interests, servicing his life in society (commercialized organization of food supply, commercialized organization of health care, et al.). Natural laws and biological requirements are dictated to man by interests of Nature, 1) creating each human organism for support of the Life within and for supply Health as inner attribute of Life, 2) creating natural foods for a man being observed in garden and kitchen garden, 3) creating the natural means and methods of health service genetically inlaid in human organism at the moment of its conception in the mother's womb. In the matters of choice of 1) way of life, 2) way of eating, 3) foods, plus 4) means and methods of health service, it seems reasonable to everyone to apply for advice and support firstly to the Nature (textbooks on biology and physiology) but not to corporations (to commercial advertisement). But in the matter of choice practically all ordinary people are satisfied by an easily accepted information from the commercialized publicity and they step aside of a hardly interpreted global information in the textbooks of biology and physiology; as a result they loose their own health—loss of the principal, natural are not possible to be compensated by the private, commercialized. The construction of a building is starting from a basement, building of health is good to be started from the mass BIOenlightening.

The Computerized Global BIOcultural ‘public health’ (Health without medical ‘health service’) is simply obliged to substitute the modern ‘public health’ (Health via medical ‘health service’) rooted in Commerce. It is clear to everyone, that the Commerce is interested in money but not in the laws of Nature and in the respect to them. The final goal of the Commerce is money and it cannot be alternate due to determination; in the Commerce no moral principles are acting—this is the experience of a humanity. It is easy to realize, that (1) interests of corporations in the obtaining of financial gains for functioning and (2) interests of Nature in satisfying of normal needs of a human organism for a normal working—these two interests are laying in different areas. That's why the ordinary people are to know that the Commerce is one, while the Health is quite another with no link. Such a radical difference between Commerce and Health is poor realized yet by the individuals and the society. Too few common people either businessmen or not, either physicians or not, do realize that the roots of the Health, including their own one, are exclusively in the Nature, in fundamental and stable laws of biology and genetics. Therefore, the roots of “the Public Health” are simply located in biology and genetics but not in the Commerce —in orthodoxal commercial medicine with its apothecary pharmaceuticals, alien to a human body and invented by enterprising persons for the commercial goals.

The logic is simple: for each individual, nowadays, “Public Health” (Health via medical “Health Service”) is entirely an object of commercialized medicine, while the “Health” of each individual is entirely an object of the Nature (biology and genetics). Biologists and geneticists consider human organism to be a individual unity, where Life and Health (as an inner attribute of Life) do create simultaneously nearly 5 trillions of living cells functioning in accordance with the unique genetic program, single for all the cells of a human body; this program originates at the moment of the fusion of the “spermatozoon” and the “ovule” of parents and formation of the “zygote” (or “maternal cell”). The biologists and geneticists are sure that the Life as such is out of human competence. Therefore, 1) the “Organism” as a form of the Life's existence and 2) the Health as an inner attribute of the Life are also out of the Human's competence. Physicians have quite an opposite opinion. “Life” is in their competence, “Organism” is also in their competence, “Health” overloads all the pharmacies, “Health” is on sale in all clinics. We should emphasize: physicians are ill, as rule, not more seldom than their patients; the later seems strange and it makes reasonable person (Homo sapiens) watch for. If money as such would disappear, the “Medicine” as such would disappear at once, but the Health will remain as an attribute of the “Life” in human “Organism”. Otherwise, “Medicine” is based on “Money”, but not on “Health”. It looks like a lack of logics, a non-intended error or an intended cheating, with which the society will not be agreeing further.

We repeat: “Life”, “Organism”, “Health”—all this, like Sun, Earth and Life is not artificial and is out of Human competence. Nothing of above mentioned can be improved by the Man but it can be worsened only. The question is: what is in the Man's competence? The answer is: the scientific study of “Life”, “Organism”, “Health” is undoubtedly in Man's competence. To improve the accomplishment of Life, to correct Man's “Health”—this means, to spoil the Nature as less as possible by unreasonable actions, to study it diligently and to follow the Nature's laws. But if this approach to health from the side of scientists and common people would inevitably produce bankruptcies of modern corporations, the humanity will surely overcome it. Millions of orthodoxal physicians should accept new approaches to the healthcare—biological and genetic ones, 1) directed on treatment of the whole organism as one undivided entity but not of some parts separated from all living organisms, 2) directed on treatment of organism by the natural remedies and effects but not commercial artificial remedies and effects such as pills alien to a human body. To perform a section of still living organism on separate organs and to apply for every organ some specific pills alien to a human body—it is necessary to finish with such an approach incompatible with biology and molecular genetics; a human organism is being an undivided entity where Life and Health being an inner attribute of Life are producing simultaneously and mutually connected together, almost 5 trillions of living cells acting in accordance with one genetics common to all the cells. The layout of Nature in living cells will be a research field for many thousand years to the biologists and geneticists, so the latter will never be unemployed.

But to know little is always better than to know nothing at all. Every minute scientific knowledge produce an appreciable practical use, if one applies it reasonably, does not idealize it, doesn't rise by human mind over the Nature's reason—it seems hard not to be tempted by, if the all-powerful Money produce temptation.

Undoubtedly, in the coming century, the science of Public Health will come from physicians to geneticists. But it seems probable, that the Commerce and all-mighty Money now reigning over physicians will submit geneticists in “making of commercial health” by an interference in genes' activity of each of us. Thus, geneticists will have to invent for, slightly educated persons, “genetic commercial services for improvement of living cells of human organism”, in economy it is equal to the “medical commercial services in improvement of the human organs' activity”. The vicious circle will close, Commerce and Money will rise, as they did before, over the Biology and Genes, corporate financial interests will suppress, as before, biological interests of human organism—all it concerns us, including workers and shareholders of corporations, geneticists and non-geneticists as modern commercial advertising is elaborated by most gifted psychologists and advertising can suppress the mentality of even well educated persons, non concerning the ordinary people, young kids that is all humanity practically.

Not to see all above or keeping silence on biological and genetic truths in favor of corporate interests—is a non-logical behavior of the whole community. To correct these great efforts and voluntary humanitarian scientific contributions from biologists and geneticists of the world are necessary, as only they are able to realized passage from modern “Public Health” (Health via medical “Health Service”) to the Computerized Global Humanitarian Genetic BIOcultural Public Health science (the science of Health without medical “Health Service”), as an independent scientific branch in biology and genetics, that is, in Nature, but not in Commerce.

The corporate interests and financial gains, in modern human society crush down natural interests of human organisms in individuals including shareholders and workers of the corporations. To everyone is better to take first care of his own interests, of his own organism and of his own health and, later on, he would take care of corporate interests and financial gains.

As a result of huge investments in the commercial advertisement, being worked up nowadays only by psychologists, with no participation of biologists and physiologists, the corporations for the sake of their gains 1) are thrusting the man on a certain way of life (distant from biological expediency, but profitable financially), 2) are thrusting the man on a certain way of eating (far from biological expediency, but profitable financially), 3) are thrusting man on commercialized and spoiled foods fostered by manufactures of foodless foods (not expedient biologically, but profitable financially)—we encounter them in food stores and restaurants, but not in nature: not in garden and kitchen garden, 4) are thrusting the man on definite commercial means and methods of health service (distant from the biological expediency, but profitable financially)—we see them in drug stores and clinics, but not in nature: not in the very human organism. And this psychological pressure of the commercial advertisement impact all people including shareholders and workers of these corporations, including managers and performers of the publicity, elaborated now by the most qualified psychologists who can easily submit the mentality of common people and especially youngsters.

That's why, Homo sapiens needs now BIOeducation, BIOculture, the science and art of Computerized Global Humanitarian Genetic BIOcultural Public Health (the science of Health without medical “Health Service”).

We repeat—the method of science popularization—is laid in of topical amusing individual and collective games on the specialized “Computerized Global Humanitarian BIOcultural Genetic Public Health” Internet-site, but firstly, it is addressed to common people (including schoolchildren) specialized microprocessor devices: the Computerized Global Humanitarian BIOcultural Genetic Public Health microcomputers and microprocessor toys for preliminary self-enlightening in BIOculture and in the Genetic People's Health principles and for subsequent simple, playing, easy-to-understand using of the science and art of Computerized Global Humanitarian BIOcultural Genetic Public Health (Health without medical “Health Service”).

We repeat once more, BIOculture of individual represents intellectual mean of self-defense against harmful antiBIOlogical conditions of utmost commercialized society, as of dangerous environmental habitat, in additive to the habitat defended by Ecology.

The 6^{th} principle of the Genetic People's Health and of the “BIOphilosophy of the Individual” (Individual is now under condition of human society commercialized to the core):
BIOculture of the Individual—is the level of understanding of the elements of BIOlogy, BIO (Life) and its logic in the own organism. We shall bear in mind, that commonly used prefix “BIO” (from Greek “bios”—life) denotes: “is referred to Life comprehended as natural phenomenon on the Earth and within our own organism”. Our organism has no other life. Besides, we have no other life as our, as we are lacking without this very organism. That's why we need BIOenlightening and individual BIOculture: 1) out of our organism (out of BIO, Life as a phenomenon of the Nature on the Earth and in our organism), we have neither life, neither health, nor activity; 2) we are not alive—our organism is alive; 3) not we do but our organism is acting; 4) not we are ill or healthy, but our organism is; 5) not we do, but our organism either rejoices in, or delights in; 6) to engage an alien person to live instead of you, to give him for usage your own organism—is the purest absurdity, while to take stranger for support your organism in healthy state, to help to its normal and correct activity, to treat it—is no less madness; those aliens proposing you health care, are taking care on your pocket money, that's all. The old proverbs are “Health is not on sale” and “Rescue of drowning ones is business of hands and brains of drowning ones”.—So, we need BIOeducation and individual BIOcultture: each person is to lead the own life, is to use competently and to take care healthy own organism; each person has to enrich own mind and own intellect—nobody except you can do it for any money. It is true, that no alien person refuses of our money, if we should try to hire him to fulfill all above mentioned. This is the nature of a man, and it is not our competence to change it. But we are able to bear that in mind organizing our life, our nutrition, and our healthcare.
This is the sixth principle of the Computerized Global Humanitarian BIOcultural Genetic ‘public health’ (briefly: the Genetic People's Health—Health without the medical ‘health service’). Detailed commentary of this principle is given below.

While thinking of our own daily life, we inlaid into the notion “Life” any sense but not BIO meaning, as biologists do. Our subjective life—everyday, private and other far-fetched, “artistic-romantic” life in thousands and thousands of novels and movies—is carried us away, while BIO-objective, “biological life of our organism” in manuals of biology—does not interest us at all.

The roots of our indisposition, bad general state and bad mood, even non-satisfaction of life as such, we are ready to look for anywhere but not in the biological life of our organism that is in BIOlife, that we have no idea about, and, as a result, we expose our BIOignorance what feeds our frequent indisposition, bad mood or serious diseases. In this connection we are saying on BIOculture and BIOeducation.

Our body—is an aggregate of living cells as bodies of all vegetable and animal organisms on Earth, what we use as our food particularly. The Living Cell, vegetable or animal,—it is the single object realizing unique natural phenomenon, called the Life (“BIO”), and creating its attributes Food, Nutrition, Health, etc. Paraphrasing a well-known classic, one can say: “However, not all is good in Kingdom of the Living Cells of our body” and authors of the Computerized Global Humanitarian BIOcultural Genetic Public Health principles (briefly: the Genetic People's Health principles—the principles of Health without the medical ‘health service’) invite readers to reflect on it together.

We, the people, have two diverse lives: 1) “Life of our organism”—here are the Nature, living cells, biology; 2) “our life in society”—here are the Commerce, money, economy. We are completely anxious by our second life—work, wages, prizes, “relaxation” intrigues, “good and evil”, “laugh and tears”, etc. but we are ignorant of life of our organism. That's why we need urgently BIOeducation and individual BIOculture.

We are saying “culture of labor”, “culture of speech”, “political culture”, “culture of civil law”, “spiritual culture”, as we do respect these human achievements and during our life we have been mastering the elements of this knowledge, not wishing to look like as ignorant persons. However, we don't know “Life as such, as natural phenomenon”. It turns out we evaluate everything except “such a trifle”, as Life. This is our greatest ignorance—to appreciate all knowledge, except the Life. Therefore, authors of the Computerized Global Humanitarian BIOcultural Genetic Public Health principles (briefly: the Genetic People's Health principles) have decided to propose the readers to respect the BIOculture-biological data on the Life as such.

Each of us has read a lot on the private life of the celebrities and non-celebrities. Perhaps, millions of books were written on private life. One can ask: “What are you living for?” and nobody has a simple answer to the question. For the answer the authors of the Computerized Global Humanitarian BIOcultural Genetic Public Health principles invite readers to BIOlogy manuals, retelling real BIOlogical but not the imaginary romantic life. As auxiliary questions we ask: “What is the Life in general, who creates biological Life, what and who do our Life depend upon?”

Life as such, health, diseases and our natural foods are created by the Living Cell, vegetable and animal, and all this is produced by the Living Cell under an operation of genetic program, being placed by Nature into nucleus of every cell of our body and into nuclei of plants and animals, we use as meal. The Living Cell has no technical analogues and it will never have them—this is uniformly accepted, as laying beyond the human intellect and it leads to an idea of existence of Life Creator and his Supreme Reason, realizing the Life on Earth. That is why, it seems reasonable to start BIOeducation on Natural Public Health from the Living Cell, but there is no need to take off the Creator. This is a key used for the following Computerized Global Humanitarian BIOcultural Genetic Public Health principles (briefly: the Genetic People's Health principles—the principles of Health without the medical ‘health service’).

Under the word “principle” are understood all sense loads, namely principle (Latin principium—base, start)-1) basic initial clause of some theory, study, science, etc.; 2) this is a leading idea, basic rule of activity; 3) inner conviction, belief determined norms of behavior.

The 7^{th} principle of the Genetic People's Health and of the “BIOphilosophy of the Individual” (Individual is now under condition of human society commercialized to the core):
Life as such—is a natural phenomenon in form of living organism: from protozoa, microbe and virus to arch-complex human organism. The Life as such—is single and entire for all living beings on the Earth, including each of us. According to biologists, Man had become a leader in Life development 2 million years ago, and 10 thousand years ago he became the Master of all living on the Globe. One should ask, what is the general sense of Life and sense of everybody life?
This is the seventh principle of the Computerized Global Humanitarian BIOcultural Genetic ‘public health’ (briefly: the Genetic People's Health—Health without the medical ‘health service’). Detailed commentary of this principle is given below.

Any and each man—undivided part of Life on the Earth, its representative enjoying full rights participating by its organism to Life support on the Earth, prolonging Life duration by own children, participating by fruits of mental and physical labor in Life development. Intellectual labor fruits are standing apart: firstly, these fruits are imperishable—they can be accumulated and conserved for all time of humanity existence: all other human contributions don't interest the Creator and they are destroyed by the River of Time, secondly, if intellect labor fruits have turned out to be of use for others, they would be reaped by all subsequent generations and would became property of whole humanity. Really, if anybody managed to perform his business best of all during short life duration (for instance, best sewing, best plowing, best building, best designing, etc.) his heritage will be remembered and be changed for the total benefit. This creative achievement would leave his body and transform into all mankind benefit, that is the person after physical death of body would live in human society by means of soul (by own “trace on Earth”). Does it mean “Eternal Salvation”, we are sometimes talking about? It looks like sense of human life is in his labor (sense of life—in creative labor!).—This edifying conclusion was done thousand years ago and fixed for us in the Bible or in the Koran.

It is clear, you may work and enjoy life is only till you are healthy.

But what does it mean Health and what biological sense does it bear (BIO+logical)?

BIO (Greek “bios”—life)—first constituent part of words, terms depicting relationship to Life as a natural phenomenon, an organism of everyone is being a private performance of that.

Logic—science on laws and forms of thinking.

So what does it mean Health and what biological sense it has?

The 8^{th} principle of the Genetic People's Health and of the “BIOphilosophy of the Individual” (Individual is now under condition of human society commercialized to the core):
Man's Health—is normal, correct activity of his organism and nothing but this. But what does it mean Organism as such and everyone organism? How is the single Life on Earth and in our organism organized? Briefly: what does it mean human health as normal correct activity of his organism—how can one understand it all from biological point of view, from Life position and its logic? How is it all organized (organized!) by Nature? What are the most fundamental news of to-day science? Building is started from the foundation, formation of health is reasonably to start from Health foundation, from the basic (main) knowledge on the Life in our organism.
This is the eighth principle of the Computerized Global Humanitarian BIOcultural Genetic ‘public health’ (briefly: the Genetic People's Health—Health without the medical ‘health service’). Detailed commentary of this principle is given below.

The modern biology distinguishes the next primary levels of Life organization on the Globe and Life and its organization within our organism. {—We emphasize: the organization of the Life by its Creator, but not by us, great sinners designed own life by common proud choice: “I! Want! so!”—“What I want, I eat”—choice of food;—“How I want, so I eat”—choice of a way of eating; “How I want, so I live”—choice of a way of living.}

So, that is Life organization on the Earth and within our organism (done by its Creator, but not by us).

Genes (from Greek “genos”—“origin”)—this is the first level of Life organization by its Creator, named in science as the Nature and in religion as the God. In physical-chemical aspect, the genes represent DNA sections and they are in nucleus of any vegetable and animal cell. In information-cybernetic aspect, the genes are material bearers of the genetic program and operators on its realization, they start, direct, control any living cell on the Earth. The Genetic program, as such, is linking and indissoluble section of vegetable and animal world. Absolute fact: the Genetic Program starts and controls the Life as unique natural phenomenon, on the Globe. Our organism is a genetic undivided part of this phenomenon (Life as BIO). Absolute fact: Genetic Program as such—consists of multi-million years experience of the Creator on Life support on the Earth and in our body specifically. Genetic Program, inlaid in the nucleus of every vegetable and animal cell—can be identified as the Supreme Reason, once disputed by Plato in ancient Greece. This Supreme Reason, creating and supporting the Life on the Globe as well as BIOlogical life of everyone, is not a speculative conjecture of philosophers, but a materialized entity observable under an electron microscopes, as this Supreme Reason is codified by the Nature in arch complex fanciful construction of billions of material atoms in each completely material DNA molecule of our body. We would like to emphasize, that this Supreme Reason is codified and in laid in cell nuclei 9 months before our birth! Probably “the eye of the Creator” and “mechanism of His reactions upon our actions” are in put in every cell of our body at the moment of the fusion of the “spermatozoon” and the “ovule” of our parents and formation of the “zygote” (or “maternal cell”).

The living cells—are the second level of organization of Life by its Creator. Our body, as well as bodies of plants and animals, are aggregates of living cells working in strict accordance with genetic program and nothing more. Absolute fact: the Living Cell looks like as computerized factory on living matter production—protoplasm and organic molecules: proteins, carbohydrates, DNA, enzymes, hormones, etc., etc.—Digestion, nutrition, and many other molecular biological processes in our body are impossible without these molecules. Absolute fact (all biologists unanimously agree): creation of living matter (making of protoplasm) lays out of competence of human reason. All above mentioned on Living Cell activity reminds the computer, working with software. By the way, even cells of Human body and other representatives of animal world are unable to transform non-living matter of soil layer of Earth into protoplasm—living cells matter as Life of animals and Man is impossible without plants nourished with. Only plant living cells create initial raw materials for living matters of animals (Human also) cells. Really the Life on the Earth is unique and arch complex, and Genetic Program connects vegetable and animal world and from the Program starts Life organization, later continuing in cells, afterwards in organisms.

Living organisms (from unicellular microbes to human organism)—are the third level of Life organization by its Creator. Absolute fact: our body and our organism are an aggregate of living cells, working in strict accordance to the Genetic Program. We are formed from living cells and each of these cells without genetic program in nucleus, entire for given organism. So, at the moment of our conception—at the fusion of spermatozoon and ovule with subsequent formation of zygote, being ancestral Living Cell of our future organism as a whole—the Creator (the Nature or the God) supplies everyone with the personal Genetic Program, which is clear in complete volume only to its Creator. This program is to be inlaid into the very of our sinful body for permanent control of its work and the function of the whole organism; the cell is of micron size,—is the permanent control and the functioning of the whole organism; the cell is micron-sized, such a strict is the Creator control on each of us.

Modern biological sciences affirm: our Creator (the Nature or the God) presents in every living cell of our body, that is our saying “(reasonably) to give the God a place in our heart” is true.

All the afore-mentioned on Living Cell is referred not only to our body, but to any vegetable and animal organism on Earth, we are consuming as a meal. Speaking (*) on our natural Health and natural Health Service, (*) on natural foods (those arch complex, easily vulnerable molecules of proteins, carbohydrates and other organic substances), (*) on our digestion (designed by the Nature for these molecules) we have enough to think about.

So, the biological life of everybody is created and supported by the living cells of our sinful body, its self-cure and self-reproduction, occurring under genetic program as prolonged experience of the Creator of the Life in support it in every organism. The radical biological essence of the Global Genetic Public Health science (briefly: the Genetic People's Health science—the science of Health without the medical ‘health service’) is in permanent cure of us by our Creator.

The start to everyone was laid by a cell-zygote formed by merging of parents' cells—spermatozoon and ovule. In accord of genetic program, the zygote (the first and still single living cell of future organism), having accumulated enough constructive material, on the base of nutritive substances, starts to divide, giving life to other cells, gradually producing tissues, organs, systems of organs and at last the organism ready to birth. So, the genetic program is fulfilled in the further process of precise copying of the formed cells with no relation to the human consciousness.

It is known, that nearly a billion of living cells are instantly in changes in our body: they are dividing, self-restoring or dying off. For one day and night in human body 20 billions of new living cells appear for substitution of overaged cells having spent out the physiological resource. Our organism was given an inborn capacity for self-reconstruction and self-cure via permanently occurring metabolism. Metabolism is our physician single to trust and to follow. Our nutrition is obliged to living cells demand, our way of life is to follow them, but we, being ignorant to elements of biology and physiology, push them off. We don't know that micron-sized living cells are able to create miracles—to self-propagate, to self-develop, to self-organize and they are capable to self-renew: enterocytes from intestine epithelium are completely renewed in 3-4 daily, half of hepatic proteins and plasma blood are restored in 10 days, half of muscles proteins are renewed in 180 days, human proteins are renewed average in 80 days,—this is without medicines, free self-healing of Human organism. It is single mechanism of our healing; other (paid!) cure can help or prevent but cannot substitute it.

There is plenty of biological and physiological facts to mention. Blood contains 45% living or active cells—erythrocytes and leukocytes. Erythrocytes are red blood cells, containing hemoglobin, which binds oxygen in areas of high concentration and returning it to the areas of lower concentration—thus, oxygen transportation takes place. Leukocytes are larger than erythrocytes and much less in number. They perform defensive role for organism: (*) 70% living and active leukocytes are capable to intake and digest malignant bacteria, (*) 4% leukocytes penetrate through capillary walls into focus of inflammation for intake and digest bacteria, (*) 24% leukocytes can cause immune reactions, forming antibodies for destruction of cancer cells, (*) 1.5% can rapidly rise concentration in allergic states. Attention: life duration of leukocytes in circulation bed is several days normally; old and dying off cells are substituted by new strong leucocytes—that is an example of self-recovery of our organism. Rate of erythrocytes breakdown and substitution depends on oxygenic penetration into blood from air. Low content of oxygen in blood activates bone marrow where number of new erythrocytes is higher than they are destroyed in liver. So every second in blood 2-10 millions of erythrocytes are destroyed and the same amount appears newly—this is an example of self-recovery or self-recovery in our organism an example of metabolic processes.

To sum up, this is a logical reasonable outlook useful to anybody: don't make an idol of physicians but try to follow Her Majesty the Nature, our Mother and with all mind, try to comprehend her, not to contradict her in food choice (“What I want, I eat”), way of eating (“As I want, so I eat”) and way of life (“As I want, so I live”).—These ideas compose the concept of the Computerized Global Humanitarian BIOcultural Genetic ‘public health’ (briefly: the Genetic People's Health concept—the concept of Health without the medical ‘health service’).

The 9^{th} principle of the Genetic People's Health and of the “BIOphilosophy of the Individual” (Individual is now under condition of human society commercialized to the core):
Health as such that is Health in biological and genetic sense—is an obligatory inner attribute of the Life as such, as without it Life would cease immediately, even having appeared. The Health, as well as the Life, was inlaid by the Creator in a program form into genes of every organism, in particular of human one. An individual unique set of genes is formed at the moment of its conception within mother as in zygote nucleus formation—first living cell of the future organism being formed by a fusion of spermatozoon and ovule of parents. Thus, Life and Health (as the “Normal Correct Activity of Organism”) are inlaid even at its conception within mother and after his birth, the man is only spending his life and health as certain physiological source of organism, spending it reasonably or not.
This is the ninth principle of the Computerized Global Humanitarian BIOcultural Genetic ‘public health’ (briefly: the Genetic People's Health—Health without the medical ‘health service’). Detailed commentary of this principle is given below.

The Life as such is programmed within genes being accomplished in cells and continued in organisms but Life start is nevertheless in genes and Health as such and Health service in their origin are also genetic.

Genetic denotes being referred to genesis or genetics. Genesis (Greek “genes”—beginning, birth, origin)—the word denotes origin, process of formation and development of phenomenon. Life is developing natural phenomenon and the Man—is the particular manifestation of the Life, leading part of Life development. The Genetic Public Health is individual life in accordance to genesis of Man, with respect to man's roots. Shoot, being thrown away from roots, will have no future, no blossom as it would like to have. Life of any being on the Earth is controlled by its own genes. These genes are organizing its life supporting and developing it. Public Health, organized and controlled by Physicians form Medicinal Public Health, is being more distant from the Genetic one, than the Earth from Heaven. Public Health beyond the Genetic Public Health is being absurd in its base.

These ideas compose the concept of the Computerized Global Humanitarian BIOcultural Genetic ‘public health’ (briefly: the Genetic People's Health concept—the concept of Health without the medical ‘health service’).

Genetics (Greek “genetikos”—referred to birth, to origin)—is a science on laws of heredity and variability, its leading part is molecular genetics.

Gene (Greek “genes”—beginning, birth, origin)—is a material bearer of hereditary information, part of DNA molecule having capacity of self-reproduction and supply succession character of property of organism in generations. Organism is a form of Life's existence on the Earth. The Life as a natural phenomenon looks as living organisms from microbe and virus to human organism. Life organization is initiated by genes. Genes as those are a receptacle of information on support and development of Life for all millions years of its existence.

There is no Life without genes. Without genes no health exists. Without health no Public Health is. The Public Health can be genetic—based on Molecular Genetics representing a front line of Molecular Biology, based on Biophysics. Evidently, there is no place for Orthodox Medicine here. The Public Health as such is to be Genetic Public Health, other is unnatural one, being old-fashioned having no reflection of modern state of science on Life—Life as a whole on the planet Earth and in a human organism, Life as BIO, as natural phenomenon is single for all living beings on the Earth—this is extremely important in Public Health matter and we shall discuss it later on, as the ignoring of this fact leads to the greatest losses in everyone's health.

Start of the year 2000 was marked by a sensation: the structure of human genome was deciphered and henceforth the Public Health cannot remain traditional, orthodox, medicinal, treating this or that separate organ. The Public Health is obliged to rise on higher level—namely onto the level of Genetic Public Health, treating the organism as a whole. The Public Health beyond Genetic one is an absurd one. Life as a whole is created in living cell, it is formed there under genes' control, its set is individual for everyone and single to any living cell of a human body, where there are nearly 5 trillion and they all are being ruled by a single set of genes are functioned as one construction called human organism. It is known that, in a trice, nearly a billion of cells are changing: they divide, replenish and die off. During the day-and-night period, 20 billion new living cells are springing up having originated to substitute the cells spent out their physiological resource. Under natural conditions, the majority of body's cells make a source of 40-50 divisions and afterwards cells loses a capacity to produce exact copy of genetic information and it becomes dangerous to an organism. The Nature has elaborated special mechanism of defense against the danger: aged and weakened cell making a mistake in copying the genetic program, i.e. having disobeyed it, at this very moment launches a mechanism of self-destruction—it starts to produce enzymes destroying protein frame of the cells and so breaking off its life; the perished cell is utilized with aid of antibodies and immune complexes giving place to new young strong cells. On evaluation of biologists, the physiological resource of self-convalescence is estimated on 120-130 years of active life. The self-substitution of an aged cell by new one may occur 50, 30, or 1 time—all depends on vital conditions and correspondence of them to Nature's requirements. The self-convalescence may continue 130 years, either 50 or only 1 year—all depends on conditions of correspondence to Nature's requirements; nowadays to be ignorant and not to harm own health is impossible—it is reality of modern life, these are consequences of factual BIOignorance of those men failed to reach 130 years extremely rare due to occasional fortunate circumstances. To become reconciled with such a mass BIOignorance is unreasonable.

We shall repeat: the modern commercialized medicine is not interested in the BIOenlightening and BIOculture. But it concerns everyone—businessmen and not, physicians and not, ordinary men who eat something and drink something, who has this or that way of life, being unwell or seriously sick, afterwards complaining of Nature's imperfection but never of the mind's.—That's why Homo sapiens needs now BIOenlightening, BIOculture, the science and art of Computerized Global Humanitarian Genetic BIOcultural ‘public health’ (briefly: the science and art of Genetic People's Health)—the science and art of Health without the medical ‘health service’, science where the essence is given by data of the Genetic People's Health principles.

We shall repeat: the methods of popularization of the science are—thematic entertaining individual and collective games on the specialized “Computerized Global Humanitarian BIOcultural Genetic Public Health” Internet-site, but firstly the method of the science popularization for common ones including schoolchildren is being a specialized playing microprocessor devices: the Computerized Global Humanitarian BIOcultural Genetic ‘public health’ microcomputers and microprocessor toys for preliminary self-enlightening of an individual in the BIOculture and in the Computerized Global Humanitarian BIOcultural Genetic ‘public health’ principles and for subsequent simple, playing, easy-to-understand using of the science and art of Computerized Global Humanitarian BIOcultural Genetic ‘public health’ (Health without medical ‘health service’).

The BIOculture of an individual is being an intellectual method of self-defense of this individual from disastrous antiBIOlogical conditions from completely commercialized human society as the first and dangerous habitat environment of the Individual, additional to the medium habitat defended by Ecology science.

The 10^{th} principle of the Genetic People's Health and of the “BIOphilosophy of the Individual” (Individual is now under condition of human society commercialized to the core):
The laws-requirements of the Creator of Life on the Earth and of that very Life in the everyone's organism were formulated by the wise representatives of the humanity in the scientific and religious books also. To ignore the laws-requirements of the Creator, that is not reasonable, and, not important, whether these laws-requirements were formulated in the Bible and in the Koran or in biology and physiology. This is the reason why the science and art of Computerized Global Humanitarian Genetic ‘public health’ (briefly: the science and art of Genetic People's Health—Health without the medical ‘health service’) is based on the principle of complementarity in biology and religion.
This is the tenth principle of the Computerized Global Humanitarian BIOcultural Genetic ‘public health’ (briefly: the Genetic People's Health—Health without the medical ‘health service’). Detailed commentary of this principle is given below.

We shall try to show that not to trust in God (single to three world religions) is not logical from the point view of modern molecular genetics.

The genetic code is a system of hereditary information in DNA and RNA in human, plants, animals, and microorganisms. Genes are material carriers of the code.

Genes are located in chromosomes. The latter carry DNA. Gene corresponds to a part of DNA molecule. It may bear from tens to 1500 nucleotides, and everyone contains millions of different atoms united into an arch complicated individual atomic structure of separate gene (a question is possible how billions of atoms in chaotic spatial movement suddenly managed to be at one point and molecular forces have caused their confluence into a gene?).

There are a lot of complexities in gene: it is not common atomic union, but is a material bearer of genetic program—bearer of genetic information and operators of its realization reminding a diskette with software for a computer or a book with printing out of sequence of letters, figures, symbols. That is, the sequence of nucleotides in DNA and RNA molecules is not accidental as letters and words in a text of some written instruction. These segments of nucleotides comprise genetic code.

It is difficult to agree, that the monkey sitting at the computer and striking on the keyboard, would print suddenly a “Legislation book” of some country. It seems unreal for a reasonable man to accept this occurrence. And it seems more accidental when billions of necessary atoms are turned out in one point, where they had fused into nucleotides and form a strictly arranged sequence representing the genetic code of certain unicellular being—first living formation on the Earth, that, in course of evolution has given rise to all living creatures including ourselves.

Those ones accepting the reality of this occasional event in observed time of expectation, are atheists.

Others, who does not consider the reality of this event, are believers, that is why they trust in the Creator called the God, single God for all religions.

Remaining dwellers of the Earth are still not thinking on these matters, biologists could not inform, what is the difference between Homo Sapiens and the “younger brothers”.

The conclusion: the belief in the God is a logical from the viewpoint of modern molecular genetics. It is not surprising, that many scientists sincerely believe in the God and it does not prevent their scientific activity.

We shall repeat again. The genetic code is a system of fixation of hereditary information in DNA and RNA molecules in men, animals, plants, microorganisms. Material bearers of the code are genes located in chromosomes. Chromosomes contain DNA. Gene corresponds to a site of DNA molecule. This site may have from tens to 1500 nucleotides, each uniting in its structure millions to billions of definite atoms.

A matter of imagination, is it possible to unite in certain spatial configuration one trillion of multicolored balls for codifying the arch-complex (similar to software products to animate a computer) information? But any living cell, for instance in ordinary rice grain, is capable to realize it—living cells are revitalized, dying off, multiplied by division and during that, are forming new DNA molecules with the absolute copying of genetic program, single to definite concrete plant and this program is much more complicated, than all the computer programs are.

One can add two scientific facts to this one in the choice of his outlook, for organizing the life. First: the genetic code, is a basic law of Life, the only one to all the living creatures, from virus to a human organism, living on the Earth. Second: the genetic code, from the viewpoint of physics and information theory, is not accidental, in other words, the assumption of causality of a genetic code runs counter the physical laws and the postulates of information theory. So, one is to recognize, that the genetic code had appeared as a result of its own evolution, having its own history of appearance and development long before the Life had appeared on the earth. So, the genetic code, a central law of the Life has a proper pre-biological evolution.

The very facts of pre-biological and universal character of the genetic code are to base the following conclusions. First conclusion: genetic code is, in its essence, an intellectual product existing clearly and evidently, and being created long before the Life; so, a genetic code has its author, the Creator, for no intellectual can be without its author. Second conclusion: the unity of genetic code for all the living beings is an evidence of existence of the Creator of all the living ones from microbe to human organism tell us, please, how can you talk about your organism and its normal and correct activity (so, on Health) saying nothing about the existence of its Creator? The notions “correct” and “normal” denote: according the rules and norms of the organism's Creator, aren't they? You may not know and ignore the rules and norms, but how may you be healthy in that case? The final conclusion is: we are obliged (obliged!) to cognize personally and to follow meekly the requirements set by our Creator.

Speaking on Creator in science the term Nature is used. In religion the term God is used. It stands to reason, from usage of diverse term the essence of the Creator as such is not changed. It is revealed out of dependence whether we accept it or not, either recognize it or not. Thus, the Creator exists and reveals Himself for believers and for atheists.

The laws-requirements of the Creator of Life on Earth and Life within everyone's organism are discovered, studied, generalized by the biologists, geneticists and set forth in their works. To escape these laws-requirements, to anyone, is ignorant, as cells are living following them, these cells making him healthy or ill, strong or weak, vigorous or gloomy, these cells are waiting from their master a supply with proper nutrition and proper way of life in exact correspondence with the laws-requirements of the Creator. We repeat—to disregard these laws-requirements seems the ignorance.

These laws-requirements of the Creator were formulated by wise men in scientific and religious books. That is why the science and art of the Computerized Global Humanitarian Genetic Public Health (Health without medical “Health Service”) are based on the complementarity biology and religion.

To sum up, it is impossible to charge somebody to live the life given to each of us by the Creator, it is impossible to engage somebody to exploit your own organism and to support its health state, otherwise to support its correct and normal activity. That is why everybody is to know himself the laws-requirements of usage of the device called human organism. These instructions for our organism exploitation were given by the wisest representatives of the humanity in biology manuals and in fundamental principles of worldwide religions as in the Bible or in the Koran. The manuals on exploitation of our organism, their knowledge and application are of personal care of each of us. If someone proposes you to take the decision of this problem off you, he would obligatorily demand money for this care for he is interested in your money—that is all.

To conclude, two main statements are repeated.

The first one. The start of the IIIrd millennium was marked by a sensation: the structure of genome is deciphered and nowadays the Health Service is raised onto a genetic level. We add two aforementioned facts to that: the genetic code is single to all living beings of the Earth, and from the viewpoint of physics and information theory it is not accidental—it has its own evolution being before biology (=pre-biological). This feature of a genetic code and its universal character prove positively an occurrence of the Creator, named as the Nature in science and the God in religion; both words do reflect the same idea occurrence of the Creator whose laws-requirements are to be followed and it is not important, where they have been formulated, either in the Bible and the Koran, or in biology and physiology. So, with proper respect to the spiritual and scientific heritage of humanity, the health-servicing potential of genes is really limitless, for it is a potential of the Creator of Life—experience of all the Life during its existence. Other (that is artificial) health service is pseudoscientific, immoral, unnatural, contrary to the Creator, otherwise initially absurd, that is absurd genetically.

The second one. It is doubtless, that in this century the science of Health service will pass from physicians to geneticists. But there is no shade of doubt that the Commerce and almighty Money, now reigning physicians, will subordinate geneticists also, forcing the latter “to create commercial health” by their penetration in genes' activity of our organism. That is, geneticists, for the benefit of financial interests of corporations will be obliged to invent for poorly educated persons the “genetic commercial means and services for improvement of living cells' activity of human organism”. So, this vicious circle will close, Commerce and Money will be above Biology and Genes, the corporate financial interests will suppress the biological interests of human organism—and it concerns all of us, including the shareholders and workers of these corporations, geneticists and non-geneticists, as the up-to-date publicity is elaborated by the best psychologists and it can subordinate the psychology of highly educated class, not only of ordinary people and kids without higher education—that is practically of all the humanity.

These two moments cause us to base the support and reconstruction of our own health on scientific and Divine laws—this is a reason for the science and art of the Computerized Global Humanitarian Genetic Public Health (Health without medical “Health Service”) to base on the principle of complementarity of science and religion.

The 11^{th} principle of the Genetic People's Health and of the “BIOphilosophy of the Individual” (Individual is now under condition of human society commercialized to the core):
Scientific laws and Divine laws are, in their essence, parallel (non-crossing over) and they cannot contradict one to another or compete, but are only supplementing each other usefully as color and odor of an apple are non-crossing, and are incapable either to contradict or to compete, supplementing each other usefully only. The real Health Service is based on registration of scientific facts and natural laws—it seems evident but this real Health Service is based logically on accounting the Divine Laws. We'll try to assure ourselves in it.
This is the eleventh principle of the Computerized Global Humanitarian BIOcultural Genetic ‘public health’ (briefly: the Genetic People's Health—Health without the medical ‘health service’). Detailed commentary of this principle is given below.

Scientific fundamental knowledge on Life are published in proceedings of following sciences: molecular genetics, molecular biology, biophysics, biochemistry, general biology and physiology. There is no sense to convince anybody in reasonable and useful fixation of these knowledge in life organizing and for personal Health Service.

The religious fundamental knowledge of Life is issued during millennia in works of our wise ancestors as in the Bible and the Koran. Besides known difference of three modern religions they are singe in Ten Commandments (“Honour your father and your mother, so that you may live long in the land the LORD your God is giving you”, “You shall not murder”, “You shall not commit adultery”, “You shall not steal”, “You shall not covet your neighbour's wife” etc.). It seems reasonable to attempt to show atheists, that the oblivion of these God's Commandments by somebody have severe physiological sequences for them, for example, good and normal digestion when with excellent and complete nutrition living cells of them will starve and there is no need to say on health and good spirit in that case.

Really, cells of human body get nutrition substances via blood and lymph, those ones get these substances on walls of gastrointestinal tract after digestion of eaten food. All these processes of digestive splitting into nutrition substances and wastes, processes of further transportation of nutritive substances to cells—all they are regulated by the nerve system and operated by endocrine system. Let us suppose, that some person we call him a sinner, does ignore some of Ten Commandments, as he contradicts to father and mother, or murders, or steals, or insults his wife, mother or his children, by encroaching upon of alien wife (having ruined both families), or simply envien to the neighbor—in all these situation the disorder of nerve system is inevitable and there is no need to be a physiologist to realize that. Nervous disturbance will cause digestion decay in healthy and strong digestive system and in its turn will cause starvation of living cells of the sinner even if he would swallow excellent food in sufficient quantities. In case of cells starvation one cannot expect their normal activity, otherwise “Health as an activity of an organism” for sinner breaking the God's Commandments is unattainable.

Conclusion: real Health Service is based on accounting of scientific facts and natural laws, but it is logically based on Divine laws. Scientific and Divine laws are located in parallel non-crossing spaces and they cannot contradict or compete, wholly complementing each other, as color and odor of food table are supplementing each other when we make a choice it is worth to eat or neglect the food, or whether is it worth living so or not.

We shall repeat again. The very facts of pre-biological and universal character of the genetic code are to base the following conclusions. First conclusion: genetic code is, in its essence, an intellectual product existing clearly and evidently, and being created long before the Life; so, a genetic code has its author, the Creator, for no intellectual can be without its author. Second conclusion: the unity of genetic code for all the living beings is an evidence of existence of the Creator of all the living ones from microbe to human organism tell us, please, how can you talk about your organism and its normal and correct activity (so, on Health) saying nothing about the existence of its Creator? The notions “correct” and “normal” denote: according the rules and norms of the organism's Creator, aren't they? You may not know and ignore the rules and norms, but how may you be healthy in that case? The final conclusion is: we are obliged (obliged!) to cognize personally and to follow meekly the requirements set by our Creator.

We shall repeat again. Speaking on Creator in science the term Nature is used. In religion the term God is used. It stands to reason, from usage of diverse term the essence of the Creator as such is not changed. It is revealed out of dependence whether we accept it or not, either recognize it or not. Thus, the Creator exists and reveals Himself for believers and for atheists.

We shall repeat again. The laws-requirements of the Creator of Life on Earth and Life within everyone's organism are discovered, studied, generalized by the biologists, geneticists and set forth in their works. To escape these laws-requirements, to anyone, is ignorant, as cells are living following them, these cells making him healthy or ill, strong or weak, vigorous or gloomy, these cells are waiting from their master a supply with proper nutrition and proper way of life in exact correspondence with the laws-requirements of the Creator. We repeat—to disregard these laws-requirements seems the ignorance.

These laws-requirements of the Creator were formulated by wise men in scientific and religious books. That is why the science and art of the Computerized Global Humanitarian Genetic ‘public health’ science (briefly: the Genetic People's Health science the science of Health without the medical ‘health service’) are based on the complementarity biology and religion.

The 12^{th} principle of the Genetic People's Health and of the “BIOphilosophy of the Individual” (Individual is now under condition of human society commercialized to the core):
At organization of individual life in human community in connection with globalization of capital and integration of countries, it seems reasonable to turn from modern commercial “Public Health” (Health via medical “Health Service”) to the future non-commercial “Public Health” (Health without medical “Health Service”) basing this concept on the principles of complementarity of biology and religion. According to the Computerized Global Humanitarian BIOcultural Genetic Public Health concept, not to believe in God is not logical from the viewpoint of general biology, physiology and molecular genetics. This is an excellent biological and religious basement for reconciliation of all the people in globalization processes and in decision of “Social Problem of Natural Hygiene and the Individual”, raised half a century ago by the progressive physicians of USA in American Natural Hygienic System and being remained still unsolved. We shall discuss now the processes of globalization within the frame of our topic: “Computerized Global Humanitarian BIOcultural Genetic Public Health (Health without medical ‘Health Service’)”.
This is the twelfth principle of the Computerized Global Humanitarian BIOcultural Genetic ‘public health’ (briefly: the Genetic People's Health—Health without the medical ‘health service’). Detailed commentary of this principle is given below.

At first, we shall make a remark of social character, and, afterwards, we shall turn to the biological outlooks on the given Computerized Global Humanitarian BIOcultural Genetic Public Health principle.

To all appearances, the XXI^{th} century will be “The age of integration of nations and countries in connection with capital globalization”, it is absolutely inevitable and it exposes and sharpens such humanity's problems as 1) inevitable arch-difficult consolidation of nations of Europe and Asia, 2) inevitable arch-difficult approaching of spiritual cultures of the East and the West, 3) inevitable arch-difficult reduction to the common denominator of extremely commercialized and growing fat civilization of the West and counterpoising lean civilization of the East (referred to Japan, China, India, Russia and the CIS).

These essential problems of humanity are to be solved by the politicians and businessmen. It is reasonable to bear in mind firstly that fates of the world are fates of common people, their food, their way of life, their health, secondly money and wealth do not always bring health and happiness. In sociological studies, in reply to the question “Are you happy?”, the Easterners answer affirmatively more often than the Westerners, who are more well-to-do. So, (1) people's nutrition, (2) their way of life, (3) their health—are three key matters of attention in the American Natural Hygienic System—are to be placed before wealth and money in performance of processes of capital globalization and integration of countries and nations. In this third wish, and in difficulties of its fulfillment, the gist of the “Social Problem of Natural Hygiene and the Individual” is contained.

Among the problems and troubles made evident by the globalization process, the problems connected with the Public Health are evidently and reasonably paramount, for the Life and Health are absolutely primary both for every man and for the humanity as a whole.

The globalization of the capital, the globalization of the human relations, the globalization of the mechanisms of community building—all these processes of globalization are seeming to be natural and unavoidable, for they (these processes) are uniting the reason and intellect of the whole humanity and sore increasing the might and efficiency of the reason. It seems to be evident, that the globalization of the economic mechanisms is impossible without the merger or a fusion (or the common denominator) of the Western and Eastern civilizations, without the globalization of the spiritual heritage especially as of the Bible and Koran, with which the humanity is not parting for the next millennia and with which it will hardly part in the future.

Yes, the Western and Eastern civilizations are different. They are, however, unite because of the unity of the Man as such. That's why the way to the Globalization is opened here.

Yes, the Bible and the Koran are different. They are, however, unite because of the unity of the God as such. That's why the way to the Globalization is opened here, too.

Yes, the way of life and the very scale of spirituality of the Western and Eastern people are different, in particular in the area of spiritual culture, in the understanding of the woman's role in a basement of a family life, in the relation to an alcohol and so on. They, the Western and Eastern people, are, however, unite because of the unity of the human Health as such, for it is unite for the every human organism and for it depends on the human way of life, first of all. That's why the way to the Globalization is opened here, too.

And, moreover, all the processes of the economic and managerial globalization are to be initiated, reasonably, starting from the search of the reasonable common denominator of the spiritual cultures, that is: from the best or the logicalmost and reasonablemost of the Western and Eastern cultures. That means, the logicalmost and reasonablemost from the viewpoint of the Biology and Genes, not of Commerce and Money (first the Health, then the rest).—This is the miraculous motive for the Western and Eastern cultures to leave the announced pathway of force, bellicosity and deadlock, and to enter the perspective, reasonable and concordant pathway (first the Health and the Reason, then Commerce and Money, for it is hard to live with no money, but it is impossible to live with no health).

Some suitable linguistic reference. The Culture is a combination of the human achievements in the areas of production, social life and intellectual life. The cultural means the occupying a relating high level of culture. The spiritual means the relating to an intellectual activity and to the spiritual area. The spirit is an element determining the behavior and the psychical abilities of a human being, its internal moral force. The conscience is a human ability to think, to meditate and to determine an attitude to the reality. The thinking is a process of reflection of the objective reality in the intelligible terms, notions and judgments. The Man is a living creature having the abilities of thinking and speech, an intellectual leader of living matter's development, the leader of Life development and its master on the Earth. Life is a specific form of an existence and movement of the matter, revealed in the existence and activity of organisms, including the human one. Matter is an objective reality existing beyond and independently of the human consciousness.—That is this point, these circumstances are a solid motive of necessity to talk on science and religion, spiritual culture and spiritual heritage of humanity, as on the excellent mark in the human activity and the reliability of this mark and its non-contradictive character (with the scientific reference points) has been checked with centuries.—That is why one should find firstly the common denominator in spiritual culture of the East and the West, otherwise the globalization process may face with the insurmountable obstacles.

The 13^{th} principle of the Genetic People's Health and of the “BIOphilosophy of the Individual” (Individual is now under condition of human society commercialized to the core):
In the processes of globalization, it is necessary to find a common denominator in the spiritual cultures of the East and the West, otherwise insurmountable obstacles are probable for the processes of globalization. And the science of Computerized Global Humanitarian BIOcultural Genetic Public Health may serve as such a common denominator, for it first talks about the human way of life, and spiritual culture as such talks about the same: the way of life, that, in its turn, determines the man's health. The ways of life preferred in the East and in the West are differed strikingly, but the organism is single, the sciences of biology and genetics are the same, but the spiritual marks and relations to the heritage are clearly different. What way of life is more reasonable from biology's and genetics' points, what way of life is more preferable for human organism? The reply would be given by the science of Computerized Global Humanitarian BIOcultural Genetic Public Health and it (the science) may be an independent and objective arbiter in the discussion of persons preferring spiritual cultures either of the East or of the West. The already advertised solution pathway of force and bellicosity seems to be a blind alley. The decision of the discussion in the frames of the Computerized Global Humanitarian BIOcultural Genetic Public Health science is perspective in its definition, as in biological notion everybody is Homo sapiens (Human thinking being) whose occupation is better at the negotiation table than in the field of battle and blood.
This is the thirteenth principle of the Computerized Global Humanitarian BIOcultural Genetic ‘public health’ (briefly: the Genetic People's Health—Health without the medical ‘health service’). Detailed commentary of this principle is given below.

Nature—this is all the existing in the Universe (organic and inorganic worlds, the living and dead matter), it all exists independently of human conscience, so it was once created and has the Creator who, from the scientific viewpoint is His Majesty Chance and from the point of religion the God.

From the scientific viewpoint, this “created and existing” had appeared itself by the will of the Chance. Scientifically, it is supposed that “the everything created and existing”, has appeared occasionally. If it is so, then the Chance rules the world, it operates us and each of us, as nobody except us and the Chance continues to govern; there are some means to submit it and to become a Master of Nature. That is a limitless field is opening for permissiveness to each of us, empowering and doubting at the same time.

The authors of the Computerized Global Humanitarian BIOcultural Genetic Public Health principles are inviting the readers for the reasonings on the topic with the next meaning inlaid into words: outlook, soul, spiritual, observer. Outlook—is a system of views and opinions on Nature and society. The soul is an inner, psychological world of man, its conscience. Spirit is a conscience, mentality, psychological abilities, and element determining the behavior and action. Observer—man practicing the inactive observation, a passive keeper on the events; that definition does not reach the scientific notion of the Homo Sapiens as of the intellectual leader in the Life development on the our beloved Earth.

We realize our everyday life a bit dualistically, looking from the two levels: from light, “sensitive”, attainable even by kids, and from hard, “Logical”. Sensitive—subjective Life is: everyday, personal and “artistic-romantic life” in novels and movies, close to us and capturing us from the very childhood, while the “biological life of our organism” in biology textbooks is completely out of our interests. The first is bright, emotional, attractive and it reminds the childhood. The second is dry and boring, as dry and tedious the grown-ups in kids' eyes are.

So, we use two words: “life” (small letter) and “Life” (big letter).—What do we want to say or emphasize? What is the difference in the sense, contents of these too similar words? Why in combination of words “high life” is simple impossible to use word “Life”, while in biological Life the usage of term “life” covers too much, hides real essence of ideas and from the our reflection? So let us establish some order in our thoughts and reflections in relation to these two related and different notions of the “life” and the “Life”.

It is clear, that without the “biological Life” no “high life” is possible, for without roots no plant is possible. So, we are starting form the our common “biological Life”, where we shall clarify its inner sense and later on we shall say a bit on our “high life”, for there is no use to discuss it in details: it is reflected in the millions of novels—the novels red enthusiastically from the very childhood in contrast with the scientifically boring biological manuals.

So we are starting from the very beginning, namely: how did we reach this “biological Life”, where is our “origin of the origins”, how and when have we first seen the God's World?

Here is the “origin of the origins” for each baby. In the body of mother of the future child, to continue of her genus, due to the Creator's Will, of the non-living molecules of food, in the blood, the protoplasm of some living cell called “ovule “had appeared by some miraculous way. (It happens specially to continue the genus!—we the sinful creatures are trying not to remember it while looking for the periodical sexual adventures in our “high life”, or while dealing with abortions and contraceptives willingly offered for reasonable payment by our Commerce, which is, in exchange for our money, eager to satisfy our every wish with no respect whether is it desired by the God or not; for the Commerce is an attribute of our banal “mind-reason” and of our “high life”, not of the Creator and of our “biological Life”.) Analogically, in the body of the future father, for continuation of his genus, due to the Creator's Will, of the non-living molecules of food, in the blood, the protoplasm of some living cell called “spermatozoon”, had appeared by some miraculous way. (It happens specially to continue the genus!—we the sinful creatures are trying not to remember it while looking for the periodical sexual adventures in our “high life”, or while dealing with abortions and contraceptives willingly offered for reasonable payment by our Commerce, which is, in exchange for our money, eager to satisfy our every wish with no respect whether is it desired by the God or not; for the Commerce is an attribute of our banal “mind-reason” and of our “high life”, not of the Creator and of our “biological Life”). The father and mother of a future baby had come into a sexual contact searching for sensual sensation for stimulation of the genus extension. And, so, two living cells (spermatozoon and ovule) in the mother's body, in accordance with the Will and the means of the Creator, are being fused into a new single living cell named by biologists the zygote, the very first cell of a future human being.

In a nucleus of the zygote, the molecules of DNA and RNA are located, being a custodian of genetic data from parents to the future man. Further division of the zygote onto the daughter cells occurs with copying genetic information into their nuclei. During this self-division, under a genetic control, the cells are starting to specialize for a future activity. Specialized tissues are appearing, and the organs (e.g. heart, hepatics, brains, etc.) are self-organizing from them, later on uniting into systems of organs and at last an organism is born.

So all the events are mutually inseparable, indivisible, indissoluble, united and they all are linked with the Creator. Namely at the very moment of conception, the moment of the fusion of spermatozoon and ovule of our parents and formation of the zygote, the first Living cell of our body and organism,—the Creator supplies each of us by the personal genetic program understood completely to the Creator only. It is arranged in every cell of body for the control of cellular life and for supply of whole organism, while the cell's dimensions are encountered in microns: such is the Creator's control upon us!

That is how our personal “origin of all the origins”, from the biological viewpoint; we must be grateful to the Creator for all this. So do we become the part of “the biological Life on the Earth”.

And what further? Firstly, after a birthday, our “biological Life”, having been started in the zygote 9 month before our appearance, is continued to be created in our body until our death, under a strict supervision of the Creator. Often enough, we don't guess on it, and if we do, we frequently try either to ignore the fact or not to think about it. Secondly, after the birthday, our social life starts, being expressed in the interrelations with other ones, work, salary, prices, “relaxations”, intrigues, cunningness, “good end evil”, “laugh and tears”, and other positions from the vocabulary of artistic-romantic life we are supreme experts in. But in the real biological Life we are not.

The “Biological life” is linked directly and fully with the Creator, it corresponds to the notions and requirements of the Creator, which are partly explained in the biological manuals: “Biological life” is a subject of biologists' studies.

At the same time, the “high life” corresponds to the notions and requirements of the so called “higher society”, which are somehow lower than the bottom (you may confirm the impression having re-read the usual novels with sexual adventures, cunning intrigues, and other sophisticated intra-personal pleasures). The notions and requirements of the “society” are expressed by some idioms like “life-style”, “image”, “fashion”, “protocol” and others for the mutual conceit; if you want to detect the roots, the dictator of all that, you are welcome to find anything except Her Majesty the Commerce. Please, try to form the two lists, which will make you meditate widely up to some nasty conclusions on our common life.

The first list. The Commerce proposes us the following goods and services “for support of biological life of man”—for the Life of organism, for the support, continuation and development of real Life, based on the Supreme Reason of the Creator—being discussed in biological manuals: 1)______,2)______,3)______, etc.

The second list. The Commerce proposes us the following goods and services for support and development of fashionable, stylish and artistic-romantic life in the society, not limited with the Supreme Reason of the Creator and reflected in not biological manuals but in novels: 1)______,2)______,3)______, etc.

And please have a look onto the great difference in length and price scale in the lists and . . . get terrified: what are we spending our money earned with great sweat on—on hardening of health or on annihilation of the latter? Certainly, the biologists hurried with calling us as homo-sapience, Man Reasonable or reasonable being. Being—yes, but reasonable a great doubt and a far future.

The authors of the Computerized Global Humanitarian BIOcultural Genetic Public Health principles will reach their final goal, if the readers will share the authors' understanding of the real Health of a man, the understanding based on the fundamental knowledge of the Life as such, as BIO. This comprehension of Health leads to make further conclusions, for instance on marriage, family fidelity and (don't be surprised !) sexual excesses in “social” life, “love affairs” in resorts, at work, accidental ones—to all then we adhere two sacred words: love and liberty (liberty in love or of love).

We shall discuss it from viewpoint of the basements of biological knowledge on Life, Life of organism being unique and single and being described in the manuals, not in the un-fresh novels. Let us start from a very brief repeating of the once said for the sake of our deepest comprehension of fundamental BIOlogical concepts on life.

The Life on the Globe is represented (to our sight) by the living organisms, vegetable and animal, human organism being one of them. Living organism forms the third level of life organization by the Creator, living cells—the second one, while the genes form the first and program level. Life starts from them, they bear the program for Life's support and development.

Genes are material bearers (like the diskette with software is) of genetic program and operators of its realization; genes do launch, direct and control the activity of every living cell on the Earth. These are genes, their role and abilities.

Genes exist and launch the Life—it is impossible to disagree with that. And if genes are already created, it is impossible to disagree with their Creator's occurrence. Attempts to use the notions like “Chance” are unreasonable.

A new note for useful comprehension: the secrets of genes will be further analyzed for many millennia; these problems of cognition of the existing and created Nature are our problems but non the Creator's ones. The main problem of our cognition is the intention of us to get, with our reason-mind, higher than is the Supreme Reason, creating the Life which we so often are destroying.

So these are genes created by the Creator, the Life formed by the genes and we, sinners, in it, being even unable to guess that our body is build of living cells with our own personal genetic program written by the Creator into each cell's nucleus—so the Creator, through genes, presents really in the every cell of our body.

We can identify: the genetic Program inlaid in each nucleus of the living cell on Earth represents that the sane Supreme Reason had been mentioned even by Plato. This Supreme Reason, creating and supporting the Life on the Globe and our BIOlogical life of everybody, is not a philosophical speculation, but an observable materialized reality as this Reason is codified by Nature in an extra-complicated network of billions of atoms within DNA molecules of our body. We emphasize specially: it is codified and inlaid for 9 months before our birth. It seems so, the “Eye of the Creator” and “His reactions upon our deeds” are inlaid in the every cell of our body at the very first second of our conception—namely at the moment of fusion of spermatozoon and ovule of our parents.

So our body and organism as a whole—consists of aggregated living cells acting in accordance of with the genetic program at the moment of parents' spermatozoon-and-ovule fusion and zygote (being ancestral living cell of our body and organism) formation. The Creator (the Nature the Lord, as you will) supplies us with the personal genetic program for control of each cell's life. The Creator, with the aid of genes, is present in the each cell of our body.

The question rises—for what aim the urgent control from the Creator is used? The reply is simple—at the moment of fusion, the Creator takes us “as a full partner” for elongation of family genus of everybody and so for the continuation of the Life on the Globe. We almost never (especially in our sexual adventures) think about this important fact.

From the viewpoint of the biology, each of us is a full partner to the Creator in the life continuation and development. Therefore, our wedding is certainly sacred, our fidelity is certainly sacred, our family is certainly sacred, our children are certainly sacred! A deviation from the holiness, we name is as a “sin”, is being tempting like a hop and too sweet, however, in spite of it, not everyone is alcoholic or drug addict. For everyone knows its own “limits” of “useful drinking” or “safe sinning” to be merry enough, for we know our hangover is a kind of punishment.

We realize clearly, especially from the medical and biological manuals, that the Creator is able to catch us sinning and to punish us by the means of Physiology—we thank biologists and physiologist for such a valuable information. It seems, that the era of BIOlogy and BIOeducation is coming to everyone's mind and conscience.

You may see it yourself on the following addition to abovementioned: an addition on sexual excesses widely cultivated by the Commerce under a slogan of “Freedom in love!” meaning love not connected with continuation of the genus but permitting the Commerce to supply us with great lot of superfluous goods and services.

It is noteworthy: the freedom in love (it means freedom in copulation without any relationship to 10 the continuation of family) between men and women is proclaimed and proclaimed by the Western culture causing the greatest malice in the Eastern culture where over-conjugal freedom is prevented strictly on religious level.

The Eastern explicit spiritual culture rejects the permissiveness in Commerce, which is being permanently ready, for the sake of money and profits, to buy and sell everything including body, and soul, even the life, for the first slogan of Commerce is “money don't smell”.

The spineless Western spiritual culture is under the Commerce' thumb and it silently allows to sell a great lot of harmful goods and services under the slogan “freedom in love!”: money are money and they are to satisfy any of our wishes. The Western spiritual culture does not even try to dig a bit and to see the evident fact: the Commerce in love is a commerce without any moral and religion, for these two attributes are inseparable from the spiritual culture, and sore alien to the Commerce.

Two circumstances are considered as rules in Commerce: 1) nobody can survive without money in human society; 2) too much people can survive without moral in human society.

Diverse cosmetics, children including, various ornaments, “erotic and sex appeal” in female clothes, “erotic and sex appeal” on stage and various shows, “erotic and sex appeal” in million-copy issues with pornography to our kids; “intimate services by phone and at home”, “intimate services in specially adapted places”—we are paying for all it of our own pocket, not thinking of the necessity.

For the continuation of the family and Mankind in accordance with the Creator's requirement? For the sake of own house and the beloved pious rest within? For our own family and its happy life? For our own children? For our husband or our wife? For the God's Commandment VII—“you shall not commit adultery”? (Exodus 20;14.) For the God's Commandment X—“you shall not covet your neighbor's wife” ? (Exodus20; 17).

No, it is for other sake. Briefly, for aimless. To enter “into society” for “society life”, “For amuse and merriments!”. “For business love affair”! Briefly for extramarital aimless, instinctive saturations, which were originally set by the Creator to stimulate the continuation of our genus.

The additive great lot of superfluous goods and services to be “high life” are ordered from the Commerce, then paid of own pocket with no reflection on whether is it.

The Medicine, as an obedient servant, is silent on the pernicious action of sexual excesses; moreover, it propose to us special pills and drugs for rising the sexual potential, in case then our organism is weak enough and resists the excesses in sex.

Hygienists—professionals of the American Natural Hygiene System, have enumerated typical widely distributed sources of body intoxication via dyspepsia within healthy gastrointestinal system and do refer sexual excesses to the beginning of list nearly after overeating, neurasthenia and bad foodstuffs combining (sexual excesses are fourth in the rating).

The matter is, that in all four cases, the digestive juices are discharged too slowly or too little and, secondly, as a sequence, the reception of splitting carbohydrates and proteins incompletely treated by these juices and receipted by mucous of intestine are decaying for almost 24 hours.

It is clear, that sexual excesses demand higher productivity and spending of valuable proteins and enzymes and hormone of endocrine system regulating and operating all bioprocess of digestion—so dyspepsia originates in completely health, digestive system. To take toxins off the organism, great amounts of vitamins and minerals are spent from physiological resources intended for old age and we are curtailing the life itself and its quality.

We realize clearly, especially from the medical and biological manuals, that the Creator is able to catch us sinning and to punish us by the means of Physiology—we thank biologists and physiologist for such a valuable information. It seems, that the era of BIOlogy and BIOeducation is coming to everyone's mind and conscience.

Now we repeat typical features of Western fashion: diverse cosmetics, children including, various ornaments, “erotic and sex appeal” in female clothes, “erotic and sex appeal” on stage and various shows, “erotic and sex appeal” in million-copy issues with pornography to our kids; “intimate services by phone and at home”, “intimate services in specially adapted places”—all it is ordered by us to Commerce under impact of Western culture all its is paid by us. For the sake of own house and the beloved pious rest within? For our own family and its happy life? For our own children? For our husband or our wife? May be for a quite different—for social life with amusements, intrigues, treachery? For the appearance in “high” society to satisfy own pride-vanity!

For addition: a great lot of goods and services are ordered to Commerce for realization of those, including drugs, alcohol and cigarettes being paid by us without any idea whether we need them or not; as results those sexual and other excesses originate, being so harmful for family fidelity, for our own health, for bringing up children by our own example, etc.—in our haste we has no time to estimate it due to our, as we name, BIOignorance.

And, remaining unseen for us, it occurs, what usually is called the “stupidation of the masses and pushing them down to the animal level”.

Thus, realities of everyday life force us to part with sensual (artistic-romantic) outlook of life and to pass to reasonable BIOlogic acceptance when everyone becomes a full partner of the Creator of the Life on its continuation and development on our beloved Earth.

The 14^{th} principle of the Genetic People's Health and of the “BIOphilosophy of the Individual” (Individual is now under condition of human society commercialized to the core):
Life realities do force us to leave emotional (artistic-romantic) level of life perception and enter its reasonable BIO+logic level given in biology manuals and so, in this connection, we shall discuss BIOlogical Expedience as such (its contents is explained beneath).
This is the fourteenth principle of the Computerized Global Humanitarian BIOcultural Genetic ‘public health’ (briefly: the Genetic People's Health—Health without the medical ‘health service’). Detailed commentary of this principle is given below.

Our diseases, our poor well-being, low quality of our life do represent a king of prompting from the Nature, a prompt that our way of life does not correspond Its demands and Its expectations in exchange for given life and huge physiological resource of body in young age when we don't think about health; the resource is given as a minimum for 120-130 years of vigorous life. But the Nature, having given life to us, is probably not interested personally in everyone after his appearance on the Earth. It is probable that, when we step off natural pathway, we do feel a consequent prompt of Nature in a form of poor well-being. Nature does stimulate us to the natural way of life. It stimulates—that means, it directs. So we are obliged to understand Nature and Its demands. We cannot survive simply without knowledge, without information, without biological expedience of the existence, without subordination to that expediency. It is proved by the superior Life organization within our body, really within our corporal cells.

The Nature starts informative (perhaps theoretical) organization of Life on the Earth by the Genes—material bearers of the Genetic Program, and it does accomplish Life in cells, structural units of Life and, later on, in organisms consisting of the cells.

The Living Cell is a biomicroprocessor device of fabulous complexity, which does practically perform that very Genetic Program on creation, provision and development of Life on the Earth.

Those scientific data on Life as a whole and, so, on real Health and most important (primary) pathways of convalescence are given to us by biology (a set of sciences on living nature) and by physiology, science of life provision and vital activity of organisms and separate cells. So, we do start to shape our convalescence from the most general and fundamental biologic-physiological knowledge of structure and demands of human organism, that is, from the knowledge on Life and Health: main things are to be taken first.

That's why we do repeat for ourselves again and again one and the same essence. The Life on the Earth is represented by organisms, and by nothing more. Human organisms are only one of them, being inseparable from other ones. Any organism compiles an aggregate of living cells and nothing more. Any act, even the simplest, is being performed by the living cell only under a genetic program in its nucleus, and in no way more. So, Life on the Earth is being accomplished in accordance with genetic programs, individual to any organisms separately taken. Genetic program as such is multi-year experience of the Nature on life support on Earth and nothing more. Any given living cell is an arch-sophisticated physical-chemical system and nothing more.

So, the Life on the Earth is performed by the great plenty of physical and chemical bioprocesses in every living cell of every organism. Any separate process in any given object is not occasional, being caused by a genetic program (multi-million-year experience of the Nature), depending on biological expediency of the process. The activity of all the living cells does determine the life and activity of an organism. This given organism does support the life of a community. The community supports the Life on the Earth. But the Life does begin and is performed in the Living Cell, which bears the Genetic Program, the Nature's experience on 1) creation, 2) continuation, 3) support, and 4) development of the Life on the Earth.

If Plato, the ancient philosopher of Greece, was right that so called Highest Reason, which we can not understand, does exist somewhere in Nature,—one can suppose that, in connection with studies of informative secrets of structure of DNA molecules, this very Highest Reason of our Creator (the God, if you prefer) is present in every Living Cell, wheresoever is it, till the cell is still alive. (We hope, the God is a God of living ones, not of useless dead ones.)

Materialization of this very Reason is laid in a coded network of billions of atoms—that is not possible for us to comprehend that completely. For all that, a great consolation is given to us: everybody yet alive is accustomed to this Supreme Reason through the individual participation in the Life as such, in its prolongation, and especially in its development. Likely, the Lord is a God of living but not dead ones, for our Lord is interested in each of us while we are alive, active and, useful; and when we are dead, having lost our activity, we are useless for the Lord. Therefore, we ought to connect our hopes for Salvation with our biological life, as no other life is given to us, only this one and the “trace on the Earth” that is human memory on our deeds on continuation and willingly on development of Life—and willingly on development of life—and it seems here our Eternal Salvation is laid.

From the philosophy, we shall return to the physiology into biological expediency of physic-chemical bioprocesses in our body and they, in the essence, do represent the Life as such, in particular, our short life.

The biological expediency is determined by life supply (all for myself!) and vital activity (all for others!). It is referred to a single cell, to an organism as a whole and to human community being the most active part of global ecosystem.

The life supply and vital activity of separate cell or organism are performed by plenty of chemical reactions and physical processes within the cell and on the boundary with the environment.

Further, chemical reactions and physical processes are connected with substances but met anything else—one is to say on metabolism (renovation, renewal) of substance. In this case, every chemical reaction and physical process are linked with energy transformation and we are to speak on energy renovation. To add more, any chemical reaction and any physical process occur with biological expediency of process or reaction. It is impossible to reach any expediency without the exchange of information, that's why we have to deal with the “metabolism (renewal) of information”.

Thus, a capital distinctive feature of living object from non-living one is the presence of exchange processes triad. If in given object triad is being detected completely, we are dealing with living object as an organism or a cell from corporal structure. In the other case, we are dealing with dead organism, dead cell or an object of dead nature (ordinary stone, for instance).

Therefore, proceeding of exchange bioprocesses triad is practically Life. This triad of biological-physiological processes does consist of metabolism (renovation!) of substances, energy exchange (renovation!) and exchange (renovation!) of information.

Living cell is an elementary representative of any living organism: from cell it starts, and the further activity of an organism is determined by the internal activity of all living cells of it. Chemical material is continuously spent for life supply and vital activity, requiring an input of nutritive stuffs and excretion of used substances—wastes of vital activity. As a whole, the process is named as metabolism of substances. The very living cells are permanently “wearing out” and perishing, requiring to be substituted with new ones. According to the estimates of physiologists, in any moment almost billion of somatic cells are in change: they divide, renew or perish.

The division of cells, their nutrition, as any other bioprocess is obligatorily connected with the energy exchange. Any activity is, from the physical viewpoint, a process of transformation of one type of energy into another. No process is possible without energy exchange.

Life supply and vital activity of any living cell is performed by nothing but the sequence of permanent plenty of physical-chemical processes. Any living organism is a self-recovering system of extra-complicated structure; it is treating itself. But! . . . Each biological process in a given cell is caused by the expediency, which cannot be attained without the information exchange.

All the great multitude of physical-chemical processes within living cell is completely framed within three aforementioned processes. And their list is complete: there are no processes in the living organism outside that basic triad, no processes not determined by this expediency. And, we must stress, in a living sell, everything is subordinated so, that all the managers of chemical plants of the whole world are unable to provide such an order.

How can we determine the necessity of this or that (seemingly insignificant) physical or chemical process within a separately taken living cell?—For this purpose, exchange of information proceeds between cells (especially surface cells) intermittently on genetic level. This information exchange causes switching of mechanisms of instinctive subconscious decision-making, and, later on, of mechanisms of conscious decision-making as a result of instinctive and brain decisions.

So, the biological life is impossible without metabolism processes, without energy exchange and without information exchange: (*) without information exchange within the body (in the interior tissues of organism) on genetic level; (*) without information exchange between internal and external environment (incl. the humanity as a whole) for instinctive decision-making; (*) and, finally, without information exchange between internal and external environment (incl. the humanity as a whole) for the person's own reasonable decision-making.

Life supply and vital activity of each man, each organ and each living cell is determined by the entire aggregate (triad) of three processes—metabolism, energy exchange and information exchange. There is no main process among them—they do form the triad.

It is important to realize, that the final product of life supply and vital activity is determined by the triad of these processes—the negativity of each one of those can Block two positive ones. For instance, our organism has a healthy digestive system, our dinner table does contain a fine assortment of natural food stuffs (from those 200 created by Nature and ones we see in the garden, kitchen garden or field). We eat them either too much or being in stress, suppressed, tired, badly combined or perhaps after extreme culinary preparation. In any of these actions,—not very rational, and ignoring biological information, “the mental meal”,—we'll provide ourselves the dyspepsia and its consequences (surely, we do require both material and “mental” meal).

Then, the living organisms are consumers of food, laid in the input of that triad of exchange processes. And as the process of information exchange is an inseparable part of the triad, the man has to mention literally the “mental meal” hyperbola.

So, from the biological viewpoint, the food is not only the nutritive stuffs from the environment: food is information from the environment also.

So then, from this very viewpoint of biology, the process of getting stuffs and energy and information from environment (incl. the humanity as a whole) may be named nutrition of modern man.

To continue the summarization of biological terms, giving a tribute to the role of informative processes for the supply of a man, it is appropriate to call “assimilation”: (*) the assimilation (“digestion”), inside the interior, not only of the stuffs got from the environment; (*) the assimilation (“digestion”), inside the interior, not only of the energy got from the environment; (*) and also the assimilation of the information got from the environment including the humanity as a whole and with all the knowledge accumulated.

Furthermore, the transformation, within inner medium, of the assimilated stuffs, energy and information obtained from the environment can be appropriately called life supply and vital activity.

We do know well, how unpleasant the process of food digestion is. Talking on nutrition we have to say about it. The metabolic (exchange) processes are completed by excretion: (*) with obligatory discharge of final products of metabolism to the environment; (*) with obligatory discharge of final products of energy exchange to the environment; (*) and, as well, with obligatory discharge of final products of information exchange to the environment.

Nutrition success depends not only on success in food obtaining, not only on success in food assimilation, but also even on success in excretion of it. If one does not pay proper attention to excretion, he would be hungry even consuming a high-class meal. Usually we know it as a “slagging” of our organism, and, to stress more: (*) “slagging” with substances, useless or even hazardous from the viewpoint of the biological expediency; (*) “slagging” with energy, useless or even hazardous from the viewpoint of the biological expediency; (*) “slagging” with information (f.e. with that, which our mass media are overfilled with; they are primarily full with political and commercial advertising for they are paid from these sources).

We shall disclose a small secret well known to mass media specialists. Advertisers base their activity on the idea that, in human community, the stupidity is permanently prevailing over reason (foolishness of youth+stupidity as such). Therefore, specialists in mass media, being undoubtedly the wisest persons, do publicity for simple ones thinking those do always (!) form the majority of the human race.

We simpletons, being far from summits of psychology and sociology, and naturally naive as kids, we don't allow proper meditations on that all, of all BIO-logically inexpedient, excessive for BIO and not too logical, but well tailored to suck money of our pockets or for our unreasonable decision-making too advantageous for somebody. We are, sore, being often punished after having thoughtlessly swallowed mass-media information, after having not digested it properly for extraction the “information slags” and after we having used these slags for our own decision-making.

This slag making of our consciousness was to insert into it an idea of improved, modern nutritive foodstuffs: they allow us, (*) for additional payment, to eat on foot, that is, surely, very convenient and useful for health, (*) for additional payment: peculiar taste, (*) for additional payment: peculiar odor, (*) extra pay is taken for specialized painting and bright cover.

Please, tell us whether is it all BIOlogically necessary, necessary for BIO and logically expedient? Please, tell us, the producers and salespeople of all those “optimized” foodstuffs, are they not eating this themselves?

For the same purpose, for our “informative slag making” and for strengthening of herd instinct (“make as all make!”) a notion “fashion”, along with the same notions of the same order, is invented for sucking out our money and for making us make not reasonable decisions, advantageous for somebody, however. Please, tell us—are “fashion” and other analogical notions necessary for BIO- and logical?

It seems, not everything is simple in BIO. It seems, not everything is simple in our human logic. On the very level of instincts, we are protected from dangerous substances from the environment: we spit out uneatable substances instinctively. On the very level of instincts, we are protected from dangerous energy from the environment: we jerk back our hands from too hot objects instinctively. It seems so, our Creator wants us to elaborate protective instincts against the hazardous information from the environment, which surrounds us.

Summing up, through the human organism as a whole, and through each living cell of it, the substances, energy and information do pass continuously. It all comes from the outer (environmental) to the inner medium, being assimilated in the least, and then transformed for the inner purposes, and, after all, the non-utilized rests are to be extracted back to the outer medium. The every living cell of our organism, and the organism as a whole, is the open and dynamic system. In respect to a separate cell, the system acts on the genetic level, with no participation of our mind-reason. In respect to the whole organism, the system is directed on two levels at the same time: (1) on the level of instincts, with no penetration of our mind-reason, and (2) mostly on the level of our conscience, of our mind-reason. All the products of the human vital activity are getting to the outer medium, to the environment. We shall take in mind the following detail. All the products of the personal vital activity in a substantial form are to be destroyed chemically and transformed into the chemical elements of soil (“ashes to ashes”), being unable to add anything to the substance existing before the appear of that person. All the products of the personal vital activity in an energetic form are unable to add anything to the summary energy, according to the law of conservation of energy. All the products of the personal vital activity in an informative form are to be positioned quite differently.

“Information”, as it is determined in mathematics, is “a measure of uncertainty exclusion”. The same intuitive approach is applied in intellectual activity of man, always wishing to obtain additional information. The more uncertainty is excluded by given person's mind, the higher information and intellect the person possesses. The more uncertainties are excluded by humanity's intellect as a whole, i.e. the more scientific knowledge (information) is accumulated in a form of microscopic contributions of individuals, and the higher is an intellect of the humanity as a whole. The humanity's intellect as a whole is consisting of accumulated contributions from each of us into a general moneybox.

So, the vital activity of the humanity has no accumulative effect in substances and energy, but it has an accumulative action in a growth of information (diminishing of the “measure of uncertainty”), and, sore, in knowledge, in a power of intellect—hence it follows a logical conclusion: the sense of our and humanity's existence is laid in accumulation of intellect, for nothing else principally can be accumulated, all others are to be washed away by the River of Time. That is our Life and these are demands of its Creator!

Everyone is capable to leave, for ages after death, only an individual microscopic intellectual contribution into a humanitarian intellectual money box, as for example, to deliver to further generations the way of sewing clothes, of better plowing of earth, or of better houses building or better growing up the children, of better treatment of information and its further transportation, or more optimal storage of health and physiological resources of body to live on Earth for more than hundred years. The biologists assure us on than physiological resources for active life are enough for at least 120-130 years of active life.

Really, ancient Greeks, Romans, our medieval and later ancestors have left only the intellectual heritage, non intellectual products of their activity had been destroyed by showers, earthquakes, winds, fires, or this fate is waiting them (non-intellectual products) tomorrow. Nevertheless, wheel, numbers, alphabet are not destroyed yet as intellectual results of vital activities of our distant relatives as well as computer technologies—these activity's results cannot ever disappear from the intellect of the humanity otherwise than with the humanity itself. Only the human intellect is not annihilable and destroyable. We consider that such contribution of a single man into a huge moneybox of humanity as an information or intellectual product compiles the human soul. If this contribution is available—the soul is perhaps saved (that is eternal turn to humanity whose particle he had been born and had remained after biological death of his body). In absence of this contribution (humanity's good memory) no salvation is available.

After the human body's death a single is remaining afterwards and continues his life in human society, is his private contribution into an intellectual moneybox (“to leave a trace on the Earth”). Really if a given man has learned to make his business better than others (to sew, to plough, to build, to design, or theoretize, etc.), this intellectual achievement will be remembered for ever and his future experience will become the humanity benefit—his soul has attained the Kingdom of Heaven and it will live for ever.

Therefore, the Nature, having been created ourselves, does need creative persons—those performing their good business better than others: to sew better, to plough better etc. So, if a concrete ordinary man wants to be better than others in his own business, the Nature itself is interested in it and it will give the greatest Gift for him to carry on, and the best Health, without which this Gift could not be accomplished.

The 15^{th} principle of the Genetic People's Health and of the “BIOphilosophy of the Individual” (Individual is now under condition of human society commercialized to the core):
Realities of the contemporary life do dictate us to part with sensual (artistic-romantic) level of life acceptance and to pass to reasonable BIOlogic perception given in biological (BIO+logical) manuals that's why we are talking on BIOlogic Expediency as such, for having control on which the Creator does possess the proper means of impact. Our Creator (either the Nature or God) as the Author of genes, and there encoded operators of the life supply and vital activity, rules the cells of our body. That's why the Creator is not an abstraction but an objective reality affecting on us every moment either negatively or positively.
This is the fifteenth principle of the Computerized Global Humanitarian BIOcultural Genetic ‘public health’ (briefly: the Genetic People's Health—Health without the medical ‘health service’). Detailed commentary of this principle is given below.

Finally, there is the tool of impact of the Creator upon a man—to break optimal nutrition of living cells, that is to disturb metabolism processes within causing diseases till the lethal end. Probably this negative tool is the only one approaching to us and we feel ourselves in low spirits, then poor well being; later on, all depends upon our relationship to life and the Creator, upon the way of life we choose and which we are willing to change.

So, the only one general positive tool for Creator's influence exists—to supply optimal nutrition of living corporal cells. Indeed if the exchange processes go accordingly to Nature's demands, man in accordance to its genetic program may feel himself cheerful till the very end of biological life, f.e. till 130 years (in this case death will not be torture, as in this age all sensations including painful became less anxious and the death becomes unexpected).

So “The Creator's Eye” and “The Mechanism of His reaction on our deeds” are inlaid in each cell of our body. Therefore, any disease, bad being and sickness can be interpreted as kindly smack for our childish disobedience to Mother Nature, as a symptom of our unreasonable behavior, while taking off such symptom by means of medicines seems to be double foolishness.

The Nature has given an invaluable gift to everyone: to observe, with the own eyes, a unique phenomenon called Life and to participate actively within it.

Therefore every morning of God's day is to be met with the joy of private active participation in Life and with the gratitude to the Creator.

Our own life and our labor pleasing to the God—that's our happiness; all other things are real trifles, inventions not necessary to us, to or our Creator.

Biology has leaded us to this conclusion after an analysis of exchange processes being features of living matter, differing it from non-living one.

This triad is an attribute of all living organisms from unicellular microbes to the Man differing them from non-living objects. As a result of an analysis, we are assured that, the for the sake of human health, not only nutrition (in the sense of metabolism process) but also the “labor in sweat of the brow” as a process of energy exchange. Moreover, this labor is to be biologically necessary in the sense of information exchange. These all three exchange processes (metabolism, energy exchange and information exchange) are interrelated biologically and physiologically for the sake of realization of the life supply, for realization of vital activity and biological expediency of its proceeding.

One can say, in other words, without the vital life activity no life supply is possible. Otherwise (that passes out of our understanding), even a modest food within the presence of activity does bear the health while a luxurious food without active Labor leads to health loss.

We can add: our labor activity suits the Creator only when it is directed for the support of life or for life development, pleasing the God again. Any other activity is not accepted: we do understand on that at once on our bad well-being or on our painful diseases, if we continue to be stubborn in certain attempts, biologically unreasonable.

We are attempting to discuss it in more details. We are eager to observe the matter within us and, later on, externally, for the penetration into logic of Life organization firstly within, and then to get into logic of our own organization of life—life of an ordinary man in a human community.

The internal medium within us is, an aggregate of cells of body, living by their own life on one side and, from another side, acting in the interests of other cells. The biological expediency of individual activity of each living cell in an organism's structure does consist of, firstly, realization of its own life supply and, secondly, in realization of its individual vital activity, completely subordinated to the vital and functional interests of other living cells of the organism's structure. For the living cells may only exist within the narrow range of optimal conditions determined by Nature, these living & functional demands do fully lay in the area of support of an inner medium's regularity under the conditions of permanently changing external environment; that does allow them to stay in this “narrow range of optimal conditions”.

However, our inner medium, our interior, is not simply an aggregate of cells, but also a genetic program in cell nuclei, of strictly individual character. This genetic program is codified by the Nature in individual structures of DNA and RNA molecules, and the program was inlaid by Nature into an each living cell for ruling its activity within an each organism. Our own mental efforts have no relationship to this genetic program, its realization for life supply plus vital activity—everything is subordinated here to the Nature having left, for our mind-reason, the only ability and chance of choice and consumption of meal (stuffs, energy, information) from the environment.

We all in proper measure of competence, capabilities and applied efforts have tried, above, to look at this inner medium. As a results, a real inner microcosms of nearly 5 trillions of living cells, acting in coordination has been observed—our corporal world, not completely cognizable. At inner medium of our corporal world, biological expediency of each cell's activity is established (“choice of activity's target”), performed (“choice of activity's pathway”) and controlled by two-million-year Nature's experiment on life support on the Globe. Due to such a long-lasting vital experience, the structural organization of all the living cells into an unique system of organism is reached on the highest level, what is not yet attained in a rather diverse structure of the humanity. Biological expediency of individual activity in humanity structure is still to be attained by us under a control of the Creator (the God, or perhaps the Nature).

External environment of the everyone is firstly, the human community, everybody is there just like a certain living cell, and, then, the rest of living matter consisting partially of human component and, after all an inorganic matter as a basic support to the organic one. Here, in the environment, everything is subordinated to the Nature's laws partially recognized by Man—certain information amount was obtained (to exclude some uncertainties). However, outside of the human conscience the unknown, practically limitless, information medium will always remain, a sort of a sea of uncertainties. Therefore, the activity of anyone of us, in this external environment, will always be insufficiently optimal and adequate.

The human society as a part of an external environment of an individual—is an aggregate of living and actively operating persons each of them partly lives his own life and partly is acting in the vital interests of other ones, or, speaking in the terms of economics, acting according to “the law of supply and demand”. Likely, the Nature considers that everyone within human community will actively work like the living cells in the body, that is: “do survive yourself and let others survive, for this approach at least starts working for you”. It seems so, that the Nature's pathway to fulfill this idea is very long lasting and thorny, as we are saying often: “Oh! Only am I, who exists! All beyond me is this external world being, firstly, too cruel even in necessity case and alien due to unnecessary cruelty, and, secondly, it will disappear at the moment of my death thus after me the Flood should be. Spit upon this external world!”. This living position does not suit the High Reason probably, and will not leave It with no attention to that. It seems doubtless, this person will be unable to realize optimally the physiological resource given by Nature and to live the proposed age of minimum 120-130 years.

The external world, the environment is not an abstraction, but our surrounding affecting us continually, negatively or positively. There is only one general tool of negative impact upon a man—to break the optimal nutrition of body's living cells, causing diseases up to the lethal result. Likely, when tool of negative impact is approaching, we at first have a bad mood, then goes bad general state and, further on, all depends upon either our relationship to the Life or our way of life. For positive result, there is the only one general tool—to supply optimal nutrition of body's living cells (“My God, give me health, and I'll do the remaining”). Really, if exchange processes are passing adequately to the Nature's requirements, in accordance to his genetic program (multi-annual Nature's experience of providing the Life on the Earth), the man will feel himself cheerfully till the last second of his biological life, so up to 130 years.

Both worlds—internal and external—are subordinate to Nature's (or Divine) laws, which only partly noticed by man. The knowledge of Nature's laws does enable us to succeed the in a vital activity. The ignorance of these laws does open the pathway to a failure in a vital activity.

It seems to be very probable, that our diseases, our bad self-control, and, briefly, low quality of our life is a prompting from our Mother-Nature, that our lifestyle does not correspond with its demands and expectations in exchange of given life or huge physiological resource in youth, when we don't think on health. The Nature, having decided to create each of us, is hardly having no interest to everybody personally. Probably, having passed off the natural way in our way of life, we feel at once a corresponding prompt in the form of bad self-control or even severe diseases. So does the Nature stimulate us to the natural way of life. (It exactly stimulates: we have to remind, at the hundredth time, that the Latin word “stimulus” means “a pointed drover's stick”.)

It seems, we are to understand the Nature and its demands. Each of us cannot survive in our human world without knowledge, information and biological expediency of our existence, without the submission of any vital activity to this expediency. The organization of Life within our body, being real and strict, does convince us in that.

Really, any activity of the living cell in the body is absolutely submitted to its biological expediency in accordance with the genetic program. When the living cell makes a mistake (the only mistake!) in copying of genetic information (and sore becomes dangerous to another cells) it is becoming instantaneously self-destroyed. It happens in accordance with the same genetic program, with the “Life Code”, once compiled by our Creator and written into a nucleus of every living cell, till it (the cell) continues to be biologically expedient. And since it ceases being biologically expedient, it becomes not interesting to the Creator and self-destroys by His will. (He is the God of the living ones, not of the dead ones!)

The organization of life supply within our corporal cells is highest. It is not possible to say the same on a human community. Something is established with the plenty of legal acts, however, so that it is partly submitted to the biological expediency of the human existence.

Each of us, living with the internal world, has to submit its own internal logics in each case of the external activity in the community, in the rest of animate and non-animate nature.

The 16^{th} principle of the Genetic People's Health and of the “BIOphilosophy of the Individual” (Individual is now under condition of human society commercialized to the core):
The reality of modern life does dictate a necessity to part with sensual (artistic-romantic) level of life acceptance and come to the level of reasonable BIO-logic perception proposed in manuals of biology (BIO and logic) and, in this connection, we are talking on BIOlogical Expediency as such and especially in the nutrition organization. We are eating only for the activity of living and acting body cells. For Our activity our life and life quality, as well as our work capacity and cheerful spirit—all this is provided by living cells of the body, merging into specialized tissues, later on into proper organs and systems of organs, and then into whole organism. To create and to support life—that is given to living cells. We take seat at the dinner table not to feed the mouth or for taste enjoyment—we take seat to feed and to please each living cell of our organism and it, as a token of gratitude, will present a good health and all pleasures of life.
This is the sixteenth principle of the Computerized Global Humanitarian BIOcultural Genetic ‘public health’ (briefly: the Genetic People's Health—Health without the medical ‘health service’). Detailed commentary of this principle is given below.

Thus, to look through quickly the aforementioned contents, the opinion is, that we cannot discover all the secrets of the living cell and the life as such, and the living organism being part of it as structural and functional aggregate of living cells it consists from.

There are two objects from the structure of Life satisfying its biological characters: the living organism himself and the living cell as a certain representative of numerous living cells in structure of this living organism, vegetable or animal, unicellular or multi-cellular of low or high organization as in Human. Features of animated nature (self-growth, self-reproduction etc.) are characteristic to only two objects and consequently only two may become ill. Biological-physiological understanding of living organism's disease—is comprehension of disease of living cells of its body.

The life of an organism is life of living and active cells in its structure, that's why its disease is primarily expressed in breakage of metabolism organized and accomplished in each living and actively working cell of organism. Process of metabolism is impossible without display of a genetic program and carriers of that program, DNA and RNA, were placed by Nature into cell nuclei. Genetic program does operate the cellular activity including metabolism performed by the cell. The breach of metabolism stops the life supply and vital activity, that is, it weakens the cell's ability to self-recovery, and it means a disease. It is known, that almost a billion of cells in our body is in state of change: they are dividing, self-renewing or perishing. During 24 hours, 20 billions of living cells appear to substitute the old ones. The breach of metabolism in cells, for example under a bad nutrition, does stop this miraculous action of Nature in corporal cells, so that it lets us know it on our bad self-control. And if we should continue to feed our cells-laborers badly, our bad feelings will turn gradually to nasty, and our physicians will find some wise term for it from their huge list of disease terms.

So, the organism's disease is a disease of cells in its structure, first of all it means a breach of metabolism, then a partial loss of reproductive capacity in accordance with a genetic program on it.

We may list the diseases of our hepatics in a long and tedious manner. We may list the diseases of our heart in a long and tedious manner. We may list the diseases of our kidneys. We may list the diseases of our nerve system. We, simple people distant from any science, have managed to remember thousands of scientific terms used by our respected physicians to mark various sores of our sinful body. However, it did not become easier to us of these medical cognitions. The cognitions are incapable to help if they are not reflecting the real essence of the subject. Health and disease of the living cell are determined by three exchange processes within it is exchange (renewal) of substances—metabolism, exchange (renewal) of energy and exchange (renewal) of information. Three all exchange processes are extremely important for the vital activity of all of our organs, no one is the main, but now we are discussing the metabolism in cells.

Life of an organism—is the same as vital activity of living cells within the organic structures. Organism's nutrition denotes nutrition of living cells it its structure. Health of organism is living cells' health within. Disease of organism is a disease of living cells within its structure.

Disease of organism starts from breach of nutrition of living cells of our body. Biological-physiological cognition of organism's nutrition as a whole—is biological-physiological comprehension of living cells nutrition. Organization of nutrition of living organism means: to organize nutrition of each of its cells. If we have managed to organize natural nutrition of the cells, the Nature with the aid of its genetic program, would not permit the disease of our body till the very end of physiological resources given by the Nature. As biologists and physiologist have estimated, these resources are reserved at least for 120-130 years.

To build new cells, to activate them, to activate the organism as a whole, the molecules of proteins and carbohydrates are required. And their formation is a role of the living cells of the organism, being connected with the concrete “building material”, which is usually called the nutritive substances for the cells and which is not fully adequate with what is usually called the nutrition or the food.

These molecules are extra huge (thousands, millions and billions of atoms in one molecule's structure). If H₂O, a molecule of water, does consist of three atoms only, the molecules of organic substances contain immense amounts of atoms in a one molecular construction. Judge yourself: one molecule of fats contains thousands of atoms, while one molecule of protein bears millions of atoms, in each molecule of DNA and RNA there are billions atoms within. (Are you able to combine the billion of balls together? Are you able to catch the logics of the connection in a ready construct of them? The hardest question: is it easy or not to spoil that logics a bit?)

Therefore, the molecules of organic substances consisting of myriads of atoms (and sore differing form the organic ones) do possess the great number or physical and chemical parameters. These organic molecules can perform a great plenty of functions. Therefore, the molecules of organic substances are basic chemical constituents of the living cells—these primary representatives of life on the Globe are producing for their vital activity these molecules of organic substances found only on our Earth.

Proteins are the main constituent of living cell in animal and vegetable organism. Primary production of extra-complicated protein molecules from simple molecules of atmospheric substances and soil layer is put, by the Nature, on vegetable organisms, as animal ones are incapable for it. Animals are fed by the usage of plants as food, putting the extra-complicated protein molecules or more exactly, the aminoacid molecules in proteins, into their own corporal cells. Animals, in contrast to man, do not risk to break (by a culinary processing) these complicated protein molecules created by living plants. We, having used these miracles of Nature produced by plants, excessively beat them through processing in the machines of our food industry, through frying on pans or through excessively adding vinegar and other chemical active substances. At the same time we are extremely accurate in handling with watches, realizing that we can easily spoil this complicated device. But any protein molecule is much more complicated and more destroyable than any our most precise watch. And namely, in this connection, we are talking on BIOlogical Expediency as such and on biologic expediency in nutrition organization.

The 17^{th} principle of the Genetic People's Health and of the “BIOphilosophy of the Individual” (Individual is now under condition of human society commercialized to the core):
The modern realities are ordering us to part with sensual (artistic-romantic) Life acceptance taken from novels and to come to the level of reasonable BIOlogical acceptance given in biology textbooks (BIO+logic), and in this connection we are talking on BIOlogic expediency in nutrition organization. We are eating only for vital activity of living and active cells of our body, and each cell is subordinated to the genes of its nucleus, or, more correctly, is subordinate to genetic program codified in genes—unique to all the cells of body. Cells are approximately counted in trillions (ca. 5 000 000 000 000) and they are absolutely coordinated in their activity, one with another, because of their common genetic program. The secrets of this activity will be studied by the bio-scientists during millennia. Further then, the Genetic Program as such is connecting and inseparable link between the vegetable and animal worlds. Genetic program creates the Life in our organism and, with the same tools, it makes food for our organism—the food we see at the garden and kitchen garden, but simultaneously the “food” is made by the Food industry, so our choice of foodstuffs is not too simple as we see either starting dinner in restaurant or making shopping in food shop.
This is the seventeenth principle of the Computerized Global Humanitarian BIOcultural Genetic ‘public health’ (briefly: the Genetic People's Health—Health without the medical ‘health service’). Detailed commentary of this principle is given below.

Genes are the first program level of Life organization established by the Creator. They are the parts of a DNA molecule, being present at the every nucleus of any living cell. They are the material bearers of the genetic program, so they launch and control the activity of every living cell on the Earth with no exclusion. Further then, the Genetic Program as such is connecting and inseparable link between the vegetable and animal worlds. Genetic program creates the Life in our organism and, with the same tools, it makes food for our organism—the food we see at the garden and kitchen garden, but simultaneously the “food” is made by the Food industry, so our choice of foodstuffs is not too simple as we see either starting dinner in restaurant or making shopping in food shop.

It is well known that our organism is an aggregation of living cells working in accordance with the Genetic Program and nothing more. The complexity of structure and work of the living cell will never be compared with any technical (hand-made) device, for the transformation of non-living matter into a living one is beyond the man's competence, although any cell of rice, for instance, can perform it. Besides, even the cells of a body of a man and other representatives of animal world are not given by the Creator capacity to transform “nonliving matter of soil layer of Earth and atmosphere” into protoplasm—into a “living matter filling interior of living cells”, so the life of animals and man is impossible without plants for nutrition. We emphasize: only the vegetable living cells do create the raw materials for a human body. These raw materials are organic molecules, which our organism consists from and is functioning by.

Really, the Life on the Earth is single and extra complicated, and as a connecting Link between plants and animals the “Genetic Program” acts. Only the plants form primary ancestral molecules of proteins, carbohydrates, fats and DNA/RNA—these four constituents of so-called organic substances, of which our own body and bodies, of living being on Earth are consisting and acting.

We shall repeat again. These molecules are extra huge (thousands, millions and billions of atoms in one molecule's structure). If H₂O, a molecule of water, does consist of three atoms only, the molecules of organic substances contain immense amounts of atoms in a one molecular construction. Judge yourself: one molecule of fats contains thousands of atoms, while one molecule of protein bears millions of atoms, in each molecule of DNA and RNA there are billions atoms within. (Are you able to combine the billion of balls together? Are you able to catch the logics of the connection in a ready construct of them? The hardest question: is it easy or not to spoil that logics a bit?)

We shall repeat again. Therefore, the molecules of organic substances consisting of myriads of atoms (and sore differing form the organic ones) do possess the great number or physical and chemical parameters. These organic molecules can perform a great plenty of functions. Therefore, the molecules of organic substances are basic chemical constituents of the living cells—these primary representatives of life on the Globe are producing for their vital activity these molecules of organic substances found only on our Earth.

Then, these molecules are arch complicated in spatial configuration and they may easily be wounded with either excessive heat or an impact of chemically active stuffs as vinegar, for example. Biologists are using the term “denaturation” of proteins—it means, “taking off natural peculiarities”. Biologists imply, under this term, a loss of three-dimensional configuration typical for protein molecule that is a loss of biological value; the occurrence of this molecule in food becomes useless, even harmful.

We have to add once more: these molecules are far from being completely understood by the bioscientists, if this completeness may be attained at all. Extra intensive treatment of 200 natural stuffs from garden and kitchen garden, their high-tech transformation into various commercial mixtures of 40 000 names with addition of chemically active substances for attractive odor, color, taste, outlook, for long storage, all this is able to denaturate the natural stuffs which in common language mean: “to deprive products of their natural nutritional properties and to take off their biological value”, otherwise to transform them into dangerous and useless products.

That's why we do repeat for ourselves again and again one and the same essence: the Life as such and our life as well is operated by and within the living cells, the latter are filled with protoplasm, which our Creator orders genetic program of plant organisms to synthesize; animal cells are unable to make living matter of non-living matters: soil, water, air. Only plants are creating the primary molecules of proteins, carbohydrates, fats, DNA/RNA—so called organic substance, from which our body and bodies of other beings on Earth are consisting, and by which are they acting.

Animals and man are getting these primary molecules in a ready state as a food and, of that, they are building the secondary molecules of proteins, carbohydrates, fats, DNA/RNA as appropriate and necessary for a given animal, hen or ram for instance. It is rather curious, if a man is not vegetarian—he consumes animal flesh, he gets basic organic molecules not from plants but as secondary from animals as being used in animals as hen or ram. That's why we don't use ordinarily predatory flesh: in this case, primary organic molecules we should get as twice consumed, that is, twice circulated in somebody's stomach and intestine.

Now we realize why vegetarians grin on meat eaters or fish eaters, they call it “cadaverous” and prefer to use a vegetable food as not having been eaten and not digested earlier in someone's stomach. Vegetable food is called ordinarily products from “God's table”. In a well-known Dictionary of Natural Foods by W. L. Esser, a founder of American Natural Hygiene Society, brief referative articles are given—with biological description and characteristics of molecular composition—for practically all, including tropical exotics of food stuffs, from Nature, that is from garden, kitchen garden or wild growing, of “God's table”. These primary natural ones for real nutrition are turned out to be 189, including tropical products.

So real natural stuffs for human nutrition including tropical ones are only 189: carrot, potato, apples, etc.; they are called “Products of God's Table”—“Products of God, of Nature-Creator”, emphasizing that other products are from commerce, from “Industrialized-Commercial Table”, that is from the nearest supermarket or restaurant where not less than 40 thousands of “modern foodstuffs” are proposed, prepared from the same 200 natural (from wild Nature) ones, prepared for purely commercial purposes called otherwise “the value added”. It goes without saying that the Market, Commerce, Food Industry, do follow their own interests that is quite natural and it is not changeable.

Proteins, carbohydrates fats and nucleic acids (DNA and RNA)—these are the names of four classes of organic substances; those molecules are used for protoplasm (that is living matter) which is formed according to the genetic program.

Proteins are main constituents of vegetable and animal organism, including human one, also. Their molecules compose nearly 50% of cell's dry weight. Their functions in organism are very diverse and vitally valuable.

The most important function is constructive. Proteins are the constituents of all cellular structures.

Another one of functions of protein molecules is motive. All types of motive activity of cells—contraction of muscle fibers, oscillation of lashes, etc.—are supplied by special contractile proteins.

Transportation is an important function of protein molecules. Special transportation proteins achieve transport of many substances into cell, inside cell and outside from cell. Hemoglobin is referred to transportation proteins, transmitting oxygen in a blood when myoglobin transfers oxygen within the muscles.

Protective function of proteins is one of the most important. In case of penetration of bacteria and alien protein molecules into organism special protein molecules, called antibodies, are elaborated to neutralize the intruders. Antibodies are protective protein molecules forming complexes with alien molecules preventing their threat to our health. Fibrinogen and thrombin are protective protein molecules, participating in blood coagulation; otherwise we could loose it all through any tiny wound.

The most important role of protein molecules is enzymatic. All the biochemical processes in cell may proceed only with the presence of enzymes—definite protein molecules, accelerating (catalyzing) these reactions sometimes repeatedly, but remaining unchanged, capable to act for several hours being then replaced with other ones.

Without enzymes, biochemical reactions do proceed so slowly, that the Life would be impossible. Enzymes are partially related to digestive enzymes formed and are extracted by living cells of mucus into gastrointestinal tract for splitting our food for “building blocks”, necessary to the vital activity.

Thousands of various types of proteins are operating within the human organism. There are a lot of proteins in living nature, a specific one for hazel, specific proteins for rice, wheat, etc. al., the own proteins are in trout or other fish, the own ones are required to a cow or a ram.

It seems reasonable, that the man need his own proteins. Imagine if a protein is isolated nutrition stuff and it is turned to be so alien for metabolism in somatic tissues that it can kill that man. That is in spite of occurrence of as minimum 50 thousands of diverse proteins within our body. Therefore the protein compounds are firstly split by a digestive system into simple constituents—aminoacids from those the complicated protein compounds are synthesized again, now working within our body. Bio-chemical reactions in a gastrointestinal tract are achieved with the help of digestive enzymes, whose molecules are made and extracted by specialized living cells of digestive organs.

The super complicated, in its structure, molecules of nutrition proteins, carbohydrates and fats are obligatorily split into more simple molecules of “constructive proteins” being there just the parts for super complicated molecules of our proteins, carbohydrates and fats. Splitting of molecules of the natural products of our nutrition is attained under an impact of definite set of digestive enzymes, capable to deal with substances of this very stuff.

You may agree, that the set of substances is definite in diverse products and, to split it, the own definite set of enzymes is to be applied, as the rule exists: one type of enzymes for one chemical reaction. All the products do contain their own sets of chemical substances. Each set demands definite enzyme complex: for cabbage one complex, for melon another, for meat the third, as cabbage presents one set of chemical substance, melon does quite another, and meat is completely different.

“Team” of enzymes is a set of arch complicated protein molecules; the specialized living cells of mucus are starting to act for its production every time when we take seat at the dinner table and see what we want to eat. This process is started when the receptors have sent to the nerve system “names” of natural products on the dinner table for seeking their chemical composition and further compiling the order to secretive cells of mucus for production of certain enzymes' team.

Having enriched ourselves with these knowledges, let us have a look on Industrial-Commercial table. There are, as minimum 40 000 positions (“trade marks”) of foodstuffs, proposed—a whole sea of products, so that it is difficult to find there those primary 200. They have multiplied in such huge amount for the last centennial due to chemical and technological revolution of XX^{th} century. It seems doubtful, that our genetic program, our nerve and endocrine system dealing with digestive processes and having a rather respected age of 20 000 centuries, are able to rebuild themselves during a century for such great diversity of food mixtures /jumble/ and to choose the proper teams of enzymes for successful digestion of ever such “novelty”. Most probably such perestroika, rebuilding of the extra complex digestive conveyor system as genetically codified digestive human intestinal tract is completely impossible.

The Nature has not planned to make our digestion universal: we've told and are repeating, that our digestion is enzymatic. Each enzyme is specialized on chemical treatment of molecules of the one definite substance, such substances are several within a given stuff. Therefore, for complete digestive transformation of molecules, for instance rice gruel, certain specialized team of enzymes is necessary. Part of this team is to deal with primary split of the proteins of rice gruel; some enzymes in stomach juice are to perform an intermediate stage, then the next enzyme group will be acting having achieved next of splitting stage and further on till aminoacids' level,—these molecules are required for the cells of body. The second subgroup of rice team is designed by Nature to deal with the starch of rice gruel: some enzyme from our saliva is to proceed primary splitting of starch towards intermediate phase, later on the second enzyme comes on and will do intermediate splitting phase, and so till monosaccharide molecules, being urgently required for every cell.

The above-mentioned mechanism of digestive activity had being worked out for 20 thousands years of Men's existence. But during the last centennial our digestive enzyme became to be in the embarrassing situation. Enzymes are getting rice after industrial polishing and clearing. In this case, proteins and rice starch have lost a considerable part of minerals and vitamins—such a significant share of enzymes (namely coenzyme) is dropped, and complete success is impossible. It is only a part-we want to unite in our home dishes maximally useful products to attain exotic appearance, odor and taste. For what purpose we do it, we ourselves know perfectly.

In commercial-industrial products, plenty of natural and alien for nutrition stuffs are united with addition something for taste, odor and fair “ware” outlook, for storage and so forth. There is no need to concretize for us, when exactly the necessity is appearing to improve total view or hide taste and odor—we know it ourselves. Don't explain who does multiply a great lot of industrial commercial mixtures with new, “added value”—we do know it also. Nevertheless we don't know or usually forget that there is no mechanism in stomach for dividing, those hotpot into constituents, those the same our enzymes are able to work, they had been learning for 20 thousand centuries.

The finest examples of that industrial-commercial hotpot are our beloved cakes and candy. Oh, they are rich with all! Our digestive enzymes are getting stunned while facing with them! We are stupefied, the enzymes are getting stunned! Our digestive enzymes became jerked or stoned in contact with all this jumble as we do.

It is difficult to imagine the situation, where the digestive enzyme would be after proposal of such hotpot. Imagine that nearly 200 diverse car models do exist and some universal station for technical service exists, for each there is a specialized team. Let us imagine each model exists sufficiently long, issued by serious firm and it certainly has fine technical documentation. Therefore, each master from the team can rapidly qualifiedly treat the system of ignition of cooling either supply, et al. On this case, the technical service station operates finely and no complaints exist—workers are specialized, fulfill with high quality and in proper time. Let us proceed with our imaginary pattern. On car marked besides the 200 producents, some 40 000 non-solid designer firms started to act. Each of there firms, on the base of preset details, of those 200 cars has invented the own model, being certainly “improved modern”, and started selling it. As a result unexpectedly 40 thousand car models have appeared instead of 200 old ones.

Naturally time has gone for technical service of this 40 000 models and they all had appeared in sight of our qualified and highly specialized masters.

The confusion of technical station staff is evident: details and units of “novelty” are known but completions and addition cause evident confusions; now there is no talks on quality and adequate fulfillment of the job.

In same confusion our receptors are, of eyes nose and tongue, of our central nerve system, while transforming information from these receptors for the choice of necessary team of enzymes. Some results are expected of them, as also of the receptors of endocrine and digestive system. These systems will act, so or so, anyhow, but . . . nothing may be said on time or performance and quality of work: for call of plumber, electrician has come and done what had managed.

The 18 ^{th} principle of the Genetic People's Health and of the “BIOphilosophy of the Individual” (Individual is now under condition of human society commercialized to the core):
“What to eat”—is important, but thrice more important is “How to eat”.
This is the eighteenth principle of the Computerized Global Humanitarian BIOcultural Genetic ‘public health’ (briefly: the Genetic People's Health—Health without the medical ‘health service’).

This topic (“What to eat”—is important, but thrice more important is “How to eat”) is detailed discussed in the book “BIOculture of the Individual, and the Individual Natural Hygiene, and Enlightening Microcomputers & Microprocessor Toys Specially for the Same (Our Not Light Way to Health via BIOenlightenment)”, 2004, 816 pages. The book is written by Valery Leonov, Tatjana Malish (Leonova), and Pavel Leonov in Russian and issued in the authors' publishing house BIOcult, Saint-Petersburg, Russia.

The same topic is a central for discussion in the American Natural Hygienic System. A separate volume entitled “The Science and Fine Art of Food and Nutrition (Hygienic System: II)”, 591 pages, by Herbert M. Shelton and published by the American Natural Hygiene Society (http://anhs.org).

Having based on content of these two books, it is not difficult to compile a number of principles on the topic “‘What to eat’—is important, but thrice more important is ‘How to eat’”. That's why in this in the given patent application there principles are not listed, but their presence is implied.

Now we are to talk on the Social Problem of Natural Hygiene and the Individual having been raised half of century ago in the American Natural Hygiene System and still remaining unsolved. But at first some words on the radical difference of American medicine from the European.

The 19^{th} principle of the Genetic People's Health and of the “BIOphilosophy of the Individual” (Individual is now under condition of human society commercialized to the core):
The European medicine is for millennia remaining directed on “diseases and medicaments of those diseases” while American medicine is directed for two centuries on the totally quite opposite: on “the Health and the pathways of its rising by constitutional forces and means of the human organism”. As a foundation of such public health approach, is the science of the Natural Hygiene and the American Natural Hygienic System as a whole. This science was born in USA at the start of XIX^{th} century; it has quickly covered the entire American continent and was developed there for a century and a half; in the middle of XX^{th} century it was initiated on other continents. By its content, this Natural Hygiene is addressed to every inhabitant of the Globe, but until now it is known, as a rule, to specialists only, D. Sc. persons, and its wide popularization was not possible due to some definite objective causes. We are to know and to remember the history of origin and the thorny path of Natural Hygiene, the prototype of the Computerized Global Human Genetic BIOcultural Public Health science (proposed by us), which methodically technologically and technically develops the science of Natural Hygiene, making it more adapted to the wide popularization.
This is the nineteenth principle of the Computerized Global Humanitarian BIOcultural Genetic ‘public health’ (briefly: the Genetic People's Health—Health without the medical ‘health service’). Detailed commentary of this principle is given below.

At the start of XIX^{th} century, some progressive physicians in USA, instead of traditional drugs prescribing, started to apply the following measures in their clinical practice: (*) placement of patients into the natural conditions; (*) diet of only natural products as created by the Nature in the garden and kitchen garden; (*) only minimal culinary application has been used; (*) all appetizers like pepper, salt, vinegar etc. were excluded; (*) only a clean natural water was used for drinking; (*) it was recommended to walk and sleep longer.

And in the case if some patients demanded pills glazed bread balls were given.

For these practicing physicians, the results were unexpected and incomparable with pills-and-drugs treatment. It looked like a discovery and has been called Hygiene (of Greek “hygienos”-giving health) as a name of a new, special and original way of treatment later having been renamed later into Natural Hygiene. Thus, at the beginning of the XIX^{th} century, in the USA, unexpectedly and quietly, the drugless revolution in health service has started and passed in the middle of XX^{th} century from American to other continents.

The start of this drugless revolution was connected with the name of Isaac Jennings, M.D., who, as early as in 1822, applied broadly the drugless methods in treatment. His ideas were actively supported by Sylvester Graham and helped propagate it all across America. He achieved remarkable success. Soon there appeared Graham societies for men and women, Graham journals, the world's first health food store, and a bookstore devoted to Graham's teachings. A number of medical doctors, frustrated with the medical approach of that era, joined Graham in practicing and teaching the Hygienic approach with very successful results. Shortly thereafter, in 1852, the first professional school of the Hygiene was created to teach these methods to medical doctors.

Almost the whole XIX^{th} century, the Hygiene was distributed and flourishing all across America, but to the end of century it sharply finished blooming, due to quickly starting “frost”. The matter was that the broad distribution of “drugless healthcare” throughout the States has started to undermine the financial bases of “medicinal” treatment and to produce losses to drug makers. The latter, being rich and influential, organized the official persecution of there doctors. “Show your licenses for there treatment! You are not physicians but quacks only. Do you want to be imprisoned? We can promise it for you!”. The victimization was total and nobody has hold out. The Hygiene was mocked in press and sore eradicated from brains of common people so trusting in the prepaid “official information” and to prepaid “scientific opinions”. Only thirty years later in the USA such bold spirits appeared, who by selfless labor, publications and by health schools organizing, started revival of the Hygiene and enlightening in the common Americans brains.

It the first third of XX^{th} century, some physicians were appearing who revived the Hygiene practically, being capable to use in practice the categories of the Physiology of Nutrition and Digestion, the Common Physiology, not only the narrow minded concepts of Orthodoxal Medicine (which has usurped all rights on Health service), as well as those who have risked to be imprisoned for application of the non-sanctioned methods of treatment and even to occasional loss of own life. (These facts were published.) Those were real scientific and civil thorny pathways of the Hygiene. To overcome these difficulties, one needed to have scientific boldness to overstep the orthodox positions and ideas in health service, to be frightened by inevitable “spits” of the colleagues and “cuffs” of elite members. These bold spirits among the US scientists were found.

In XX century the greatest contribution in Hygiene development was made by Herbert M. Shelton, N.D., D.C., Ph.D. He wrote more than 40 books, published monthly journal for 40 years, and throughout most of his life operated a clinic which he called a health school, because it was a place where people learned how to build health. In 1948, Shelton and fellow doctors Gerald Benesh, D.C., William Esser, N.D., Jesse Mercer Gehman, D.C., and Christopher Gian-Cursio, D.C., helped to found the American Natural Hygiene Society. Through the educational efforts of these doctors, along with others who came later, the Society helped rekindle the Hygienic revolution in the world. In 1956, the British Natural Hygiene Society was found, then the Hygienic revolution was distributed to France, Spain, Italy, Czechoslovakia, Tunis, Egypt, India, China, and in 1960, the Hygienic revolution has reached coast of Australia and there in 1961 the Australian Natural Hygiene Society was found. In 1978, Dr. Shelton became one of the charter members of the International Association of Professional Natural Hygienists, an organization of licensed physicians, which was organized to further evolve the science of Natural Hygiene.

Thus, the understanding of Healthcare within the frames of Natural Hygiene became available for specialists throughout the world, in the case of willingness to suffer from cuffs and slaps of owners of medicinal and food manufactures. It is evident, that the Hygiene's distribution will diminish profits from the sale of great lot of pharmaceuticals and “commercialized foodstuffs”. These owners will certainly disagree, proposing “prepaid official” obstacles and “prepaid scientific” objections against the Hygiene—the field is for work of politicians on the freedom of scientific thinking, on civil rights of ordinary people, on state defense from commercial permissiveness. The US experience of XIX-XX^{th} centuries has proved that without active help and protection of the Hygiene—its perspectives are seeming to be very distant and obscure.

That is the brief history of 150-year thorny development of the Natural Hygiene science on American continent and 50-year pathway of the Natural Hygiene on the other continents.

So, the modern European medicine is conservative as traditional orthodoxal medicine as a whole—it is directed to the “diseases and medicines from them”, that is aimed onto the human troubles and getting financial profits of these disorders, it is leveled to support in the masses of youth or of people without higher education (it means particularly the whole community) mass illiteracy in the matters of biology and physiology of human organism to which apothecary drugs are genetically alien. We have to stress: genetically alien, as application and functions of drugstore medicines is impossible to connect scientifically the with usage and application of our genes operating the living cell's activity; the quantity of cells in organism is around 5 000 000 000 000 and each of them is acting in accordance with one and the same genetic program for a given man and fusing our organism into a single undivided entity.

In contrast to European medicine American science looks like as obviously progressive. From the beginning of XIX century, it changed priorities on opposite the professional biologists and geneticists and it has been directed for the quite opposite: its goal is “health and ways of its rising (feel the difference, as they say)”. Naturally, it is directed on the mass education in biology and physiology of human organism, on the rise of biological culture in the general public, firstly youth and ones without special biological education (practically all the humanity). Such a “BIOculture of the Individual”—explain the simplest truth: “your health as a total Health is not a market good—it isn't on sale, it is to be build by yourself on base of your own knowledge of elementary knowledge of biology and physiology of your own organism”. Start to this approach in USA was done on the “Natural Hygiene” way: by self-support and health recovery by the man himself, by means of free natural sources of organism and the disinterested service of Nature creating this human organism—in contrast to the alien paid pharmaceuticals and services being processed by commercial Medicine for getting profits on sales of that very pharmaceuticals and services.

For the human Life as such is unattainable for its creation and it lays beyond the Man's competence, it can't become a market good, so is our health as such inaccessible to us and it also is not a market good and is beyond human competence.

Life and Health as such aren't hand made and both are attainable for scientific studies, for further following the natural laws and conditions, but not to our interference for the sake of profits gaining. Health is an inner and obligatory attribute of the Life as natural phenomenon, being performed in the existence of living organism, as, without Health, the Life would cease right after it appears.

This widely biological positioning of the Health problem has appeared on the American continent almost two centuries ago. On the base of 150-year clinical practice, the physicians managed to create the Natural Hygiene as a separate division of the biology. At the end of XX century, the Natural Hygiene ideas are accessible for the specialists of all continents. At XX century division had occurred, of physicians on hygienists, supporters of Natural Hygiene and rejecting the traditional treatment and orthodoxes preferring that old routine treatment.

“The Natural Hygiene way” is based on biology and physiology and it rejects the principles and approaches of traditional orthodoxal medicine. This way is common and fundamental one in the searches of private ways of health improvement, which (ways) do enlarge and improve “The Natural Hygiene way” making it more optimal, effective and passable for its practical application for the support and recovery of the health.

The Natural Hygiene is a science of support and recovery of the Health in the entire and indivisible human organism based on general and broad principles of the biology and physiology. Here are rejected private and narrowly specialized principles and approaches of the orthodoxal medicine, unnaturally dividing the living human organism on constitution (organs) in search of artificial commercial means for treatment of each organs separately (remedy of stomach, remedy of head, etc., as though the stomach is viable without of head). Orthodoxal medicine is hushing up, from common people, the definitely evident biological truths. Life as such, as a natural phenomenon and Health as obligatory and integral part of the Life is created by the living cell within it, and, under severe operating and control of genes in nucleus of this cell. There are about 5 trillions cells in human organism and each cell performs one and the same genetic program uniting organism into integral undivided entity; all this is created beyond man competence, so that any “creativity” of the Commerce is absurd here. It is biologically absurd but not economically unfortunately. Nowadays, the powerful economy is acting without any respect to the biology. Therefore, the all-mighty monetary economy is independent, and a penniless biology is independent. The monetary economy beats as a hammer, while the defenseless biology acts as an anvil. As for us, common people merchants and non-merchants, physicians and non-physicians, businesspeople and non-businesspeople, we, in relation to our health, are “between this active economical hammer and that passive biological anvil”. There is no science defending us excluding the lacking ecology, especially if we talk about the human organism and health service as a whole—from the positions of biology, genetics, genes and out of position of economy, commerce, money.

The science of Natural Hygiene is very young, being generated in USA only two centuries ago (it is an infant age for science) and only a half of century it became known in other continents, where, with difficulties, with the resistance of medical orthodoxes and with social obstacles, is it developed. It is customary, that the American experience in Natural Hygiene from XIX century to mid XX century was most completely, systematically and successfully complied in the American Natural Hygienic System in 4 volumes in 2033 pages. For two centuries these scientific knowledge is propagated in America and for more than a half-century in other continents. We repeat that in 1948 the American Natural Hygiene Society was found, then in 1956 the British Natural Hygiene Society was organized and the Hygiene revolution was initiated in France, Spain, Italy, Czechoslovakia, Tunis, Egypt, India, China. And in 1961 the Australian Natural Hygiene Society was found.

Thus, the science of Natural Hygiene became known to specialists, but it is absolutely unknown to the youth and to the common people with no special education, as this part of humanity either have not heard about these 4 books where on 2033 pages the science is presented, or they have heard but don't want to be tired by reading scientific books considering scientific data of no urgent knowledge.

Two circumstances are worth to be mentioned. First: widely and in great quantities (that is by majority of humanity) are now purchased the wares supplied by massive and expensive advertising. In this connection, it is clear, that 4 scientific books where on 2033 pages the science Natural Hygiene is stated, will not belong to this category: the commercial profit of 4 books distribution is absolutely miserable and unable to cover advertisement costs. On another side, and that second circumstance is also clear, the science of Natural Hygiene is essential and absolutely necessary for everyone. Two circumstances in aggregate are named by us as “The Social Problem of Natural Hygiene and the individual”—individual living now in extremely commercialized human community.

The 20^{th} principle of the Genetic People's Health and of the “BIOphilosophy of the Individual” (Individual is now under condition of human society commercialized to the core):
The principles (from 1 to 20) do represent a nucleus of the science and art of Computerized Global Humanitarian BIOcultural Genetic Public Health (Health without medical “Health Service”). But, to create this science on the base of this nucleus and to proper develop—we propose it to the professional biologists and geneticists of the world as a humanitarian gift to the common people of the Globe for the decision of “The Social Problem of Natural Hygiene and the individual”—individual living now in extremely commercialized human community.
This is the twentieth principle of the Computerized Global Humanitarian BIOcultural Genetic ‘public health’ (briefly: the Genetic People's Health—Health without the medical ‘health service’). Detailed commentary of this principle is given below.

The matter with, yet unsolved, “Social problem of Natural hygiene and the Individual” is the following.

Through corporations' activity—for example, in the sphere of mass organization of human nutrition, or in public healthcare and other spheres of satisfaction of human needs and demands—mutually beneficial economic interactions among separate personalities are appeared and so the modern human society is being formed. For formation of it, the role of corporations is prior. It is poorly understood, however, that, in this servicing individual the by society, financial and economic corporeal interests are prevailing, being laid over the biological interests of human organism. That is, economy and money are dominating above biology and genes. Thus situation is not considered to be reasonable and perspective for the human society as a whole.

Economic and financial interests of corporations are with no doubt important and are to be realized. But human interests, biological and genetic, are also important and are also to be realized. Otherwise, the reasonable balance of corporate interests and biological (genetic) human ones is to be attained, but not enough attention is paid to it except the matters of ecology. That is not enough, however.

The ecology (from Greek oikos—homeland, home) broaches the interrelations of the man with the environment, but ecology doesn't deal with the relationship of a man and a society. However, the human society is also an environment for an individual, an environment even more dangerous in comparison with the nature in ecological sense. It's a high time to make some further steps, to broaden ecological problems up to social ones, and, in particular, it's a high time to turn to the reasonable balance of economical interests of corporations and biological interests of man in the sphere of organizing of social nutrition and social organization of health care. In the American Natural Hygienic System, it is said on the necessity and extreme hardship of these steps to reach that balance, and we call it all “Social Problem of Natural Hygiene and the Individual”.

To resist corporate interests, discordant with human health and his biological demands, to hold out against money power for the health of men,—only a might of scientific reason is capable to it: ecology can be an example. But ecology, as a science, protects only the external biological environment of man from the human.

There is no science for protection of the “internal biological environment” of man from the same unreasonableness. Proposed by us, the Computerized Global Humanitarian BIOcultural Genetic Public Health science may fill that gap, and the tools, also proposed by us, are able to contribute in popularization of this science among common people including schoolchildren.

Half of a century ago, the might of scientific reason did create the science of ecology to solve the definite problem. Nowadays the fruits of that science of ecology are enough noticeable and are used by common people all over the world. So it is a high time to make a next step in the direction having noticed that, at the very time of rise of the science of ecology, 50 years ago, the progressive physicians of USA raised a problem related to one of ecology but hundred times more difficult and more vital, for it is linked with providing the biologically justified nutrition and health care to the people. For the sake of distinctness, we have called it “Social Problem of the Natural Hygiene and the individual” and we proposed to create the Computerized Global Humanitarian BIOcultural Genetic Public Health science for the decision of the social problem.

The discussed social problem of the “Healthcare as such” is global in its totality, its essence, its depth and necessity; but, having been raised in the American Hygienic System, it was not discussed in other publications and it was not formulated for a practical decision—it was not presented in theory and technique being extremely complicated for comprehension. Our vision of the whole problem is described in above-mentioned the principles (from 1 to 20) as a nucleus of the science and art of Computerized Global Humanitarian BIOcultural Genetic Public Health (Health without medical “Health Service”). But, to create this science on the base of this nucleus and to proper develop—we propose it to the professional biologists and geneticists of the world as a humanitarian gift to the common people of the Globe for the decision of “The Social Problem of Natural Hygiene and the individual”—individual living now in extremely commercialized human community.

The definition and the meaning of the Computerized Global Humanitarian BIOcultural Genetic ‘public health’ science (briefly: the Genetic People's Health science—the science of Health without the medical ‘health service’) are given as principles being a kind of certain embryo of the coming science.

The Genetic People's Health science is a real science with its subject and method of research:
1. The subject of research of the Genetic People's Health science is “Health”—Health as such, Health from the positions of biology and genetics, precisely: “Health” is “Normal and Correct Activity of Organism” (any organism including human, for an Organism as such is a natural device for the accomplishment of Life, being one and single for all the organisms on the Earth from microbe and virus to human organism). The “normal” and “correct” means: conforming the rules and norms of BIOlogy as “Logics of BIO—Logics of one and a single Life (from microbe and virus to human organism)”.
2. The method of research of the Genetic People's Health science is “Logic of Life”—logical studies of fundamental knowledges of the humanity on the Life as such, published nowadays in the proceedings of the following sciences: molecular genetics, molecular biology, biophysics, biochemistry, general biology and physiology. Notice: the fundamental knowledges of the humanity on Life as such are given not only in scientific proceedings but in fundamental religious contributions as well in the Bible and the Koran, for instance, being written before appearance of all the contemporary sciences, and those humanity does not want to part with, even in future, and it is not logical (reasonable) to throw off and to ignore their requirements to human life, these requirements are useful and just as human experience had shown through the millennia. These requirements to organization of life do not contradict those given by biology, physiology and genetics but complete them helpfully and it is logical to take into an account.

So, the Genetic People's Health science is a science on human Health, built and developing on the results of logical studies of the fundamental knowledge of Life—biological (connected with logics of Life) and genetic (connected with Man's origin and his natural roots).

Results of these logical studies are to be formulated as the Genetic People's Health principles and are supplied with the comments necessary and simple enough for intuitive understanding of these principles by common peoples including schoolchildren. Under the word “principle” all sensual loadings of the word are meant, namely principle (the Latin “principium”—basis, elements) is a (1) basic ancestral idea of theory, study, science (2) leading idea, basic rule of activity, at last (3) inner conviction, opinion, determining norms of behavior. From these positions, these principles are to be accepted by their elaborators: biologists, physiologists, and geneticists. From these positions these principles are to be taken by common people, distant from biology, molecular genetics and from serious science as well.

The Genetic People's Health principles are addressed to the most common man to show him, on the base of the fundamental biology, physiology and molecular genetics that,—in support, development and continuation of Life on the Earth,—he is a plenipotentiary and full partner of the Creator (called Nature in science and the God in religion). And it is really so as the own organism of everyone is a plenipotentiary and full representative of the Life as such, Life on the Earth, this single Life, knowledge of which is accumulated by humanity in books on biology and in books of the fundamental spiritual heritage as the Bible and the Koran. In other words: the Genetic People's Health science is to be based on the principles of linking of the biology and religion. Really, from the scientific biological point of view: 1) the Man is a living being with ability of speak and think, intellectual leader of the living matter's development, the leader of Life development he had become 2 millions years ago, the Master of all living on the planet of Earth; 2) the Life is a peculiar form of existence and movement of the matter, being performed in existence and organisms' activity, including human; 3) the matter is an objective reality existing out of and independently of human consciousness.—These three circumstances are inducing the humanity to talk about the Man and His activity, about His way of life, and His moral Health from the scientific and religious points. The spiritual culture as humanity's fundamental heritage is a fine guideline in the human activity and the security of that guide line and its consistency to the scientific ones has been already checked through the ages.

Further, the Genetic People's Health principles are directed to the most common man, to help him to find his own philosophy of life, philosophy of own nutrition and philosophy of organism support in healthy physical and spiritual state. The spirit is an element determining the behavior and the psychical abilities of a human being, its internal moral force. The conscience is a human ability to think, to meditate and to determine an attitude to the reality. The thinking is a process of reflection of the objective reality in the intelligible terms, notions and judgments. We repeat: these principles are directed to a common man to assist him to find his own philosophy of life, philosophy of nutrition, philosophy of supporting the organism in healthy physical and spiritual state. Without the personalized vital philosophy, the man is unable to support his own organism in healthy physical and spiritual state, as without his own philosophy he ceases to be Homo sapiens and becomes a subject of easy manipulation of other persons and structures who are following to their own interests to the detriment of the interest of the man.

At last, the Genetic People's Health principles are addressed to simple people to refer more respectfully to elements of biology, physiology, molecular genetics and independently (on own reason, but not on commercial publicity base) and to use these scientific data in 1) choice of food, 2) choice of way of eating, and 3) choice of way of life—these three choices do support and recover human health. Nothing is more necessary and nothing other is given. All the rest seems alien for a human organism, for genes and for therein codified information (scientific information is not given to rise above genes information, scientific information cannot be leveled with genes information, as Man is not given to create Life as all biologists agree in). That, is besides 1) choice of food, 2) choice of way of eating, 3) choice of way of life,—nothing is given to man to support and to recover his health; as a principle, (*) a man is not given to construct and build the archi-complex food molecules (molecules of proteins, carbohydrates, fats, DNA and RNA); (*) a man is not given to construct the simplest living cells, not mentioning the human organism containing nearly 5 trillions of living cells creating Life; (*) a man is not given to construct and build DNA molecules, including genes, bearing codified information, without which Life as such is impossible.

Three choices: 1) biologically justified choice of food being prescribed by the Nature-Creator, 2) physiologically warranted choice of the way of eating, 3) genetically and biologically justified choice of the way of life—are a unique base for support and recovery of health by any person. Other choices of the means for the support and recovery of health are seeming to be ways of money extraction (from credulous simpleton's pocket), as is given, so to speak, by devil. Anyone is obliged (by himself and only so) to protect himself from the foolish antiBIOlogical proposals of modern essentially commercialized human society and is does not concern only hard drugs, tobacco and alcohol, that is clear nowadays to everybody, but it is more evident in the case of 1) food, 2) way of eating, and 3) way of life, but that is unfortunately to few people. A human society represented by corporations, have taught BIOignorant individuals (firstly kids and teenagers lacking own philosophy of life and own convictions) to use drugs, tobacco and alcohol as commercial goods absolutely unnecessary for a human organism but excessively profitable for the corporations. This situation would be eternal, as, in human society there always be kids, teenagers and other BIOignorant individuals, far from BIOscientific elements. This situation, connected with drugs, tobacco and alcohol, is realized now by many people. Now practically the everybody don't realize that human society represented by corporations has already taught BIOignorant individuals without certain philosophy and own convictions to 1) use biologically unjustified food, 2) choose physiologically unwarranted way of eating, 3) choose genetically unjustified way of life—all these incarnations of BIOignorance is hundredfold more profitable for corporations and hundredfold dangerous for a human health than the usage of drugs, tobacco and alcohol. And very few people who understood the American Natural Hygienic System—the 150-year-old clinical and theoretical scientific application of the Natural Hygiene on the American continent, did realize this situation, unfortunately. We repeat that everyone is objected to defend himself from the foolish antiBIOlogical proposals of modern commercialized society and it concerns not only drugs, tobacco and alcohol what everyone understands but it concerns in greater degree the 1) food, 2) way of eating, 3) way of life—it is realized by very few only. The Genetic People's Health principles are elaborated to help this realization from the highest positions: from the positions of the proper philosophy of life, from positions of the convictions, from the positions of biologically and genetically justified choice of 1) food, 2) way of eating, 3) way of life. We repeat: without the proper philosophy of life, a modern man being completely dependent on society's goods and services, cannot support the organism in a sane physical and spiritual state, as without the proper philosophy, he becomes a subject of easy manipulating by other persons and structures who follow their own interests but not the interests of this credulous person. So it was, it is, it will be always—this is the Man's nature, this is a stage of human society's formation on the base of Corporations, Money and Commerce once invented by a Man and extremely useful in a formation of human society (or community) as such, but, to apply these inventions safely, one is to learn and to learn. The the Genetic People's Health principles are elaborated to help in this learning to most common people: businessmen and non-businessmen, medicals and non-medicals, all of us, who may consume something from the Commerce who drinks from the same hands, who leads this or that way of life inculcated by the Commerce and its advertising, who are frequently and seriously ill, and, if so, then swallow the pills and other pharmaceuticals from the hands of the Commerce, but with no recovery, and who are then starting to complain for their own life, for the Life at all, of the unfavor of the Creator, of the Nature's imperfection creating such an imperfect non-omnipotent human organism. But we, people, do never complain of the imperfection of our own mind-reason.

In connection with the above mentioned, we propose the next form of compilation of the Genetic People's Health principles. Firstly the principle is briefly formulated. Later on convincing biological, physiological and genetic comments follow, being presented on a language clear to a most common man. These comments are to help common people, including teenagers, to find their own philosophy of Life, nutrition, support of organism in healthy physical and spiritual condition, as without the proper philosophy of life, a modern man being completely dependent on society's goods and services, cannot support the organism in a sane physical and spiritual state, falls out of a category of Homo Sapiens and sore becomes a subject of easy manipulating by other persons and structures who follow their own interests but not the interests of this credulous person, including the workers and shareholders of these very corporations. That is a human fate: an individual is to defend himself, his own life and health against the unfavorable conditions of the environment and human society, as the latter is not ready enough to bear the burden of these functions now. All the hope are being of oneself and children's hopes are of their family. The Genetic People's Health principles are to assist an individual in the self-protection against the antiBIOlogical commercial proposals from the society, from the antiBIOlogical goods and services of the corporations.

1.2. The Genetic People's Health principles.

1.2.2. The “Social Problem of Natural Hygiene and the Individual”.

This part of the Field is used as internal informative stuffing in production of microprocessor devices (the BIOcultural microcomputers and microprocessor toys) claimed by us.

For wording the problem, we should quote the text from the book “The Science and Fine Art of Food and Nutrition (Hygienic System: II)”: “‘Return to Nature’ in your eating habits. Forsake the commercialized and spoiled foods that are fostered by the manufacturers of foodless foods” (p. 75). “Manufacturing chemists, druggists, food manufacturers, etc., cannot compete with nature in preparing food for man” (p. 86). “Back to natural eating, should be our rallying cry. Are we such fools that we are going on forever removing from natural foods essential nutritive factors and then replacing them with ‘just as good’ synthetic substances? Shall we forever bow the neck to the yoke of commercialism and a false science created by this same commercialism?” (p. 405). “I always suspect commercial motives in the physician” (p. 20). “Unfortunately the medical profession does not fail to identify its own best interests with the perpetuation and aggravation of our present disabilities. In accordance with its own financial interests it has neglected (and discouraged in all others) any effort to restore natural conditions” (p. 526). Further, from the book “Natural Hygiene (The Pristine Way of Life)”: “With individuals as with society, we are all victims of false and vicious habits, customs, practices and doctrines and lack both the knowledge and the independence to live in ways that are right and good for us. We are slaves to fashions, folly and pride” (p. 302). “In the world as at present organized, which is an irreversible antihuman machine, no individual can obey these laws so as to have integral health—it is an impossibility. We tend towards health as far as we and others become aware of the evils that exist. But if my neighbor poisons the air with the fumes of tobacco, if he pollutes the water with the exhaust from his factory, if he radiates evil wherever he goes, he makes me suffer with him. There is a unity in the race that makes the crimes of one man rebound to the hurt of another. We cannot repudiate this unity any more than we can repudiate the unity of our own body. I cannot be healthy alone—I cannot be honest alone. In a society in which dishonesty is the fashion, as it is everywhere, though people do not understand it, dishonesty is forced upon all. The full Hygienic life must await that broader social revolution that will liberate man from age-old slaveries that bind him to social evils” (pp. 153-154).

So, that is the “Social Problem of Natural Hygiene and the Individual”, who is living now in extremely commercialized human society:
“With individuals as with society, we are all victims of false and vicious habits, customs, practices and doctrines and lack both the knowledge and the independence to live in ways that are right and good for us. We are slaves to fashions, folly and pride. In the world as at present organized, which is an irreversible antihuman machine, no individual can obey these laws so as to have integral health—it is an impossibility. In a society in which dishonesty is the fashion, as it is everywhere, though people do not understand it, dishonesty is forced upon all. The full Hygienic life must await that broader social revolution that will liberate man from age-old slaveries that bind him to social evils”.

Methodic, methodological, technical, and technological solution of this “Social Problem of Natural Hygiene and the Individual” does represent the aim and sense of the given invention developing the once started by us in U.S. Pat. No. 6,179,778 B1 (LEONOV et al.), Jan. 30, 2001 and in the U.S. Patent Application Publication No.: US-2003-0023147-A1 (LEONOV et al.), Publication Date: Jan. 30, 2003, Title: Biocultural microcomputers and microprocessor toys for preliminary self-enlightening of an individual in Bioculture and Natural Hygiene and for subsequent simple, playing, easy-to-understand usage of the American Natural Hygienic system. And, namely, with the deepest respect to the author of above given phrases, ideas and conclusions, we, the authors of the given patent application, are rejecting these last words “The full Hygienic life must await that broader social revolution that will liberate man from age-old slaveries that bind him to social evils” and are replacing these words with a bit different ones: The full Hygienic life must await that broader BIOcultural technical revolution that will liberate man from age-old slavery that bind him to social evils. As a “BIOcultural technical revolution” we do propose the BIOcultural microcomputers as future embodiments of the invention in the U.S. Patent Application Publication No.: US-2003-0023147-A1, that we are adding with the present innovation, namely: the science and art of Computerized Global Humanitarian BIOcultural Genetic Public Health (Health without medical “Health Service”), and microprocessor devices aiding the same, and method of producing the devices in the part of preparing theirs internal informative stuffing, and the specialized “Computerized Global Humanitarian BIOcultural Genetic Public Health” Internet-site system as means specially intended for realization of this method.

1.2. The Genetic People's Health principles.

1.2.3. The “BIOphilosophy of the Individual” based on philosophy of Life as such, on BIO as a natural phenomenon on the Earth and, at the same time, in everyone's organism.

This part of the Field is used as internal informative stuffing in production of microprocessor devices (the BIOcultural microcomputers and microprocessor toys) claimed by us.

In up to date commercialized life, under the strongest pressure of TV advertisement, being elaborated by highly specialized psychologists of Public Relations (briefly PR, special psychological services in firms and organizations to provide where, really, relations with simpletons). These highly qualified and highly paid psychologists are capable to suppress subconscience and mentality of anybody even with university degree, saying nothing of teenagers and grown-ups with no higher education, that is, and the prevailing part of the humanity.

It is rather comfortable to operate this prevailing part of the humanity with the aid of subconscious herd instinct (“Do as all do!”), habitual to all and inherited from our “younger brothers”. It hardly seems to be the best our position “Do as all do!”, “Eat as all eat!”, “Take cure as all take!”, briefly, in other words, “Take your spot in a herd!”, in herd being operated comfortably and profitably by means of diverse fashion styles used en masse cultivated by TV-PR lads on previously fertilized soil of our common human stupidity-recklessness and pride-arrogance, typical in youth to all of us and to some aged ones, too.

So in a contemporary and completely commercialized human society any individual becomes an object of easy manipulation by highly qualified PR psychologists. To defend yourselves from powerful psychological pressure, to protect from recommended fashions having the own vital philosophy, that is, how to live in harmony with the demands of the Creator (Nature or the God, if you wish), how to nourish yourself, how to support recovering good health if it has been suffered of your own unreasonable choice of meal, or lifestyle—all these choices can not be reasonable without biological knowledge, without the BIOculture of an individual, without the own philosophy of the individual, basing on the philosophy of Life as BIO, as of natural phenomenon on our planet and in the human organism as well.

The science and art of the Computerized Global Humanitarian BIOcultural Genetic Public Health—is a Health Service based on individual's BIOculture and his faith in Creator. BIOculture of an individual is an outlook, an approach to himself and to the surrounding world, to own health service and choice of meal and manner of food, to the own and family life, an approach to social life in the community from positions of: 1) the Living Cell as such, and plus 2) the Genetic Program as such.

Both the cell and the program in cell's nucleus do exist beyond and out of human consciousness, and both do function and perform the Life on the Earth and, at the same time, within the human organism, on the base of our plant food that we see in garden, field and kitchen garden and appreciate so insufficiently in its primordial state. Biologists are certain, the complete cognition of a living cell and genetic Program and their creation lay beyond the human competence, so that we recognize the occurrence of the Creator named in science as Nature and in religion as God; the usage of various names doesn't change the essence of the Creator.

The BIOcultural microcomputers for Science and Art of Computerized Global Humanitarian BIOcultural Genetic Public Health (Health without medical “Health Service”) proposed in the given patent application are first of all tailored to help the user to elaborate the “BIOphilosophy of the own life”, based on the philosophy of the Life as such, basing on the philosophy of Life as BIO, as of natural phenomenon on our planet and in the human organism as well; the Life as such is the same for all the living beings on the Earth and there is no life with no genes, the code of those is also the same reality for all the living beings on the Earth, both vegetable and animal, including our ones.

The BIOcultural microcomputers for Science and Art of Computerized Global Humanitarian BIOcultural Genetic Public Health (Health without medical “Health Service”) proposed in the given patent application are inconceivable without the internal informative stuffing; during the production process, their databases are to be filled with the data on the Life as such, as BIO, as a natural phenomenon on the Earth and in the everybody's organism.

The illustrations of internal data stuffing or the microprocessor devices required are given below. This stuffing is to elaborate the user's BIOphilosophy of his own life, based on the philosophy of the Life as such, as a BIO, as a natural phenomenon on the Earth and in the everybody's organism.

First. The Genetic Program as such, exceeding all the program products of the world, is being an intellectual product, so it has its author. The Author of the Program is our Creator, always working for us in the every living cell of our body and of the plants prescribed to us by Him as a primary food. We have also to understand the following. The beginning of the year 2000 and of the Third Millennium was marked with a sensation—it was deciphered: structure of human genome, so since this time the Healthcare becomes to be Genetic. Two earlier proved facts are to be added: the genetic code—a basic law of life—is single for all the living beings (microbes, plants, animals, man) and secondly, from the point of physics and theory of information, it is so complicated that it could not appear accidentally by itself and, so, the genetic code—a basic law of life—has its own pre-biological evolution. That is, the molecules of DNA/RNA, the genes as patches of DNA/RNA molecules and material bearers of genetic information and this information itself and operators for its realization were created by Somebody long before the appearance of Life on the Earth.

In other words, the Life at the whole time of its existence, the Life in any plant, animal and man, from the very first time and until now does have some Creator, in science called the Nature and in religion named the God; any usage of different terms does not change the essence of the Creator as such, His laws we cannot ignore irrelatively of where were they formulated, either in the Bible and the Koran or in Biology and Physiology. Thus, in the case of proper accumulation and the respect of spiritual and scientific heritage of the humanity, the health-servicing potential of genes of our body (existing out of human consciousness) is limitless.

One is to remember that the health-servicing potential of a gene of our body is codified 9 months before our birth and it is inlaid into somatic cell nuclei, we are having around 5000 000 000 000 of those. So, “The Creator's Eye” and “The Mechanism of His reaction upon our actions” are installed into each living cell of our sinful body. Otherwise, our Creator is not “somewhere in the skies” but directly within us—whether we want it or not, whether we know it or not, whether we recognize it or not. Therefore, as for any of our diseases, bad mood or indisposition, we ought to interpret it as favorable parent's “slap” in connection with our childish disobedience to Mother-Nature as a signal of our unwise behavior; to take off this symptom by means of medicines of commercial origin and being alien to human body, is a double stupidity.

Non-hand-made health-servicing potential of genes of our body is really limitless, as it is a potential of the Creator of Life for all the time of Life's existence. Another (commercial, hand-made) health service is pseudoscientific, mostly speculative, amoral, unnatural, absurd genetically, that is contrary to the Creator. The moral is: not to change the living Nature for the purpose of commerce, for profits of corporations, but to study genetic requirements and to follow that meekly for the human Health. That is the essence of genetic Health Service. It originates basically from the Creator and depends on our reason-mind also: 1) what do we eat, 2) how are we eating, 3) what way of live are we choosing for ourselves.

Second. Outlook (the world outlook, Weltanschauung) is to be a system of views on Nature and society. Soul is an inner, psychological world of consciousness. Spirit is a consciousness, thinking and psychic abilities, which induces deeds, activity, behavior, determines the actions. Contemplator is a person inclined to observation without actions, that is, his position does not attain to his scientific BIOlogical determinations as Homo sapiens—intellectual leader in the development of Life on the planet Earth.

Third. Nature is all the organic and inorganic world existing in the Universe, living and non-living matter. This all exists out of, and independently of, the human conscience and, so it has its Creator; scientifically, it is His Majesty the Chance and, from religious viewpoint—It is the God. Scientifically, it is supposed that “the everything created and existing”, has appeared occasionally. If it is so, then the Chance rules the world, it operates us and each of us, as nobody except the Chance and us continues to govern; there are some means to submit it and to become a Master of Nature. That is a limitless field is opening for permissiveness to each of us, empowering and doubting at the same time.

Fourth. Protein potential of a man is boundless, as you may realize.

The Life on the Globe is first of all “existence of protein bodies”. Proteins are the main constructive element of any cell, of any vegetable and animal organism, including human also. Protein molecules are met in all cell structures and comprise 10-20% of its weight or nearly 50% of dry weight, that is 50% of total dehydrated living matter on the Globe. Great variety of proteins does enable molecules to accomplish a plenty of structural functions and many functions and roles in metabolism. Proteins' functions in organism are very diverse and vitally important.

The most important role of proteins is enzymatic. All the biochemical processes in a living cell are performed only in the presence of enzymes—definite molecules of protein type, which accelerates reactions in million times without changing themselves. Enzyme molecules are formed by cells and are able to work for several hours; afterwards, they are utilized and replaced by the new ones.

Chemically, enzymes are proteins. Their function is to accelerate sharply the rate of biochemical reactions. Without enzymes, biochemical reactions do proceed so slowly, that the Life would be impossible. Enzymes are partially related to digestive enzymes formed and are extracted by living cells of mucus into gastrointestinal tract for splitting our food for “building blocks”, necessary to the vital activity of the usual cells.

The most important role of proteins is constructive, for instance, collagen is referred to the class of structural proteins being a basic component of connective tissues, tendons, cartilage, bones. Proteins are included into all the cellular structures.

One of proteins' functions is motive, for instance, all kinds of moving activity—contractility of muscle fibers, eyelashes movement, etc.—are supplied by peculiar protein structures, so called contractile proteins.

Transportation is an important function of protein molecules. Special transportation proteins achieve transportation of many substances into cell, inside cell and outside from cell. Hemoglobin is referred to transportation proteins, transmitting oxygen in a blood when myoglobin transfers oxygen within the muscles.

Protective function of proteins is one of the most important. In case of penetration of bacteria and alien protein molecules into organism special protein molecules, called antibodies, are elaborated to neutralize the intruders. Antibodies are protective protein molecules forming complexes with alien molecules preventing their threat to our health. Fibrinogen and thrombin are protective protein molecules, participating in blood coagulation, otherwise we could loose it all through any tiny wound.

Further, some proteins can be used by cell as a source of energy, appearing within the oxidation of protein. The energy is discharged in utilization of exhausted protein when the protein unable to be used is split to the final products of decay: carbon dioxide (CO₂) in breath out, water which is used again, nitrogen containing substances discharging with urine and so on.

The synthesis of urgent protein molecules is fulfilled in the living cells of organism. Only those molecules are synthesized, that are necessary in the given moment; they are made by certain cell for a short term to perform this or that function. Organism's cells are specialized—each cell synthesizes protein molecules in accordance to its specialization. The building of necessary at protein molecules is proceeded in conformity with the information codified in genetic code stored in nucleus of each living cell. DNA molecules with participation of various RNA molecules organize synthesis of proteins. A number of aminoacid molecules are demanded for synthesis of necessary protein molecules of certain type, certain quantity, in definite place and at the appointed time.

The aminoacid molecules—are the simplest in protein type, being structural elements of bigger molecules of proteins. A great amount of protein types exists; all they differ in spatial configuration of aminoacid molecules. Now, nearly 50 000 of various protein types do work in a human organism having definite roles or certain functions. Protein types' quantity seems enough—greater amount would be in excessive, that is not required by a contemporary Man; however, he, as a leading part of life, is developing continuously, and, for this purpose, the “material base” for body cells is to be foreseen by the Creator of life, the Author of the Genetic Program.

We repeat, the protein molecules are formed from aminoacid' molecules as of simplest structural protein elements. In vegetable and animal tissues, around 170 aminoacids occur. There are 26 or, more frequently, 20 aminoacids in protein composition summing us; the diversity of proteins is attained by combination of 20 aminoacids. We are to bear in mind, that, by usage of 30 alphabet letters in various combinations, thousands various books are issued, that is: combining 30 symbols, one can codify diverse information written by alphabetic signs. Protein molecules forming living cells of the organism, are the informative ones, as also the DNA molecules. If these 20 aminoacids are to consider as some “letters” their combinations should be treated as pieces of aminoacids breed consisting of some “letters”. This breed is written by DNA and RNA molecules.

Different combinations of aminoacid molecules are called peptides and, in case of long combinations, they are named polypeptides. Of two different aminoacids, we mark them as A and B, one can make the following combinations: AA, AB, BA and BB, that is, two aminoacids are capable to form 4=2² dipeptides. The quantity of polypeptids being 100 aminoacids residues in length formed from 2 different aminoacids is equal 2¹⁰⁰=1.27×10³⁰. Twenty but not 2 aminoacids are acting in our body. The quantity of polypeptides with length of 100 aminoacid residues amount 20¹⁰⁰=1.27×10¹³⁰—this enormous quantity of potentially possible protein types exceeds a considerably quantity of atoms in Universe equal to 10¹⁰⁰.

Such infinite diversity of molecules can be formed by living cells there is no limit to development and upgrade of a Human body. Those inhabitants of the Globe who accept the accidental formation of the first living cell, first primitive unicellular being of common microbe type (from which, by evolutionary path multicellular organisms have been formed, including the Man who has no limit of perfection of function due to basic, protein, building and functional material) are being atheists considered, that the Chance rules the world and it is really the chance who has created the Man and his unlimited physical and intellectual abilities. Those inhabitants of the globe who doesn't estimate this as a chance are religious, that is, they do believe in the Creator or the God. The remaining part doesn't worry about it. Biologists have not informed that part, what is the difference between Homo sapiens and “younger brothers”.

Fifth. The genetic potential of the Man is limitless.

Our body is an aggregate community of living cells working in the strict accordance with genetic program, which, as such, is a connecting link between vegetable and animal worlds; that is a million-year-experience of the Life Creator on the support of the Life on the Earth, and in particular, in the each human body. Genetic Program starts and controls life as a unique natural phenomenon. Genetic code is a system of fixation of hereditary information in DNA and RNA molecules of man, animals, plants and microbes. Genes are to be the material bearers of code being located in chromosomes. Chromosomes do bear DNA and gene is a section of DNA molecules. This section may contain from tens to 1500 nucleotides, each uniting from millions to billions of definite atoms—so huge and extremely complicated atomic structure of a gene is.

Gene is not common atomic formation: it is a bearer of genetic program, genetic information and operators on its realization; it remains a diskette with software to re-launch a computer or a book with printing of sequence of letters, number and symbols. It denotes, the sequence of nucleotides in DNA and RNA is not accidental as it may be the sequence of letters and words in a text of written instruction; this sequence is a genetic code. It seems impossible to agree that a monkey sitting behind computer and chaotically pressing keys may unexceptionally print the Code of legislation of some country. The acceptance of reality of this occasional event for visible time is simply impossible for any reasonable man. And more impossible may be such an occasion, a chance, when billions of necessary atoms are found in one point, then they fuse by change into nucleotides and form accidentally severe sequence presenting genetic code of some unicellular being—first living formation on the Earth from which all other living beings, including us, had originated. Those inhabitants of the Globe who accept the accidental formation of the first living cell, first primitive unicellular being of common microbe type (from which, by evolutionary path multicellular organisms have been formed, including the Man who has no limit of perfection of function due to basic, protein, building and functional material) are being atheists considered, that the Chance rules the world and it is really the chance who has created the Man and his unlimited physical and intellectual abilities. Those inhabitants of the globe who doesn't estimate this as a chance are religious, that is, they do believe in the Creator or the God. The remaining part doesn't worry about it. Biologists have not informed that part, what is the difference between Homo sapiens and “younger brothers”.

Sixth. The intellectual potential of human development is unlimited.

The Genetic program single for all cells of a given individual, determines the activity to all body's cells, particularly to the living cells of the brain. Neuron is the nerve cell, structural and functional unit of nerve system. This specialized cell is 1) capable to receive to treat to codify, to transfer and to save information; 2) capable to generate electric impulses and to transfer codified data; and 3) able to react upon irritation, able to contact with other neurons and cells of other of organs by specialized endings-synapses.

It is noteworthy scientific fact, difficult for realization: the number of neurons in human brains reaches 10¹¹, one neuron may have up to 10 000 synapses; if only these elements are considered as cells of information storage, then nerve system of us is able to keep 10¹⁹ bits of information that is the system can contain all the knowledge collected till now.

Yes, there are no limits for human development and perfection! Those inhabitants of the Globe who accept the accidental formation of the first living cell, first primitive unicellullar being of common microbe type (from which, by evolutionary path multicellular organisms have been formed, including the Man who has no limit of perfection of function due to basic, protein, building and functional material) are being atheists considered, that the Chance rules the world and it is really the chance who has created the Man and his unlimited physical and intellectual abilities. Those inhabitants of the globe who doesn't estimate this as a chance are religious, that is, they do believe in the Creator or the God. The remaining part doesn't worry about it. Biologists have not informed that part, what is the difference between Homo sapiens and “younger brothers”.

Seventh. Potential of genetic (not hand-made) health service is unlimited therefore alien (hands made) health service is pseudoscientific, speculative basically absurd, you may see it yourself.

The human organism is constructed and functions by own cells, for the Life, BIO as such, on the Earth is being created by them, in them and in no way else. Myriads of primary initial living formations are within our bodies and one is to remember that the genealogy of each cell is started from zygote—primary and single living cell formed by the fusion of spermatozoon and ovule of our parents. The human body does consist of myriad of functioning living cells and each cell functions on single according to the given individual personal genetic program: 1) the one formed as personal at the moment of fusion of DNA molecules in Zygote's nucleus; 2) that is having made zygote to feed, to grow to divide into daughter cells with copying the genetic programs into nuclei; 3) that making cells specialized for activity in the tissues of various organs of our body (heart, intestine, brains, etc.); 4) that permitting cell to be immediately self-annihilated, in the case of first mistake in its activity, first insubordination to genetic programs; 5) under that each out unconditional reflex is accomplished; 6) that forming the activity of each organ or system of organs—brain, muscles, heart and the whole cardiovascular system.

To illustrate, we shall give the following examples of living cells' functioning under the control of the genetic program.

The first example. The genetic program dictates the operation mode to all the living cells of muscles. Really, the spatial transference of a body, support of a definite pose, shift of separate parts of body, heart work, vascular work, gastrointestinal work, heat discharge in corporal thermoregulation—all this is operated by a genetic program and performed by the muscles' specialized living cells mainly intended for transformation of a chemical energy of eaten food into a mechanic work and heat.

The second example. The same genetic program gives work to all the cells of blood. Blood comprises 6-8% of weight that is 5-6 liters average. The basic function of blood is transportation. Blood transfers vitally necessary substances, gases, and metabolites. So, blood going through lungs, gives back carbon dioxide and is simultaneously saturated by oxygen. It is realized so, that erythrocytes, specialized living cells, elaborate molecules of peculiar protein called hemoglobin and, with its assistance, erythrocytes do convey oxygen and carbon dioxide—here is a basic function of erythrocytes and main purpose of hemoglobin. Second basic function of blood is protection. For example, conservation of blood in liquid state, otherwise it would not circulate. The next example is stoppage of blood circulation in case of damage of vessels. One example more—the immunity connected with occurrence of leukocytes, the specialized living cells, in blood, they are important in protection of the organisms from diseases; 70% of living and active leukocytes are capable to intake and digest pathogenic bacteria, 4% of our leukocytes are able to migrate through capillary walls to inflammation focuses and destroy the pathogenic bacteria, 24% of leukocytes are able to cause immune reaction by forming the antibodies to destroy tumor cells, 1.5% of leukocytes can sharply rise their concentrations in allergic states. The third basic function of blood—regulatory one, is being connected with intake to circulation hormones, biologically active substances and metabolism products.

The third example. The same genetic program dictates the mode activity to all the living cells of a heart. Blood is moving owing to periodic contraction of a heart. These contractions are caused by the periodic excitation in myocardium. Specialized living cells of myocardium, under natural conditions, are, in the state of rhythmic excitation, capable to elaborate the difference of electric potentials nearly 100 mV with frequency of 60-80 per minute, and besides myocardium cells have a huge quantity of intercellular electric contacts by those excitation is conducted from one cell to another. The myocardium consisting of the single cells works as a unity due to these contacts, those quantity is raising the safety of conduction throughout myocardium. For instance in the case of damage of specialized generative node pacemaker, it can be replaced by another one capable to generate impulses with frequency of 40-50 per minute, in case of turn off the latter node, the specialized muscle fibers will be operating as a pacemaker with drop of impulse till 30-40 per minute and if the last one would switch off the process of excitation will originate spontaneously in the cells of some specialized fibers and cardiac rhythm would be lower, nearly 20 pulse beat per minute.

The fourth example. The same genetic program dictates simultaneously the mode of operation to all the living cells of our body—we have there nearly 5 trillion cells. At the same time, this genetic program, being single to organism of given individual, not does only arrange the cells' activity but does perform a strict control on each living cell activity. Try to judge yourself. It is well known, that, at a moment, almost billion of cells is in change state: they are dividing, renewing or dying off. Besides, during twenty-four hours, 20 billions of new cells (living creatures!) do appear in the human organism to substitute those which became aged and have worked out their biological resource. Under normal natural conditions, the majority of body cells have resource of 40-50 divisions and, later on, the cell looses capacity of copying genetic information exactly and it becomes dangerous for an organism. The Nature had foreseen a special mechanism against this danger: the aged and weakened cell having made a mistake in copying genetic program, at that moment, does launch the mechanism of self-elimination—it starts to elaborate enzymes destroying the protein frame of a cell; the destroyed cell is utilized under assistance of antibody and immune complexes, giving place for new young cells.

It is certainly evident to everybody, that the potential of genetic (not hand-made) Health service is Limitless, that's why other (artificial) health services (treatment of hepatics, hearth, kidneys, stomach, cure of ear throat, nose, left nostril, right nostril etc., et. al.) are pseudoscientific, speculative, and basically and genetically absurd. Really, for our life supply and our vital activity, for our Health and vigor, there are working 1) not the heart but for each living cell in it; 2) not the stomach but for each living cell in its structure; 3) not the nerve system but each living cell, forming its multitude; 4) not the organism but each living cell, of which does it consist, being an indivisible living (not made by hands) unity. These cells are counted in myriads, but each cell is submitted to the single genetic program.

Within our body, our corporal world exist, a real Universe or natural Cosmos formed by myriads of the living cells. This corporal world has its own life according to natural laws, to which our consciousness has no relationship. The program of life supply and vital activity in the corporal world had been composed by Nature long before our birth. For the sake of security, this program was inlaid by the Nature in a nucleus of every cell of our body; the program being named genetic, and each living cell within us lives in accordance to it and develops activity for the sale of other cells of our body.

Briefly speaking, the biological life and life quality of each of us—it means: biological life of those living formations called cells. Something from the life of our corporal world has been noticed and described by biologists and physiologists, but it is enough work for many centuries, till the humanity exists.

We repeat: it is evident to everybody that the potential of genetic (not hand-made) Health Service is limitless, therefore other (artificial) health services (a cure of ear, throat, nose, left nostril, right nostril, etc., et al.)—are pseudoscientific, speculative, basically and genetically absurd. Nevertheless, the other (artificial) health service is not absurd commercially, as it allows to sell simpletons (people distant from biology and genetics, that is practically all the humanity) a great lot of chemical and other pharmaceuticals on a huge sum of money: one for hepatics, second for heart, third for kidneys, fourth for stomach, fifth for ear, others for throat, nose, left nostril, right nostril etc. et al. The simpletons purchase it all, then they repeatedly are convinced that to take off symptoms—is absolutely a useless occupation similar to cutting tops in weeds: how much don't you cut them, they grow up again, for their root is remained and strengthened.

Thus, those simpletons (people distant from biology and genetics—practically all the humanity) need now urgently, as never before, the BIOenlightening of their own, the BIOculture of their own, the own BIOphilosophy of life based on the philosophy of Life as BIO, as a natural phenomenon on the Globe and in the organism of this individual. Nowadays, without BIOphilosophy of the own life an individual is not to hope for a normal health, as it is impossible to buy even for all the money of the world. Without BIOphilosophy of the own life, the individual cannot survive in the conditions of totally commercialized human society.

Proposed in the given patent application, the BIOcultural microcomputers and microprocessor toys for self-enlightening of an individual are appealed, in playing and easy form, to help in all this BIOenlightening to those very simple ones, including schoolchildren. We emphasize, for all this self-education in fundamentals of modern molecular biology, we do propose not a thick and boring students' textbooks, but microprocessor toys that would be required by the majority of human race—by the common people and teenagers far from modern biology and therefore loosing health due to their own BIOignorance.

Indeed, under normal conditions, the majority of cells have a physiological resource for 40-50 divisions; at the same time, the physiological resource for self-recovery is planned for 120-130 years of vigorous life. Nevertheless, few people will reach this age due to the following trivial truth. Self-substitution of an aged (worn out) cell by new young one can take place 50 times or 30 times or only once—all depends on how the conditions are close to Nature's demands. Self-recovery or self-reconstruction of organism can last 130, 50 or only 1 year: all depends on conditions of living, those are to be known. Those are the consequences of mass and total BIOignorance of the people extremely rarely reaching 130 years. It seems unreasonable to agree with such a mass BIOignorance. Therefore, the proposed, in given Patent Application, microprocessor toys for easy and simple BIOenlightening would be required by those distant from modern Biology and loosing health due to their own BIOignorance.

1.3. The Genetic People's Health technique.

This part of the Field contains theses of the BIOcultural microcomputers and microprocessor toys for grown-ups and kids, and a method of production of these devices in the part of preparing theirs internal informative stuffing, and the specialized “Computerized Global Humanitarian BIOcultural Genetic Public Health” Internet-site system as means specially intended for realization of this method.

All parts of the “Field of the invention” are used as internal informative stuffing in production of microprocessor devices (the BIOcultural microcomputers and microprocessor toys) claimed by us.

The devices proposed are impossible without informative databases, being an internal stuffing of the devices. The Computerized Global Humanitarian BIOcultural Genetic Public Health principles are necessary for production of microprocessor devices as an internal stuffing. The codification of these principles is a constituent of the proposed devices' production.

But the formulated code of the Computerized Global Humanitarian BIOcultural Genetic Public Health principles is only its beginning. For the production and further modernization of microprocessor devices, more complete and elaborated code is to be used. Therefore, the proposed Patent claim on specialized devices would be incomplete without an indication of production mode as a whole, including, as a constituent, the method of preparing of the complete and developing code of the Computerized Global Humanitarian BIOcultural Genetic Public Health principles as an internal informative stuffing of the proposed microprocessor devices.

That is why, we also incorporate the method of production of microprocessor devices in the part of preparing the internal informative stuffing of the devices in their production, into the given Patent claim. We are patenting additionally the technical device for realization of the method as firmware System, including the specialized “Computerized Global Humanitarian BIOcultural Genetic Public Health” Internet-site and necessary software for organizing, on the Internet-site, the above mentioned method of the information preparing of the internal stuffing of proposed devices in a process of production.

So we are patenting: 1) the special devices, 2) the method of their production in the part of preparing internal informative stuffing of these devices, and 3) the technical means, specially designed for realization of this method.

This technological method of producing devices in the part of preparing of their internal information stuffing is attained by following steps: 1) publishing of the “Computerized Global Humanitarian BIOcultural Genetic Public Health” principles confirmed by the Editorial board of the specialized “Computerized Global Humanitarian BIOcultural Genetic Public Health” Internet-site on its pages to make the principles attainable to any user of the Internet; 2) offering to the visitor the Internet-site,—wishing to use the “Computerized Global Humanitarian BIOcultural Genetic Public Health” principles for support and recovery of health and having got some individual experience of usage of the principles,—to set questions and to express the requests to professional biologists physiologists and geneticists; 3) publishing of questions and requests of users on the pages of the Internet-site for making these questions and requests attainable for any indicated specialist having an Internet access; 4) offering to professional biologists, physiologists or geneticists, wishing to answer questions and requests, to formulate and to sent the reply on the Internet-site in the form of the next “Computerized Global Humanitarian BIOcultural Genetic Public Health” principle and necessary authorized comments to it; 5) analyzing of the replies obtained by the Editorial board of the Internet-site; afterwards the replies worth some peculiar attention are to be additionally reviewed as it is practiced in the academic journals: with the assistance of so called “black opponents” from permanent authors having in the not less than three own publications “Computerized Global Humanitarian BIOcultural Genetic Public Health” Internet-site; 6) making the final decision, by Editorial Board of the Internet-site, to publish the given reply on Internet-Site pages as a new “Computerized Global Humanitarian BIOcultural Genetic Public Health” principle or not; and 7) usage of so obtained information for re-formulation of “Computerized Global Humanitarian BIOcultural Genetic Public Health” principles as an internal informative stuffing of any claimed device in its production and further modernization in proper time—thus, with growth and accumulation of this information, and through it, the science and technical art of Computerized Global Humanitarian BIOcultural Genetic Public Health (Health without medical “Health Service”) will be developed and perfection will be reached in the production of any claimed apparatus in preparation of its internal informative stuffing.

So:

method of explanation of the Computerized Global Humanitarian BIOcultural Genetic Public Health science—the code of “Computerized Global Humanitarian BIOcultural Genetic Public Health” principles, understood intuitively by common peoples including teenagers;
method of publication of the Computerized Global Humanitarian BIOcultural Genetic Public Health science—the special “Computerized Global Humanitarian BIOcultural Genetic Public Health” Internet-site where the principles are available to visitors free of charge;
method of development of the Computerized Global Humanitarian BIOcultural Genetic Public Health science—improvement of the principles by the humanitarian efforts of biologists, physiologists, and geneticists of the world;
method of practical application of the Computerized Global Humanitarian BIOcultural Genetic Public Health science—independent organization of individual life using the Computerized Global Humanitarian BIOcultural Genetic Public Health principles intended for this aim;
method of popularization of the Computerized Global Humanitarian BIOcultural Genetic Public Health science—various topical entertaining individual and collective plays on the specialized “Computerized Global Humanitarian BIOcultural Genetic Public Health” Internet-site but, first of all, microcomputers and microprocessor toys for self-enlightening of individual in the Computerized Global Humanitarian BIOcultural Genetic Public Health principles and for subsequent simple using of the science—addressed to ordinary people, including teenagers.

So, the following information was determined in details afore:

1.1. Field of the Invention as a whole: the science and art of the Computerized Global Humanitarian BIOcultural Genetic Public Health (Health without medical “Health Service”) as proposed in the given patent claim our general and methodical solution of the definite social problem “Health service as such”, and as internal informative stuffing of our patented microprocessor devices in production.

1.2. First part of the Field of the Invention: principles of the science called Computerized Global Humanitarian BIOcultural Genetic Public Health as our vision of that future science and as the internal informative stuffing of our claimed microprocessor devices in production.

1.3. Second part of the Field of the Invention: “Social Problem of Natural Hygiene and the Individual” as the internal informative stuffing of our claimed microprocessor devices in production.

1.4. Third part of the Field of the Invention: “BIOphilosophy of the Individual” based on philosophy of life as BIO, or natural phenomenon on the Globe and in each man's organism. This part of Field is used as the internal informative stuffing in production of microprocessor devices claimed to be patented by us.

We shall emphasize once again: all above given information, as basic one, is used as internal informative stuffing of claimed microprocessors devices in production, of patented microprocessor devices in production, this information should be considered as an illustration of biological ideas being discussed and for indication of use of demanded by us BIOcultural microcomputers and microprocessor toys. We repeat once again: our production of claimed microprocessor devices is impossible without internal informative stuffing.

2. Description of Technical Prior Art.

Methodical, methodological, technological and technical decision of “Social Problem of Natural Hygiene and the Individual” were started by us with microcomputerization of the American Natural Hygienic System in U.S. Pat. No. 6,179,778 B1 (Leonov et al.), Jan. 30, 2001. Under the registration of that patent, it had been cleared out, that the Field within the framework “Natural Hygiene and the American Natural Hygienic System” was not elaborated technically before us, therefore the microcomputers proposed in that patent, are until now being the first and the sole Technical Art.

The Field, within the framework of the “Science and Art of Computerized Global Humanitarian BIOcultural Genetic Public Health” and within the framework of the “BIOculture and BIOphilosophy of the Individual”, was described by us first of all. That's why the innovations proposed, in the given Patent claim, namely:
(1) the “playing” BIOcultural microcomputers and microprocessor toys for self-enlightening of an individual in biology, incl. genetics and physiology fundamentals, and
(2) the technological method of producing the microprocessor devices in the part of preparing theirs internal informative stuffing, and
(3) the specialized “Computerized Global Humanitarian BIOcultural Genetic Public Health” Internet-site system as a technical means intended specially for realization of the technological method—
these three innovations comprise the single Technical Art on this Field.

### SUMMARY OF THE INVENTION

The afore given Field of the Invention has been being elaborated by the authors rather long ago and with the consequent (“step by step”) efforts on decision of the global human social problem, connected with independent healthcare service of an individual on the base of the science of Natural Hygiene expounded in the American Natural Hygienic System, in fact: on self-enlightening of individual in fundamentals of biology, physiology and genetics (“BIOenlightening of the Individual”, “BIOculture of the Individual”, “BIOphilosophy of the Individual”). Here are the steps.
OUR FIRST STEP in working out means and method of involving an individual to the Natural Hygienic life-style and to the Computerized Global Humanitarian BIOcultural Genetic Public Health science as a whole, as a solution of “Social Problem of Natural Hygiene and the Individual” now living in modern, commercialized to the core, human world—this step is aimed for microcomputerized Food Combining topic as the most Labor-intensive in the American Natural Hygienic System. This step has been described in detail in the Description of U.S. Pat. No. 6,179,778 B1 (LEONOV, et. al), Jan. 30, 2001, Title: “Computerized method of health prophylaxis through Food Combining, microcomputer for Food Combining, software product for Food Combining”.
OUR SECOND STEP in working out means and method of involving an individual to the Natural Hygienic life-style and to the Computerized Global Humanitarian BIOcultural Genetic Public Health science as a whole, as a solution of “Social Problem of Natural Hygiene and the Individual” now living in modern, commercialized to the core, human world—this step is dedicated to the further elaboration of the Field of given invention in methodical, methodological, ideological plans: we proposed to transform a scientific knowledge of Natural Hygiene from special scientific level accessible completely to Hygienists, physicians, D. Sc. to the category of enlightening, intelligible to common people, including schoolchildren.—We have introduced the concept of “BIOculture of the Individual” (mind: U.S. Patent Application Publication No.: US-2003-0023147-A1, Jan. 30, 2003) and, within this concept we have interpreted Natural Hygiene on some BIOcultural level. As a result, we have written and published a book “BIOculture of the Individual, and the Individual Natural Hygiene and Enlightening Microcomputers & Microprocessor Toys Specially for the Same (Our Not Easy Way to Health via BIOenlightening)”, 2004, 816 pages.—The book is written by written by Valery Leonov, Tatjana Malish (Leonova), and Pavel Leonov in Russian and issued in the authors' publishing house BIOcult, Saint-Petersburg, Russia.
OUR THIRD STEP in working out means and method of involving an individual to the Natural Hygienic life-style and to the Computerized Global Humanitarian BIOcultural Genetic Public Health science as a whole, as a solution of “Social Problem of Natural Hygiene and the Individual” now living in modern, commercialized to the core, human world—this step is dedicated to the further microcomputerization of the American Natural Hygienic System after adding the concept of “BIOculture of the Individual and Enlightening Microcomputers and Microprocessor Toys Specially for the Same”. This step we have presented in details in U.S. Patent Application Publication No.: US 2003-0023147-A1 (LEONOV et al.), Jan. 30, 2003. Title: Biocultural microcomputers and microprocessor toys for preliminary self-enlightening of an individual in Bioculture and Natural Hygiene and for subsequent simple, playing, easy-to-understand using of the American Natural Hygienic system.
OUR FOURTH STEP in working out means and method of involving an individual to the Natural Hygienic life-style and to the Computerized Global Humanitarian BIOcultural Genetic Public Health science as a whole, as a solution of “Social Problem of Natural Hygiene and the Individual” now living in modern, commercialized to the core, human world—this step is dedicated to the further elaboration of the Field of the given invention ideologically: the Field is supplemented by two concepts: “BIOphilosophy of an Individual” and “Computerized Global Humanitarian BIOcultural Genetic Public Health”. Both concepts are presented details in the given Patent claim and in seven our publications in Russian:
   1) “BIOphilosophy of the Individual, the principles of science and art of The Computerized Global Humanitarian Genetic BIOcultural public health, Part 1: Genetic and Biological Essence of the Natural Hygiene”, 2004, 64 pages;
   2) “BIOphilosophy of the Individual, the principles of science and art of The Computerized Global Humanitarian BIOcultural Genetic public health, Part 2: Problem of Foodstuffs'Choice as a Social Problem of the Natural Hygiene and the Individual”, 2004, 64 pages;
   3) “BIOphilosophy of the Individual, the principles of science and art of The Computerized Global Humanitarian BIOcultural Genetic public health, Part 3: Problem of Choice of a Way of Life as a Social Problem of Natural Hygiene and the Individual”, 2004, 64 pages;
   4) “BIOphilosophy of the Individual, the principles of science and art of The Computerized Global Humanitarian BIOcultural Genetic public health, Part 4: Problem of a Dyspepsia Danger”, 2004, 64 pages;
   5) “BIOphilosophy of the Individual, the principles of science and art of The Computerized Global Humanitarian BIOcultural Genetic public health, Part 5: BIOculture of an Individual as a Mean of His Self-Defense Against Foolish AntiBIOlogical Proposals of Human Society Commercialized to the Core”, 2004, 64 pages;
   6) “BIOphilosophy of the Individual, the principles of science and art of The Computerized Global Humanitarian BIOcultural Genetic public health, Part 6: BIOcultural Genetic Public Health—it is Healthcare Based on the BIOculture of an Individual and His Trust in The Creator”, 2004, 64 pages;
   7) “BIOphilosophy of the Individual, the principles of science and art of The Computerized Global Humanitarian BIOcultural Genetic public health, Part 7: Internet Oasis Club: the principles of science and art of The Computerized Global Humanitarian BIOcultural Genetic public health”, 2004, 256 pages.
   All these publications were written by Valery Leonov, Tatjana Malish (Leonova), and Pavel Leonov in Russian and issued in the authors' publishing house BIOcult, Saint-Petersburg, Russia.
OUR FIFTH STEP in working out means and method of involving an individual to the Natural Hygienic life-style and to the Computerized Global Humanitarian BIOcultural Genetic Public Health science as a whole, as a solution of “Social Problem of Natural Hygiene and the Individual” now living in modern, commercialized to the core, human world—this step is dedicated to the methodical, methodological, technological and technical side of the affair within the frame of given Patent claim, in the frames of: 1) the science and art of the Computerized Global Humanitarian BIOcultural Genetic Public Health (Health without medical “Health Service”); and 2) microprocessor devices aiding the same; and 3) technological method of producing the devices in the part of preparation theirs internal informative stuffing; and 4) the specialized “Computerized Global Humanitarian BIOcultural Genetic Public Health” Internet-site system as the technical means specially intended for realization of this said technological method.

The American Hygienists, experts in the American Natural Hygienic System, were elucidating for two centuries the simplest truth to understand. The man's health is being determined by the way of life he has and by the way he nourishes, or, more exactly, how he meets the living Nature's requirements. The American Hygienists call the people to return back to the Living Nature on these two ways. But it is impossible to the usual people to make that, without understanding the Life philosophy as such (BIOphilosophy), its principles, for basing only upon them; one can elaborate an adequate philosophy of the own life and the own nutrition.

What do we, the people, have?—We have only the life. Our proposed BIOcultural microcomputers and microprocessor toys are to remind, what does shorten and depreciate our life. The BIOcultural microcomputers and microprocessor toys—these BIOenlightening microprocessor tools, autonomic and build-in, for instance, into cellular phones and personal computers, by auto-text or other audiovisual means, in playing or serious form, are to remind several times a day, on our private life as a constituent of the global Life, single and exclusive on the Globe and in our organism, unsubmissible to us, existing beyond and independently of our consciousness—that is, on its turn, to remind on the existence of the Creator of Life and of us. Through the BIOenlightening and BIOculture, through the fundamentals of Biology, Physiology and molecular Genetics—up to the natural recovery, to the spiritual revival—that is the urgent way for each individual now living under in modern commercialized to the core human community.

Namely, from the self-education (“BIOenlightening”, “BIOculture”) in the fundamentals of biology, including physiology and genetics, the individual is to start for quicker refusal of broadly spread lifestyle position: “Do as all do!” “Eat as all eat!”, “Take cure as all take!”, briefly, in other words, “Take your spot in a herd!”, in herd being operated comfortably and profitably by means of diverse fashion styles used en masse, cultivated by TV-PR lads on previously fertilized soil of our common human stupidity-recklessness and pride-arrogance, typical in youth to all of us and to some aged ones, too.

Otherwise: from this self-education (“BIOenlightening”, “BIOculture”) in fundamentals of biology including physiology and genetics, individual is to start for quicker refusal of being an easy object for manipulation of highly qualified PR psychologists, to protect ourselves of psychological pressure for the defense of our own philosophy of living: how to live to harmony with the requirements of the Creator (or the Nature, or the God), how to feed yourselves, how to support our vigorous health or to recover it due to our BIO-ignorance—being now an attribute of everyone who prefers to nourish, to live and to be cured with no attention to the simplest truths of biology and genetics. This task is absolutely backbreaking to any of us while acting separately.

This task is backbreaking, if an individual has to look for these biological, physiological and genetic knowledges in the corresponding thick textbooks and scientific monographs, too few people are inclined to study that, even for the sake of their own health, so this problem is to be accepted and solved by technical and technological means. This task will be solved for anyone, if, instead of thick books, he will be supplied with the BIOcultural microcomputers and microprocessor toys for simple, playing, easy-to-understand self-enlightening of an individual in fundamental of biology, including physiology and genetics, which being proper and announced by the given Patent claim.—This is our brief summary of the given Invention.

### DETAILED DESCRIPTION OF THE PREFERRED EMBODIMENT

We have to stress once again: all the previously given information, as the basic one, is applied, in any part of it, as an internal informative stuffing of our proposed microprocessor devices. The very production of our proposed microprocessor devices is impossible without their informative stuffing being an undivided constituent of their production and especially an inseparable part of their posterior modernization in a coming span of time and with appearance of new fact and concepts in the biology including physiology and molecular genetics. The ability of taking this important circumstance into an account for the production and modernization of our proposed devices, especially with the concrete technical equipment specially tailored for the realization of this technological method—we are referring it all to preferred embodiment of the given Invention.

All the previously given information is used, in any of its parts as a basis for the internal informative stuffing of the microprocessor devices proposed to be patented but this is the information the authors of the given invention managed to collect and elaborate mentally. Therefore the authors of the given invention were looking for the concrete technological method and the concrete technical means for realization of the method. We the authors have found that, and these two innovations we did unite into a some entity into ours, proposed to be patented, biocultural microcomputers and microprocessor toys for simple, playing, easy-to-understand self-enlightening of an individual in the fundaments of biology, physiology and genetics. The preferred embodiment of the given invention proposed by us, in its undivided entity, embraces: 1) the enlightening microprocessor devices of special assignment; 2) the technological method of producing the devices in the preparing of their internal informative stuffing; 3) the technical means specially intended for the realization of this method.

Further, we shall characterize briefly these constituents of the given invention.

The basic requirement is the following:

1. An apparatus for simple, plain, easy-to-understand self-enlightening of an user in fundaments of biology, physiology and genetics, said apparatus comprising:
(a) memory means for storing information regarding:
   (i) a biological knowledge database;
   (ii) an algorithm permitting the user to receive the biological knowledge in an easy, playing manner and then inducing the user to live more conformable by further self-enlightening in the educational subject “BIOculture of the Individual” and by the gradual stimulation of the user to the “BIOcultural Way of Thinking”; and
(b) executive means for performance of the algorithm.

The biological knowledge database includes the any part of information given in Description of the given invention; this information is given as an illustration for the contents of biological database and for the aim of BIOcultural microcomputers and microprocessor toys. This basic apparatus and the later ones are produced with the following technological method and technical means intended specially for realization of the method.

This technological method of producing devices in the part of preparing of their internal information stuffing is attained by following steps:
(a) usage of the available information from the “Computerized Global Humanitarian BIOcultural Genetic Health” principles as an internal informative stuffing of any demanded apparatus at its production;
(b) enrichment and modernization of this information in its principles in a course of time;
(c) development and improvement of these principles by means of the specialized “Computerized Global Humanitarian BIOcultural Genetic Public Health” Internet-site system as a technical means intended specially for realization of the technological method;
(d) creation of new models and improvement of the old models of any claimed apparatus during their production based on more complete and more perfect information from the “Computerized Global Humanitarian BIOcultural Genetic Public Health” principles, being a result of the lower enumerated steps;
(e) publishing of the “Computerized Global Humanitarian BIOcultural Genetic Public Health” principles confirmed by the Editorial board of the Internet-site on its pages to make the principles attainable to anyone user of the Internet;
(f) offering to the visitor the Internet-site,—wishing to use the “Computerized Global Humanitarian BIOcultural Genetic Public Health” principles for support and recovery of health and having got some individual experience of usage of the principles,—to set questions and to express the requests to professional biologists physiologists and geneticists;
(g) publishing of questions and requests of users on the pages of the Internet-site for making these questions and requests attainable for any indicated specialist having an Internet access;
(h) offering to professional biologists, physiologists or geneticists, wishing to answer questions and requests, to formulate and to sent the reply on the Internet-site in the form of the next “Computerized Global Humanitarian BIOcultural Genetic Public Health” principle and necessary authorized comments to it;
(i) analyzing of the replies obtained by the Editorial board of the Internet-site; afterwards the replies worth some peculiar attention are to be additionally reviewed as it is practiced in the academic journals: with the assistance of so called “black opponents” from permanent authors having in the not less than three own publications “Computerized Global Humanitarian BIOcultural Genetic Public Health” Internet-site;
(j) making the final decision, by Editorial Board of the Internet-site, to publish the given reply on Internet-Site pages as a new “Computerized Global Humanitarian BIOcultural Genetic Public Health” principle or not; and
(k) usage of so obtained information for re-formulation of “Computerized Global Humanitarian BIOcultural Genetic Public Health” principles as an internal informative stuffing of any claimed device in its production and further modernization in proper time—thus, with growth and accumulation of this information, and through it, the science and technical art of Computerized Global Humanitarian BIOcultural Genetic Public Health (Health without medical “Health Service”) will be developing and perfection will be reached in the production of any claimed apparatus in preparation of its internal informative stuffing.

The technical means intended for the realization of this technological method are the Internet-site system including:
(a) a computer having a memory;
(b) a database in the memory for storage of information on the “Computerized Global Humanitarian BIOcultural Genetic Public Health” principles;
(c) an application program, realizing an algorithm for supporting of the “Computerized Global Humanitarian BIOcultural Genetic Public Health” principles to provide:
   (i) publishing of the “Computerized Global Humanitarian BIOcultural Genetic Public Health” principles, approved by Editorial board of the Internet-site, for making the principles accessible to any person having an Internet access;
   (ii) offering to the visitors of Internet-site wishing to use the “Computerized Global Humanitarian BIOcultural Genetic Public Health” principles for the support and recovery of a health and (for those having some individual experience of the principles) an application to set questions and express requests to the professional biologists, physiologists and geneticists;
   (iii) publishing of users' wishes and requests on the Internet-site to make these matters attainable to any specialist having Internet access;
   (iv) offering to the biologists, physiologists and geneticists wishing to reply, to formulate and send replies to the Internet-site in a form of the Computerized Global Humanitarian BIOcultural Genetic Public Health principle and the authorized comments to them; and
   (v) receiving and registration of replies in the Internet-site.

So we see the preferred embodiment of the given invention in the undivided entity: 1) the enlightening microprocessor device; 2) the technological method of devices' producing in the part of preparation of the internal information stuffing; 3) the technical means intended for realization of the technological methods.

After a brief characteristic of three constituents of the given invention we shall it claims. Preliminary comment: claims 11, 12, 13, 14, and 15 in the given Patent Application are repeating claims 1, 2, 3, 4, and 5 in the U.S. Patent Application Publication No.: US 2003-0023147-A1 (LEONOV et al.), Publication Date: Jan. 30, 2003. The difference in these claims is laid only in the expanding of the internal informative stuffing of devices claimed within the frame of broadened account of the given patent application.

### Claim 1

An apparatus for simple, plain, easy-to-understand self-enlightening of an user in fundamentals of biology, physiology and genetics, said apparatus comprising:
(a) memory means for storing information regarding:
   (i) a biological knowledge database;
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.
The additional explanations to claim 1 concerning the biological knowledge database:

The biological knowledge here explains, to the user of device, the meaning of three most important concepts, such as: “Life”, “Organism”, “Health”. Life as such—is a natural phenomenon on the Globe which looks like a living organism: from simple microbe and virus to highly organized and extra-complicated human organisms, as we have. That means: organism as such is a form of Life's existence, without the organisms' activity there is no Life, the activity of any organism is a manifestation of the Life within. Hence it follows: the Health as such—is a correct, normal activity of an organism, it is an internal and inalienable attribute of Life, as Life on the Earth with no Health would cease just after having originated.

Further, the Life—is a natural phenomenon on the Globe and within our organism, and therefore, at the birth, each of us is rewarded with it by the Nature, firstly by individual adherence to the Life as a natural phenomenon, secondly, with the own organism as an extra-complicated device for the realization of the phenomenon of Life, thirdly, at the moment of birth each of us is rewarded with the Health as correct normal activity of organism as an inalienable attribute of life, as certain restricted physiological resource for the support and reconstruction of normal activity of organism; and this physiological resource, being counted upon approximately 100 years of the proper normal activity of organism, is being only spent by us after the birth either reasonably (taking the knowledge on the Life as such into account) or unreasonably (not doing so).

Further, the Life is an objective reality existing beyond and independently of human consciousness, Life creation is out of Human competence. The human organism as an extra complicated device for life realization within—it is also an objective reality existing beyond human consciousness, the creation of a human organism is out of Human competence. Analogically, the Health, as a physiological resource, is for organism an objective reality, also existing beyond human consciousness, and creation of this resource of Health lays principally out of Human competence.

All aforementioned is to be understood so: the Man is able to worsen the activity of any living organism and even to interrupt the Life within it, but to improve this very activity of living organism, to improve Nature's abilities—that is not given to Man and that is out of Man's competence. Here is rather important conclusion for a consciousness: to the Man in general and in particular, only one mean is given completely attainable and absolutely free of charge but demanding brains; namely, not to interfere as much as possible into the activity of the own organism, that is, not to contradict as much as possible to the Nature's Laws and requirements, and to do it basing on the human knowledge on Life as such. Firstly, in the choice of genetically justified food—that food Nature is proposing us in garden or kitchen garden, in field but not the Commerce does in supermarkets and restaurants, secondly, in the choice of physiologically justified way of eating, which is dictated to our organism by the Nature but not the Commerce imposes to human consciousness, thirdly in choice of the genetically justified way of living—this one that Nature dictates genetically to our organism but not that Commerce imposes to human consciousness in its own interests.

Besides these three choices (food, way of eating, way of living), no thing for support of normal activity of organism is given and that is not demanded, all the other in the work of our organism, including natural foodstuffs for its nutrition, are out of Human competence, as human organism and mechanisms of life support are independent of human consciousness.

We repeat and emphasize in conclusion: the Man is able to worsen the activity of any living organism and even to interrupt the Life within it, but to improve this very activity of living organism, to improve Nature's abilities—that is not given to Man and that is out of Man's competence; the Man cannot compete with the Nature and no one separate part can substitute the whole entity. This approach to the support of normal activity of human organism was proclaimed by Hyppocrates 2400 years ago, “Do not harm!” or in more details, “Most frequently the best treatment no treatment!”, the latter denotes: “Living human organism has a remarkable power for self-healing and self-recovery from the Nature—namely, good physicians are to begin working with patients starting from that non-commercial free-of-charge treatment of Nature, but not from the commercial medicaments, alien to the human organism. Really, it seems impossible to ask somebody to live instead of you, to exploit your organism instead of you, or to spend your Health as a physiological resource for an alien organism. It is reasonable, however, that, if somebody would proclaims his desire to set somebody else all above mentioned to pay for it, at once a lot of volunteers would arrive to catch the money swimming directly to their hands, and so on.

### Claim 2

The apparatus according to claim 1, wherein:
(a) the memory means are destined also for storing information regarding:
   (i) a biological knowledge database for an illustration of that the “BIOcultural Way of Thinking” is a method, an intellectual instrument, a technique of conscience assisting to make the proper conclusions for an every man on the Earth disregarding his/her gender, age, occupancies, race and locality—firstly, WHAT to eat correctly, secondly, HOW to eat correctly, HOW to live correctly, HOW to support and recover the health correctly,—and all that is being done from the viewpoint of the biology, physiology and genetics;
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

### Claim 3

The apparatus according to claim 1, wherein:
(a) the memory means are destined also for storing information regarding:
   (i) a biological knowledge database to illustrate, for the user, two primary notions of educational subject entitled “BIOculture of the Individual”:
      “genetic (biological) life accomplished by the Nature in human organism independently beyond human consciousness”, and
      “social (economic) life, accomplished by man in human society on level of human consciousness”; and
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 3 on the biological knowledge database:

The biological knowledge may be diverse, for instance, following, entirely or partially. Any man being now in separable from human society has two various lives: 1) “genetic (biological) life” accomplished by the Nature in a human organism independently from human consciousness—here rules the Biology, or more exactly: Nature, Genes, Cells and very reasonable logical activity within the organism by aid of hormones, enzymes and other substances from biological vocabulary, and (2) “social (economic) life”, accomplished by a human in a human society on consciousness level,—here rules Economy or more precisely, Commerce, Money Corporations and their rather non reasonable and non logical activity with assistance of prestige, fashions, styles, salaries, prices, kindliness and evil, treachery and love et al. from the vocabulary of fiction. These two lives (biological and economic) and two sciences (biology and economy) are not completely interlinked in consciousness of an individual or of the whole society (may be contacting a bit in ecological matters).

And namely due to this reason (named as BIO-ignorance), two lives do coexist in a human consciousness nowadays: 1) “Life in his own organism” uninteresting for ordinary man, invisible for him; he has heard few about it and therefore he cares too small, having forgotten that namely this Life, with a capital letter, is linked with health and happiness of man and 2) “life of the man in human society” visible to him; he is the greatest expert in it and not worrying about it from youth till old age, from dawn till dusk forgetting that life of a small letter has no relationship to the activity of genes and cells, but they are genes and cells (not money and prestige) who create health and happiness of man. Nowadays, it is common everywhere that anybody even doesn't guess on realization of biological life in a human organism (created under genes' management) on requirements of biological life in organism (health is impossible with no satisfaction of the requirements); common one does not guess on the matter as he grows accustomed for good by PR specialists (that is, by the Commerce and highly qualified psychologists of Commercial advertisement) to take care only on own life in society (on those fashions, styles, prestige, good wages and prices et al. from vocabulary of fiction), not keeping in his mind, that in the basement of life in society are money, but not genes as fundamentals of Life as such and Health as an obligatory attribute of life in any living organism.

Explanatory additions to the algorithm in claim 3 on the algorithm:

The algorithm may be various with the aim to permit the user, in an easy playing manner, to cognize essence of real Life—the only one on the Earth and in the user's organism, that is, to understand biological, physiological and genetic essence of Life as BIO, as a natural phenomenon in any living being and, later on, gradually, to induce the user to live more comfortably by self-enlightening in the educational subject “BIOculture of the Individual” and bit by bit directing him to his own “BIOcultural Way of Thinking”.

### Claim 4

The apparatus according to claim 1, wherein:
(a) the memory means are destined also for storing information regarding:
   (i) a biological knowledge database to illustrate, for the user, the substantive difference of two important notions of educational subject entitled “BIOculture of the Individual”:
      “the natural (genetic) foods produced by Nature beyond and independently of human consciousness—natural foods we get from gardens and kitchen gardens—about 200 names in number at all”, and
      “the commercialized foods fostered by manufacturers of foodless foods for the sake of commerce, that is, being prepared by man on the level of commercialized human consciousness; we have not less than 40000 positions (trade marks) of these commercialized food in shops and restaurants”; and
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 4 on the biological knowledge database:

The biological knowledge may be diverse, for instance, following, entirely or partially. “The natural (genetic) foods produced by Nature beyond and independent of human consciousness” and “the commercialized foods fostered by the manufacturers of foodless foods for the sake of commerce, that is being prepared by man on the level of commercialized human consciousness”—these two types of foods (from Nature and Commerce's hands) are completely mutually incompatible now, as the sciences of biology and economy are not compatible, but this annoyance is not properly taken into consideration by either an individual mind or whole society's intellect. Owing to this cause (let us call it BIOignorance) an usual man does not guess about the genetic restriction of his own organism directly towards natural food got from garden and kitchen garden as he seems to be forever accustomed by PR specialists (that is by the Commerce and highly qualified physiologists of commercial advertisement) to be fed only with commercialized foods, having forgot that the base of these foods is in money but not in genes as such laying in biological base of natural foods and biological support of life in a human organism. Actually: the genetic code is single for all vegetable and animal organisms on the Globe including human organism and those plants prescribed by the Nature for human food, food operated completely by those genes whose secret would be discovered in millennia.

Explanatory additions to claim 4 algorithm:

The algorithm can be anyone, permitting the user, in easy playing manner:
1) to cognize biological, physiological and genetic connection of human organism, operated by genes with natural genetic foods of nearly 200 names, and
2) in the same time, to cognize, understand and to keep in mind social, economic and commercial link of the man now existing in commercialized human society, with so-called commercialized foods having non less than 40 000 positions (or trade marks), and later on, gradually, stimulating the user to live more comfortably by further self-enlightening in the educational subject “BIOculture of the Individual” and by gradual turning him to his own “BIOcultural Way of Thinking”.

### Claim 5

The apparatus according to claim 1, wherein:
(a) the memory means are destined also for storing information regarding:
   (i) a biological knowledge database for user's instructing in the substantial difference between two the most important notions of educational subject entitled “BIOculture of the Individual”:
      “water is the human drink No.: 1, made by Nature out of and independently of human consciousness”, and
      “the commercialized drinks are fostered by the manufactures of foodless food for commercial purposes, that is, prepared by men in human society on the level of modern commercialized consciousness”; and
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 5 on the biological knowledge database:

The biological knowledge may be diverse, for instance, following, entirely or partially. “Water as the human drink #1″—drink made by the Nature beyond and independently of human consciousness, we see this drink in springs and brooks and only one name it has—water (H₂O). The commercialized drinks—are fostered by the manufacturers of foodless foods for commercial purposes, that is, made by men in human society on the level of modern commercialized human consciousness, we see these drinks in shops and restaurants, they have nearly 100 positions (trade marks). That human organism genetically tailored to water (H₂O) as human drink #1; a common individual doesn't guess as he was accustomed probably forever by PR specialists (that is, by the Commerce and highly qualified psychologists of commercial advertisement) to quench thirst only by commercialized drinks, having forgotten that these drinks are based on money but not the genes ruling human organisms which secret would be discovered in millennia.

Explanatory additions to claim 5 algorithm:

The algorithm can be any giving the user in easy playing manner:
1) to cognize the basic biological, physiological and genetic connection of human organism, operated by genes with water (H₂O)— the only natural (genetic) drink for any living being,
2) to cognize, understand and consider the social, economic, commercial connections of a man within commercialized society with so-called commercialized drinks (almost 100 types), and then gradually to induce the user for more comfortable life by further self-enlightening in the educational subject “BIOculture of the Individual” and, step by step, directing him to his own “BIOcultural Way of Thinking”.

### Claim 6

The apparatus according to claim 1, wherein:
(a) the memory means are destined also for storing information regarding:
   (i) a biological knowledge database for user's instructing in the substantial difference between two the most important notions of educational subject entitled “BIOculture of the Individual”:
      “organization of biological Life in human organism”—this organization is accomplished by the Nature out of human consciousness, and
      “organization of social life of man within society”—this organization is accomplished by the Economy, that is accomplished in accordance to laws and demands of economic, commercial and financial character; and
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 6 on the biological knowledge database:

The biological knowledge may be diverse, for instance, following, entirely or partially. The “Organization of biological life in human organism”—is accomplished by the Nature out of human consciousness, and it is made in strict correspondence with laws and requirements of the Nature (the Life Creator in general and human organism in particular). “Organization of social life of man within society”—is accomplished by the Economy, that is, in accordance with laws and requirements of economic, commercial and financial character, with that ordinary man chooses the way of life in conformity with customs, traditions, fashion and various styles, being imposed to our consciousness by PR specialists, that is by Commerce and its publicity elaborated by highly qualified psychologists without biologists' participation. Those two types of life organization (by Nature in organism and Economy in society) are almost mutually incompatible, as these sciences are mutually incompatible but this situation is not taken into an account by individual mentality or by the society as a whole. For this reason (its name is BIOignorance) an ordinary man does not guess that, in the choice of way of life, he has to direct all his mental and financial means on security of biological life in his organism, as the present entirely existing life and it is dependent completely on genes, their forces and means but not on commercial forces and means (it is difficult to live with a lack of money, but living without genes and satisfaction of their demands is simply impossible). But an ordinary man nowadays is not accustomed to “BIOcultural Way of Thinking” due to the passive behavior of biologists in enlightening. To-day common people are used to support their own life in society on the ground of prestige, fashions, styles and other attributes of social life imposed to human consciousness by the Commerce for elaboration of false demands and preferences. An ordinary man forgets usually, that the base of social life support is provided by money, but not genes, and without their demands' satisfaction no Life as such exists.

Explanatory additions to claim 6 algorithm:

The algorithm can be diverse, permitting the user in easy playing manner:
1) to cognize basic biological, physiological and genetic essence of “Life organization in genes operated human organism”, and
2) to realize, understand and take into consideration simultaneously the social, economic, commercial essence of “life organization in human society guided by money”.

Unfortunately, these two essences (biological and economical), these two organizations (biological and economical), these two lives (biological and economical) are not obligatory connected in consciousness of individuals or in consciousness of the whole human society—nowadays besides ecology there is not entire and ample science reasonably embracing economy and biology. Therefore, the corporate financial interests are crushing biological (genetic) interests of people, including shareholders and workers of corporations. That algorithm permits the user in easy, playing manner to induce the user to more comfortable life by further self-enlightening in education subject “BIOculture of the Individual” and bit by bit directing to “BIOcultural Way of Thinking”.

### Claim 7

The apparatus according to claim 1, wherein:
(a) the memory means are destined also for storing information regarding:
   (i) a biological knowledge database to illustration, for the user, of the principle of mutual complementarity and non-discrepancy of biology and religion;
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 7 on the biological knowledge database:

The biological knowledge may be diverse, for instance, following, entirely or partially. From the biological point of view: firstly, the Man is a living being, possessing a gift of thinking and speech, an intellectual leader of living matter development, leader of Life development he had become two million years ago, and during 10000 years he is a master of all living on the Globe—this is an opinion of biologists; secondly, the Life is a distinct form of existence and movement of the matter accomplished in existence and activity of organisms including human—this is an opinion of physicists; thirdly, the matter is objective reality existing beyond and independently of human consciousness—this is an opinion of philosophers.—These three circumstances, considered together, make the humanity to speak on a Man, on his activity and his way of life, on his physical and spiritual (moral) Health from the scientific (from the position of cognized) and from religious (from the position of non-cognized). Otherwise, the scientific culture as a fundamental heritage of mental (intellectual) human activity and the spiritual culture as a fundamental moral religious heritage of humanity are coexisting together during the man's existence, they don't complete but complement one another. The spiritual heritage has a function of orientation in all the human activity. The reliability of this spiritual (moral) mark and its correctness in comparison to scientific ones had been checked repeatedly in centuries.

Explanatory additions to claim 7 algorithm:

The algorithm can be anyone permitting the user in easy, playing manner:
1) to comprehend the “biological, genetic essence of Life as such”,
2) simultaneously as well to comprehend, understand and consider the “religious, spiritual, moral essence of life as such”.

Otherwise, the algorithm permits the user, in easy, playing manner, firstly, realize that laws-demands of Life Creator on the Globe and Life in human organism were formulated by wise representatives of humanity not only in scientific books but in religious ones also, and, secondly, to realize that ignorance of the Creator's laws-demands seems to be unwise at any rate, and it does not matter where they have been formulated by humanity in the Bible and the Koran or in biology and physiology.

### Claim 8

The apparatus according to claim 1, wherein:
(a) the memory means are destined also for storing information regarding:
   (i) a biological knowledge database to illustrate, for the user, the biological essence, naturalness and inevitability of starting globalization of organizing of human society as a whole—these processes of capital globalization and integration of people and countries are natural and inescapable in its biological essence;
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 8 on the biological knowledge database:

The biological knowledge may be diverse, for instance, following, entirely or partially. From the biological point of view:
1) globalization of capital, globalization of economic interaction of people and countries, globalization of organization of all human community—these processes are quite natural and inevitable in the essence for the globalization is to unite the reason and intellect of the humanity increasing their might and useful practical realization, useful both for separate personalities and for separate countries and so being progressive and natural;
2) the globalization of the economic mechanisms is impossible without the merger or a fusion (or the common denominator) of the Western and Eastern civilizations, without the globalization of the spiritual heritage especially as of the Bible and Koran, with which the humanity is not parting for the next millennia and with which it will hardly part in the future;
3) the Western and Eastern civilizations are different; they are, however, unite because of the unity of the Man as such; that's why the way to the Globalization is opened here;
4) the Bible and the Koran are different, they are, however, unite because of the unity of the God as such; that's why the way to the Globalization is opened here, too;
5) the way of life and the very scale of spirituality of the Western and Eastern people are different, in particular in the area of spiritual culture, in the understanding of the woman's role in a basement of a family life, in the relation to an alcohol and so on; they, the Western and Eastern people, are, however, unite because of the unity of the human Health as such, for it is unite for the every human organism and for it depends on the human way of life, first of all; that's why the way to the Globalization is opened here, too.

And, moreover, all the processes of the economic and managerial globalization are to be initiated, reasonably, starting from the search of the reasonable common denominator of the spiritual cultures, that is: from the best or the logicalmost and reasonablemost of the Western and Eastern cultures. That means, the logicalmost and reasonablemost from the viewpoint of the Biology and Genes, not of Commerce and Money (first the Health, then the rest).—This is the miraculous motive for the Western and Eastern cultures to leave the announced pathway of force, bellicosity and deadlock, and to enter the perspective, reasonable and concordant pathway (first the Health and the Reason, then Commerce and Money, for it is hard to live with no money, but it is impossible to live with no health).

Explanatory additions to claim 8 algorithm:

The algorithm can by anyone, permitting the user in easy playing form
(1) to realize and cognize the basic biological, genetic essence of inevitable and useful processes of globalization and integration of nations and countries;
(2) to understand and to cognize that globalization and integration are reasonable to begin with the search of vitally important and logical (otherwise: BIOlogical) total denominator of spiritual cultures of East and West, otherwise the globalization would face with insurmountable obstacles;
(3) to realize and to cognize that biology and religion are talking about the same—on Life as such and the way of human life as well; the way of human life determines state of man's health;
(4) to understand and to realize that in spite the striking difference of the way of life of Westerners and Easterners, but the living is single, the sciences of biology and genetics are the same, only spiritual marks and valid attitude to spiritual heritage differ obviously;
(5) to comprehend and, mainly, realize what exactly way of living (Western or Eastern) is more rational from biology and genetics' viewpoint, what way of living is more preferable now for human organism—either in people of Eastern spiritual culture or in people of Western spiritual culture;
(6) to comprehended and realize that already advertised solution pathway of force and bellicosity seems to be a blind alley, while decision of the discussion in frames of biology, genetics and spiritual culture (that is in BIOculture frames) is long-term, worth-while in determination as each man by scientific definition is Homo sapiens (Man rational, reasonable being) whose place is at negotiations table but not at field of battle and blood.
That is what the said algorithm may permit the user to realize in easy playing manner: how to more comfortably for further self-enlightening in the educational subject “BIOculture of the Individual” and gradual turning to the “BIOcultural Way of Thinking”.

### Claim 9

The apparatus according to claim 1, wherein:
(a) the memory means are destined also for storing information regarding:
   (i) a biological knowledge database for illustration to the user the essence of “Biological Expediency”—urgency and topicality of this principle have increased repeatedly in connection with processes of globalization of capital and integration of nations and countries;
   (ii) an algorithm permitting the user to get the biological knowledge in an easy playing manner, and, later on, gradually, inducing the user to live more comfortably by his further self-enlightening in two closely-related subjects: “BIOculture of the Individual” and “the American Natural Hygienic System”, and by gradual, bit by bit, switching of the user to his own “BIOcultural Way of Thinking” and to his own the Natural Hygienic life-style and diet; and
(b) execution means for executing of the algorithm.

Explanatory additions to claim 9 concerning the biological knowledge database:

The biological knowledge may be diverse, for instance, following, entirely or partially. The knowledge reflects at least one of:
(1) the Health as such is an internal and inalienable attribute of Life as such, as without that attribute the Life would cease at once having just appeared;
(2) the Life on the Earth appears in a form of living organisms;
(3) as a consequence, the Health is a normal correct activity of organism;
(4) any organism at its appearance is supplied by internal mechanism of return to normal activity (recovery state), if normal activity was somehow disturbed (organism falls ill);
(5) all biological processes of life supply and vital activity of organism are inlaid into frames of three exchange processes: (*) process of metabolism of substances (renewal) as very first base of life supply and convalescence of organism particularly; (*) process of energy exchange (renewal) as energetic basis for realization of each and any biological process, (*) process of information exchange (renewal) as a basis of biological expediency of start of each and any biological process;
(6) this three exchange processes are indissoluble triad, that is, there is no main process among them—negation of one takes off the positive from two others.

Explanatory additions to claim 9 algorithm:

The algorithm here can be any, permitting the user in easy playing manner to understand at least one of:
(1) firstly, how much he would not consume the best meal, wanting proper realization of metabolism, no Health he would get if he would not work in the “sweat of the brow” (it is from the Bible) as in this case no energy exchange would take place optimally and consequently, no metabolism of substances can occur as Health basis;
(2) secondly, how much he would not consume the best meal wanting proper realization of metabolism, no Health he would get, if he would not grown up intellectually for optimal realization of information renewal, otherwise, it seems impossible to reach the biological expediency of processes' occurrence and of owner's existence, so optimal proceeding of metabolism as a primary base of support of the organism in a healthy state is impossible;
(3) third, to realize that the Creator has ordered our brains to use three mechanisms for health support and recovery of health: (*) optimal (from the Creator's viewpoint) of the choice of food, then (*) optimal (from the Creator's viewpoint) way of eating (respecting physiology of nutrition and digestion, or ignoring this knowledge), at last, (*) optimal (from the Creator's viewpoint) way of life;
(4) fourth, to understand that it is necessary to satisfy the Creator's requirements in any case, and it is not important where this requirements were given either in the Bible and the Koran or in biology and physiology—that is, for the support of the Health, a man needs both the scientific-biological base and the spiritual-moral-religious one;
(5) fifth, to realize that the processes of capital globalization and integration of nations and countries are pertinent to each of us, whether we want it or not.
(6) Therefore, each dweller of the Earth, using the principle of “Biological Expediency”, is to make proper (biological=bio+logical) estimation of typical way of life of Westerners and Easterners.
That is the given algorithm, permitting the user in easy playing form to induce to more comfortable life by further self-enlightening in two closely-related subjects: “BIOculture of the Individual” and “the American Natural Hygienic System”.

### Claim 10

The apparatus according to claim 1, wherein:
(a) the memory means are destined also for storing information regarding:
   (i) a biological knowledge database, wherein the fact is explained for the user that Western civilization destroys the humanity nowadays, when processes of globalization are proceeding, when specialists of PR (that is, the Commerce and highly qualified psychologists of the commercial advertisement) generate a powerful pressure on the consciousness of the Earth dwellers firstly by means of psychological pressure accustoming us to quench hunger by biologically senseless 40000 “commercialized foods” instead of 200 biologically reasonable “natural foods”; secondly, by psychological pressure, the PR specialists accustom us to satisfy thirst by hundreds of biologically senseless “commercialized drinks” based only on money but not by biologically reasonable drink H₂O, required by living cells of human body genetically; third, by psychological pressure training to organize our own eating by the means of biologically senseless “social commercialized way of eating” based on money, instead of “natural way of eating” based on genes; fourth, by psychological pressure accustoming us to organize support and recovery of Health by biologically unreasonable “social commercialized health service by drugstore means alien to human organism and its genes” being organized on money base but not on “natural genetic health service by constitutional capacities of organism to self-recovery—self-recovery” based on genes; fifth, by psychological pressure having accustomed us by imposing of various fashions, styles, prestige and so on, for biologically senseless “social commercialized way of life” based on money only, instead of genetically expedient “natural way of life” that denotes a life in harmony with the Nature and with the God—that is confirmed with scientific knowledge accumulated by humanity in manuals of biology and physiology and according to fundamental religious (spiritual, moral) knowledge of humanity stored in the Bible and the Koran; all above mentioned concerns everybody: businessmen and non-businessmen, producers of goods, services and their consumers, as the human organism is the same for all of us;
   (ii) an algorithm permitting the user to get the biological knowledge in an easy playing manner, and, later on, gradually, inducing the user to live more comfortably by his further self-enlightening in two closely-related subjects: “BIOculture of the Individual” and “the American Natural Hygienic System”, and by gradual, bit by bit, switching of the user to his own “BIOcultural Way of Thinking” and to his own the Natural Hygienic life-style and diet; and
(b) execution means for executing of the algorithm.

Explanatory additions to claim 10 concerning the biological knowledge database:

The biological knowledge may be diverse, for instance, following, entirely or partially.

In the subject of the Natural Hygiene and in the American Natural Hygienic System only three basic questions are key ones: firstly, the choice of food based upon biological norms; secondly, the choice of the way of eating based upon the digestive physiology; thirdly, the choice of way of living.

Now we are interested mostly in the third question; in the American Natural Hygienic System is written:
“‘Return to Nature’ in your eating habits. Forsake the commercialized and spoiled foods that are fostered by the manufacturers of foodless foods . . . “Manufacturing chemists, druggists, food manufacturers, etc., cannot compete with nature in preparing food for man . . . “Back to natural eating, should be our rallying cry. Are we such fools that we are going on forever removing from natural foods essential nutritive factors and then replacing them with ‘just as good’ synthetic substances? Shall we forever bow the neck to the yoke of commercialism and a false science created by this same commercialism? “I always suspect commercial motives in the physician . . . “Unfortunately the medical profession does not fail to identify its own best interests with the perpetuation and aggravation of our present disabilities. In accordance with its own financial interests it has neglected (and discouraged in all others) any effort to restore natural conditions . . . “With individuals as with society, we are all victims of false and vicious habits, customs, practices and doctrines and lack both the knowledge and the independence to live in ways that are right and good for us. We are slaves to fashions, folly and pride . . . “In the world as at present organized, which is an irreversible antihuman machine, no individual can obey these laws so as to have integral health—it is an impossibility. We tend towards health as far as we and others become aware of the evils that exist. But if my neighbor poisons the air with the fumes of tobacco, if he pollutes the water with the exhaust from his factory, if he radiates evil wherever he goes, he makes me suffer with him. There is a unity in the race that makes the crimes of one man rebound to the hurt of another. We cannot repudiate this unity any more than we can repudiate the unity of our own body. I cannot be healthy alone—I cannot be honest alone. In a society in which dishonesty is the fashion, as it is everywhere, though people do not understand it, dishonesty is forced upon all. The full Hygienic life must await that broader social revolution that will liberate man from age-old slaveries that bind him to social evils.”

So, that is the “Social Problem of Natural Hygiene and the Individual”, who is living now in extremely commercialized human society:
“With individuals as with society, we are all victims of false and vicious habits, customs, practices and doctrines and lack both the knowledge and the independence to live in ways that are right and good for us. We are slaves to fashions, folly and pride. In the world as at present organized, which is an irreversible antihuman machine, no individual can obey these laws so as to have integral health—it is an impossibility. In a society in which dishonesty is the fashion, as it is everywhere, though people do not understand it, dishonesty is forced upon all. The full Hygienic life must await that broader social revolution that will liberate man from age-old slaveries that bind him to social evils”.—
To realize and to cognize it is greatly useful for all of us.

But it is turned out that we likely have two different lives—primary and basic one: “biological Life of our organism”—here Nature, living cells, biology rule, all unfortunately uninteresting ones, and our second life we are only interested in, paying great attention to it spending all time and even all money,—it is “our social life within the frame of diverse fashions, styles, prestige, etc.”—here rule Commerce, money, economy, work, salary prices, intrigue, “deceit and love”, good and evil, “laugh and tears”, etc., et al., from our fiction and romantic life where we are the highest specialists, but as for primary biological life of our organism, we are simply ignorant. That's why we need BIOenlightening and individual BIOculture. We shall explain this passage in details.

So we are starting from the very beginning, namely: how did we reach this “biological Life”, where is our “origin of the origins”, how and when have we first seen the God's World?

Here is the “origin of the origins” for each baby.

In the body of mother of the future child, to continue of her genus, due to the Creator's Will, of the non-living molecules of foodstuffs, in the blood, the protoplasm of some living cell called ‘ovule’ had appeared by some miraculous way. (It happens specially to continue the genus!—we the sinful creatures are trying not to remember it while looking for the periodical sexual adventures in our “high life”, or while dealing with abortions and contraceptives willingly offered for reasonable payment by our Commerce, which is, in exchange for our money, eager to satisfy our every wish with no respect whether is it desired by the God or not; for the Commerce is an attribute of our banal “mind-reason” and of our “high life”, not of the Creator and of our “biological Life”.)

Analogically, in the body of the future father, of the non-living molecules of foodstuffs due to the Creator's Will, of the non-living molecules of foodstuffs, in the blood, the protoplasm of some living cell called ‘spermatozoon’, for continuation of his genus, had appeared by some miraculous way. (It happens specially to continue the genus!—we the sinful creatures are trying not to remember it while looking for the periodical sexual adventures in our “high life”, or while dealing with abortions and contraceptives willingly offered for reasonable payment by our Commerce, which is, in exchange for our money, eager to satisfy our every wish with no respect whether is it desired by the God or not; for the Commerce is an attribute of our banal “mind-reason” and of our “high life”, not of the Creator and of our “biological Life”.)

The father and mother of a future baby had come into a sexual contact searching for sensual sensation for stimulation of the genus extension. And, so, two living cells (spermatozoon and ovule) in the mother's body, in accordance with the Will and the means of the Creator, are being fused into a new single living cell named by biologists the zygote, the very first cell of a future human being.

In a nucleus of the zygote, the molecules of DNA and RNA are located, being a custodian of genetic data from parents to the future man. Further division of the zygote onto the daughter cells occurs with copying genetic information into their nuclei. During this self-division, under a genetic control, the cells are starting to specialize for a future activity. Specialized tissues are appearing, and the organs (e.g. heart, hepatics, brains, etc.) are self-organizing from them, later on uniting into systems of organs and at last an organism is born.

So all the events are mutually inseparable, indivisible, indissoluble, united and they all are linked with the Creator. Namely at the very moment of conception, the moment of the fusion of sperm and ovule of our parents and formation of the zygote, the first Living cell of our body and organism,—the Creator supplies each of us by the personal genetic program understood completely to the Creator only. It is arranged in every cell of body for the control of cellular life and for supply of whole organism, all the 5 trillions of the living cells, while the cell's dimensions are encountered in microns: such is the Creator's control upon us!

In this connection, a rather logical question is raised—for what purpose such a severe control of the Creator is permitted? Simple reply is—at the moment of our conception, at fusion of spermatozoon and ovule of our parents the Life Creator decides to make us full partners for prolongation of family genus of everyone and for continuation of Life on Earth. We in bustle of everyday life (especially in our numerous out of family sexual adventures) almost never think on this serious fact.

It turned out, that from the basic ideas of biology, each of us is being a full partner of the Creator on Life prolongation and development on our beloved planet Earth. That's why our Marriage is sacred to everybody! Our matrimonial Fidelity is sacred! The own Family for everybody—is sacred! The own children are sacred as well!

A deviation from the sacredness, we name is as a “sin”, is being tempting like a hop and too sweet, however, in spite of it, not everyone is alcoholic or drug addict. For everyone knows its own “limits” of “useful drinking” or “safe sinning” to be merry enough, for we know our hangover is a kind of punishment.

We realize clearly, especially from biological manuals, that the Creator is able to catch us sinning and to punish us by the means of Physiology—we thank biologists and physiologist for such a valuable information. It seems, that the era of BIOlogy and BIOeducation is coming to everyone's mind and conscience.

You may see it yourself on the following addition to abovementioned: an addition on sexual excesses widely cultivated by the Commerce under a slogan of “Freedom in love!” meaning love not connected with continuation of the genus but permitting the Commerce to supply us with great lot of superfluous goods and services. It is noteworthy: the freedom in love (it means freedom in copulation without any relationship to the continuation of family) between men and women is proclaimed and proclaimed by the Western culture causing the greatest malice in the Eastern culture where over-conjugal freedom is prevented strictly on religious level. The Eastern explicit spiritual culture rejects the permissiveness in Commerce, which is being permanently ready, for the sake of money and profits, to buy and sell everything including body, and soul, even the life, for the first slogan of Commerce is “money don't smell”.

Here is an example: diverse cosmetics, children including, various ornaments, “erotic and sex appeal” in female clothes, “erotic and sex appeal” on the stage and in various shows, “erotic and sex appeal” in million-copy issues with pornography to our kids; “intimate services by phone and at home”, “intimate services in specially adapted places”—we are paying for all it of our own pocket, not thinking of the necessity. For the continuation of the family and Mankind in accordance with the Creator's requirement ? For the sake of own house and the beloved pious rest within? For our own family and its happy life? For our own children? For our husband or our wife ? For the God's Commandment VII—“you shall not commit adultery”? (Exodus 20;14.) For the God's Commandment X—“you shall not covet your neighbor's wife”? (Exodus20; 17). No, it is for other sake. Briefly, for aimless. To enter “into society” for “society life”, “For amuse and merriments!”. “For business love affair”! Briefly for extramarital aimless, instinctive saturations, which were originally set by the Creator to stimulate the continuation of our genus.

For addition: a great lot of goods and services are ordered to Commerce for realization of those, including drugs, alcohol and cigarettes being paid by us without any idea whether we need them or not; as results those sexual and other excesses originate, being so harmful for family fidelity, for our own health, for bringing up children by our own example, etc.—in our haste we has no time to estimate it due to our, as we name, BIOignorance. The Medicine, as an obedient servant, is silent on the pernicious action of sexual excesses; moreover, it propose to us special pills and drugs for rising the sexual potential, in case then our organism is weak enough and resists the excesses in sex.

Hygienist, professionals of the American Natural Hygiene System, have enumerated typical widely distributed sources of body intoxication via dyspepsia within healthy gastrointestinal system and do refer sexual excesses to the beginning of list nearly after overeating, neurasthenia and bad foodstuffs combining (sexual excesses are fourth in the rating).

The matter is, that in all four cases, the digestive juices are discharged too slowly or too little and, secondly, as a sequence, the reception of splitting carbohydrates and proteins incompletely treated by these juices and receipted by mucous of intestine are decaying for almost 24 hours. It is clear, that sexual excesses demand higher productivity and spending of valuable proteins and enzymes and hormone of endocrine system regulating and operating all bioprocess of digestion—so dyspepsia originates in completely health, digestive system. To take toxins off the organism, great amounts of vitamins and minerals are spent from physiological resources intended for old age and we are curtailing the life itself and its quality.

We realize clearly, especially from biological manuals, that the Creator is able to catch us sinning and to punish us by the means of Physiology—we thank biologists and physiologist for such a valuable information. It seems, that the era of BIOlogy and BIOeducation is coming to everyone's mind and conscience. Now we repeat typical features of Western fashion: Diverse cosmetics, children including, various ornaments, “erotic and sex appeal” in female clothes, “erotic and sex appeal” on stage and various shows, “erotic and sex appeal” in million-copy issues with pornography to our kids; “intimate services by phone and at home”, “intimate services in specially adapted places”—all it is ordered by us to commerce under impact of Western culture all its is paid by us. For the sake of own house and the beloved pious rest within? For our own family and its happy life? For our own children? For our husband or our wife? May be for a quite different—for social life with amusements, intrigues, treachery? For the appearance in “high” society to satisfy own pride-vanity!

For addition: a great lot of goods and services are ordered to Commerce for realization of those, including drugs, alcohol and cigarettes being paid by us without any idea whether we need them or not; as results those sexual and other excesses originate, being so harmful for family fidelity, for our own health, for bringing up children by our own example, etc.—in our haste we has no time to estimate it due to our, as we name, BIOignorance.

And, remaining unseen for us, it occurs, what usually is called the “stupidation of the masses and pushing them down to the animal level”.

Thus, realities of everyday life force us to part with sensual (artistic-romantic) outlook of life and to pass to reasonable BIOlogic acceptance when everyone becomes a full partner of the Creator of the Life on its continuation and development on our beloved Earth. It is advisable to keep in mind: our Creator (Nature, God as you prefer) as the Author of genes and codified information wherein, is present invisibly in any living cell of our body—there are approximately 5 trillion cells and each operates under a severe control of the Creator as the Author of all genes on Earth and codified information. The genetic program being given by Creator to any of us personally is extremely clever and powerful in the support of our organism in a healthy state, for it is multi-million-year experience of the Creator of Life support in time of existence. Really, the genetic program is almighty and clever, if our food is natural (but not invented by us!), if our way of eating—is natural (but not invented by us!), if our way of life—is natural (satisfying the Creator!). It is clear, that in other conditions our genetic program is powerless as our the finest and the most powerful car is weak, if its “food”—does not suit, if it “manner of use”—is wrong, if the road is erroneous for that our finest car. Therefore, almost two centuries years ago a movement of the Natural Hygiene was born in the States, delivered later to the other continents—and among the Earth dwellers supporters of Natural Hygiene and American Natural Hygiene System have appeared, with a well-known motto: “Rescue of drowning ones is in hands (brains also!) of the drowning ones!”

Explanatory additions to claim 10 algorithm:

The algorithm can be anyone permitting the user, in an easy playing manner, to understand at least one: (1) firstly, to realize that our Creator ordered for support of available health and recovery of health three mechanisms: (*) optimal choice of food, later (*) optimal choice of the way of eating (paying attention to physiology of nutrition and digestion, or ignoring these scientific data), and at last (*) optimal choice of the way of life; (2) secondly, to understand the requirements of the Creator is necessary in spite of place of its explanation either in the Bible and the Koran or in biology and physiology, that is, for the Health support we need scientific-biological foundation and spiritual-moral-religious base; at last, (3) thirdly, to understand that the initiated processes of capital globalization and integration of nations will affect everyone, whether he wants or not, and that's why everybody guided by the “Biological expedience” principle is interested to make a BIO+logical evaluation of typical way of life for Westerners and Easterners to choose a more suitable way of life to oneself.—That is all, that the above-mentioned algorithm enables to clarify in easy playing manner for the user, how to live more comfortably by the further self-enlightening in closely related subjects: the “BIOculture of the Individual” and the “American Natural Hygienic System”.
So we are informed about the explanatory additions to claims 1-10 concerning the biological knowledge database and the algorithm.

We repeat the statement again: claims 11-15 in the given Patent claim are in fact repeating claims 1-5 in U.S. Patent Application Publication N: US-2003-0023147-A1 (LEONOV et al.), Publication Date: Jan. 30, 2003. Differences in these claims are in concentrated internal information filling of the claimed devices within the broadened description of that Patent claim.

### Claim 16

The apparatus according to claim 1, wherein:
(a) the memory means are destined also for storing information regarding:
   (i) a biological knowledge database for illustration of physiological principle “WHAT to eat—is important, but thrice more important is—HOW to eat, what is a way of eating”: to inform the user on qualities of digestive enzymes and enzymatic restrictions of digestion;
   (ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

Explanatory additions to claim 16 concerning the biological knowledge database:

The biological knowledge may be diverse, for instance, following, entirely or partially. Nature has left the discharge and extraction of the important digestive enzymes into esophagus for herself. But their abilities are strictly limited, that is enzymes are not almighty. Therefore, a digestion success depends considerably on a human mentality, on a manner of food taking. An obvious example to it: in case of seemingly “excellent” nutrition and normal healthy digestion, we, for some reason, feel well-known daily discomforts,—a flatulence, an abdominal distention (an accumulation of gas in the abdomen), a sense of discomfort running in to pain in the abdomen, gastric distress (“heartburn”), a foul and unpleasant odor from the stools and from the expelled gases(a reeking decomposition which begins in the stomach and continues in the intestine), a bad breath that grows out of gastro-enteric fermentation and putrefaction, acid (sour) eructation (belching), mucus flow, nervousness, sleepless and non-refreshing nights, furred tongue in the morning, an absence of desire for food, constipation, much foul gas, colitis, hemorrhoids, bleeding with stools from putrefaction occurring in the colon, much foul stools, loose stools, impacted stools, pebbly stools, etc.—All these are symptoms of bad digestion within healthy gastro-enteric tract and excellent food are timidly silenced, but they clearly testify to the processes of bacterial fermentation and putrefaction in badly digested and badly assimilated food. These processes are started by gastro-enteric microflora, if digestion was not intensive and prolonged, that is extraction of juices was short and not intensive, so in intestine badly digested and badly assimilated food mixture was remained, being unprotected by bactericidal properties of juices, therefore, it is taken by microflora into a fermentation and putrefaction processes, giving poisons' and toxins' influence upon the whole organism. As a result, we (for some reason!) feel ourselves bad. It stands to reason, that our organism, certainly, takes off the consequences of these processes, but by spending great physiological resources, accompanied by the worsening of quality of our life and shortening of its duration—this is one of general and common disasters of modern life. Only the “pathway of Natural Hygiene” can liquidate the problem—being thoroughly checked clinical and theoretical experience of the science Natural Hygiene on the American continent and detailed in the American Natural Hygienic System.—Here are the aspects, concerning biological knowledge, including some physiological recommendations of so-called “Nutrition of Homo sapiens” in the book of authors of the given Patent claim: “BIOculture of the Individual, and the Individual Natural Hygiene, and Enlightening Microcomputers & Microprocessor Toys Specially for the Same (Our Not Light Way to Health via BIOenlightenment)”. First four years the manuscript of the book was developed under working title: “Nutrition of Homo sapiens as a Way of Natural Hygiene”.

Explanatory additions to claim 16 algorithm:

The algorithm here is any, giving the user in easy, playing manner to understand at least one of: 1) digestive enzymes cannot optimally digest natural products after excessive efforts of cookery specialists, and when we ignore this circumstance we have no rights to blame the Nature on some unpleasant annoyances in our abdomen; 2) digestive enzymes can optimally recognize nearly 200 nutritive products, as we get them from the garden and kitchen garden,—this is a complete assortment of the Natural Table, but they can make mistakes, dealing with 40 000 products of Industrialized-Commercial Table (we see them in shops and restaurants) and when we ignore the circumstances, we are not to blame the Nature on some unpleasant annoyances in our abdomen; 3) enzymes digesting proteins can not operate in the same media with enzymes, digesting carbohydrates, but we are consuming starch-bearing potato or bread with protein-bearing meat or fish, that is, we frequently breach this or those rules of correct food combining, and we cannot blame the Nature for abdomen annoyances; 4) digestive enzymes cannot operate effectively, if their concentration in stomach is diluted by tea, coffee or other drinks—it is our invention and our way of eating; here as well no claims to Nature for abdomen annoyances are excepted; 5) to realize that digestive enzymes are discharged insufficiently, if we over eat; 6) to realize that digestive enzymes are discharged insufficiently, if we take seat at dinner table after intense fuss of working day, if we eat being unwell or at family quarrel; 7) or, if we are inclined to sexual excesses, spending our own physiological resources, given once at birth and expanding great amount of valuable material for proteins and hormones (digestive enzymes—are permanently spent protein molecules and their formation is possible only on occurrence of necessary materials). All the above mentioned facts and conclusions were thoroughly tested by clinical and theoretical experience of the Natural Hygiene in American continent and presented in the American Natural Hygienic System.—It is all, that the algorithm allows the user to understand in easy playing manner: how to live more comfortably, turning to the Natural Hygienic lifestyle and diet. To do this, the user may decide after enlightening in the educational subject “BIOculture of the Individual”—this is the application of the apparatus and the algorithm.

Below, as an illustration, detailed variants are given of claim 16 in the part of the biological knowledge referred to the principle “WHAT to eat—is important, but thrice more important is—HOW to eat, what is the way of eating”. Within below given illustrations, the biological base is done on information in our book “BIOculture of the Individual, and the Individual Natural Hygiene, and Enlightening Microcomputers & Microprocessor Toys Specially for the Same” (briefly: “BIOculture of the Individual . . . ”). Basing on properties of digestive enzymes and enzymatic restrictions of digestion, we give the substantiations to fourteen recommendations called “The Nutrition of Homo sapiens”, that is the nutrition justified biologically, physiologically and genetically. These are 14 recommendations from the book “BIOcuture of the Individual . . . ” and corresponding examples of detailed variants of the claim 16:
16.1. The apparatus according to claim 16, wherein the biological knowledge are taken from the chapters of the book “BIOculture of the Individual . . . ” with basements of “The Nutrition of Homo sapiens” given in the part of Recommendation N 1: “Move boldly to one- and-a-half-time nutrition (more exactly, return to what was accepted in Ancient Greece and in Middle Ages, three-time nutrition came from enriched England of XVIII^{th} century)”.
16.2. The apparatus according to claim 16, wherein the biological knowledge are taken from the chapters of the book “BIOculture of the Individual . . . ” with basements of “The Nutrition of Homo sapiens” given in the part of Recommendation N2: “During day time consume large salad from raw vegetables and fruits—not less than a soup plate in volume”.
16.3. The apparatus according to claim 16, wherein the biological knowledge are taken from the chapters of the book “BIOculture of the Individual . . . ” with basements of “The Nutrition of Homo sapiens” given in the part of Recommendation N3: “Thoroughly and no hastily masticate and knead the food in mouth”.
16.4. The apparatus according to claim 16, wherein the biological knowledge are taken from the chapters of the book “BIOculture of the Individual . . . ” with basements of “The Nutrition of Homo sapiens” given in the part of Recommendation N4: “Don't wash down meal by tea, coffee, juices and other drinks, soups are not the best meal”.
16.5. The apparatus according to claim 16, wherein the biological knowledge are taken from the chapters of the book “BIOculture of the Individual . . . ” with basements of “The Nutrition of Homo sapiens” given in the part of Recommendation N5: “Follow the rules of ‘Food Combining’, that is, escape, in a disposable food, accidental combinations of natural nutrition products”.
16.6. The apparatus according to claim 16, wherein the biological knowledge are taken from the chapters of the book “BIOculture of the Individual . . . ” with basements of “The Nutrition of Homo sapiens” given in the part of Recommendation N6: “It would be reasonably enough to raise responsibility for nutrition from requirements of our mouth on the level of living cell requirements, the ones completely legitimate as they are bringing to us by Its Majesty the Nature”.
16.7. The apparatus according to claim 16, wherein the biological knowledge are taken from the chapters of the book “BIOculture of the Individual . . . ” with basements of “The Nutrition of Homo sapiens” given in the part of Recommendation N7: “Our drink N1 —is the pure natural water”.
16.8. The apparatus according to claim 16, wherein the biological knowledge are taken from the chapters of the book “BIOculture of the Individual . . . ” with basements of “The Nutrition of Homo sapiens” given in the part of Recommendation N8: “It seems reasonable to restrict to minimum culinary treatment of natural nutritive products for the sake of prevention of harmful action upon extra-complex organic molecules of our natural food depriving any biological value for our health”.
16.9. The apparatus according to claim 16, wherein the biological knowledge are taken from the chapters of the book “BIOculture of the Individual . . . ” with basements of “The Nutrition of Homo sapiens” given in the part of Recommendation 9: “It is unreasonable to take seat at dinner table in depressed, tired, stress and painful state”.
16.10. The apparatus according to claim 16, wherein the biological knowledge are taken from the chapters of the book “BIOculture of the Individual . . . ” with basements of “The Nutrition of Homo sapiens” given in the part of Recommendation 10: “It is reasonable to direct in nutrition to the products from the Nature's Table and not to hide their natural appearance, odor and taste”.
16.11. The apparatus according to claim 16, wherein the biological knowledge are taken from the chapters of the book “BIOculture of the Individual . . . ” with basements of “The Nutrition of Homo sapiens” given in the part of Recommendation 11: “It is reasonable to refer our digestive tract to the environment, having taken full responsibility on unpleasant consequences occurring wherein as result of our unreasonable (on Nature's opinion!) actions in organization of own nutrition”.
16.12. The apparatus according to claim 16, wherein the biological knowledge are taken from the chapters of the book “BIOculture of the Individual . . . ” with basements of “The Nutrition of Homo sapiens” given in the part of Recommendation 12: “It is reasonable to accept the thesis: without support of clearness of discharge organs of the body, its optimal nutrition is impossible”.
16.13. The apparatus according to claim 16, wherein the biological knowledge are taken from the chapters of the book “BIOculture of the Individual . . . ” with basements of “The Nutrition of Homo sapiens” given in the part of Recommendation 13: “It is reasonable to us not only consume our food, but to get it in the ‘sweat of the brow’ as the God orders; from the positions of biology one can add: otherwise due to biological laws it is unable to give help to us and even more, it will obligatory bring diseases”.
16.14. The apparatus according to claim 16, wherein the biological knowledge are taken from the chapters of the book “BIOculture of the Individual . . . ” with basements of “The Nutrition of Homo sapiens” given in the part of Recommendation 14: “It seems reasonable to take into account, that intellectual food and spiritual one do not only complement material food, but add the expediency to it”.

An essence of Recommendation 14 is the next. The frequently used hyperboles “food for thought” and “spiritual food” are not really great exaggerations for “Homo sapiens” (Reasonable Man, Thinking Creature). Really we, being reasonable thinking creatures, are trying to understand by brains (that is, or otherwise, to “digest” in head) scientific knowledge of surrounding world (food for mentality). We, reasonable and thinking beings, are trying to confer (by essence, that is, to digest in heart) spiritual heredity of humanity (our spiritual food). Without the complex digestion we as Homo sapience, are unable to the decent realization of ourselves and we are becoming similar to our “junior brothers”. Everything seems to indicate, that: 1) proteins, carbohydrates et al. as a material food are being of necessity for corporal cells' work, 2) scientific knowledge as an intellectual food for brains, 3) fundamental spiritual heredity of humanity as a food for a soul,—these three kinds of our food, only in TRIAD-like unity, are able to provide our natural nutrition (nutrition of body+nutrition of mind+nutrition of spirit). We are simply obliged to treat more responsibly to food organization, than it is generally adopted. We name this forced approach to a nutrition “not only by bread”—the “Nutrition of Homo sapience”-“nutrition of reasonable man”, “rational man” in the sense, that, in organization of nutrition and health service, it is oriented not on gregarious feelings-instincts (do as all do), as our “junior brothers”, and deliberately bases on his own mind-reason, on available scientific BIOlogical knowledge, that is, follows the “Pathway of Natural Hygiene” having being proclaimed by progressive physicians even at start of XIX^{th} century and, in the middle of XX^{th} century, being generalized in the form of the American Natural Hygienic System and distributed over the Globe to assist technically to the future realization of our invention, demanded by given Patent claim.

1. An apparatus for simple, plain, easy-to-understand self-enlightening of an user in fundaments of biology, physiology and genetics, said apparatus comprising:
(a) memory means for storing information regarding:
(i) a biological knowledge database;
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

2. The apparatus according to claim 1, wherein:
(a) the memory means are destined also for storing information regarding:
(i) a biological knowledge database for an illustration of that the “BIOcultural Way of Thinking” is a method, an intellectual instrument, a technique of conscience assisting to make the proper conclusions for an every man on the Earth disregarding his/her gender, age, occupancies, race and locality—firstly, WHAT to eat correctly, secondly, HOW to eat correctly, HOW to live correctly, HOW to support and recover the health correctly,—and all that is being done from the viewpoint of the biology, physiology and genetics;
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

3. The apparatus according to claim 1, wherein:
(a) the memory means are destined also for storing information regarding:
(i) a biological knowledge database to illustrate, for the user, two primary notions of educational subject entitled “BIOculture of the Individual”:
“genetic (biological) Life accomplished by the Nature in a human organism independently beyond human consciousness”, and
“social (economic) life, accomplished by men in a human society on level of human consciousness”; and
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

4. The apparatus according to claim 1, wherein:
(a) the memory means are destined also for storing information regarding:
(i) a biological knowledge database to illustrate, for the user, the substantive difference of two important notions of educational subject entitled “BIOculture of the Individual”:
“the natural (genetic) foods produced by Nature beyond and independently of human consciousness—natural foods we get from gardens and kitchen gardens—about 200 names in number at all”, and
“the commercialized foods fostered by manufacturers of foodless foods for the sake of commerce, that is, being prepared by man on the level of commercialized human consciousness; we have not less than 40000 positions (trade marks) of these commercialized food in shops and restaurants”; and
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

5. The apparatus according to claim 1, wherein:
(i) a biological knowledge database for user's instructing in the substantial difference between two the most important notions of educational subject entitled “BIOculture of the Individual”:
“water is the human drink No.: 1, made by Nature out of and independently of human consciousness”, and
“the commercialized drinks are fostered by the manufactures of foodless food for commercial purposes, that is, prepared by men in human society on the level of modern commercialized consciousness”; and
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

6. The apparatus according to claim 1, wherein:
(a) the memory means are destined also for storing information regarding:
(i) a biological knowledge database for user's instructing in the substantial difference between two the most important notions of educational subject entitled “BIOculture of the Individual”:
“organization of biological Life in human organism”—this organization is accomplished by the Nature out of human consciousness, and
“organization of social life of man within society”—this organization is accomplished by the Economy, that is accomplished in accordance to laws and demands of economic, commercial and financial character;
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

7. The apparatus according to claim 1, wherein:
(a) the memory means are destined also for storing information regarding:
(i) a biological knowledge database to illustration, for the user, of the principle of mutual complementarity and non-discrepancy of biology and religion;
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

8. The apparatus according to claim 1, wherein:
(a) the memory means are destined also for storing information regarding:
(i) a biological knowledge database to illustrate, for the user, the biological essence, naturalness and inevitability of starting globalization of organizing of human society as a whole—these processes of capital globalization and integration of people and countries are natural and inescapable in its biological essence;
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

9. The apparatus according to claim 1, wherein:
(a) the memory means are destined also for storing information regarding:
(i) a biological knowledge database to illustrate, for the user, the essence of the “Biological Expediency”—urgency and topicality of this principle have risen repeatedly in connection with processes of globalization of capital and integration of nations and countries;
(ii) an algorithm permitting the user to get the biological knowledge in an easy playing manner, and, later on, gradually, inducing the user to live more comfortably by his further self-enlightening in two closely-related subjects: “BIOculture of the Individual” and “the American Natural Hygienic System”, and by gradual, bit by bit, switching of the user to his own “BIOcultural Way of Thinking” and to his own the Natural Hygienic life-style and diet; and
(b) execution means for executing of the algorithm.

10. The apparatus according to claim 1, wherein:
(a) the memory means are destined also for storing information regarding:
(i) a biological knowledge database, wherein the fact is explained for the user that Western civilization destroys the humanity nowadays, when processes of globalization are proceeding, when specialists of PR (that is, the Commerce and highly qualified psychologists of the commercial advertisement) generate a powerful pressure on the consciousness of the Earth dwellers firstly by means of psychological pressure accustoming us to quench hunger by biologically senseless 40000 “commercialized foods” instead of 200 biologically reasonable “natural foods”; secondly, by psychological pressure, the PR specialists accustom us to satisfy thirst by hundreds of biologically senseless “commercialized drinks” based only on money but not by biologically reasonable drink H₂O, required by living cells of human body genetically; third, by psychological pressure training to organize our own eating by the means of biologically senseless “social commercialized way of eating” based on money, instead of “natural way of eating” based on genes; fourth, by psychological pressure accustoming us to organize support and recovery of Health by biologically unreasonable “social commercialized health service by drugstore means alien to human organism and its genes” being organized on money base but not on “natural genetic health service by constitutional capacities of organism to self-recovery—self-recovery” based on genes; fifth, by psychological pressure having accustomed us by imposing of various fashions, styles, prestige and so on, for biologically senseless “social commercialized way of life” based on money only, instead of genetically expedient “natural way of life” that denotes a life in harmony with the Nature and with the God—that is confirmed with scientific knowledge accumulated by humanity in manuals of biology and physiology and according to fundamental religious (spiritual, moral) knowledge of humanity stored in the Bible and the Koran; all above mentioned concerns everybody: businessmen and non-businessmen, producers of goods, services and their consumers, as the human organism is the same for all of us;
(ii) an algorithm permitting the user to get the biological knowledge in an easy playing manner, and, later on, gradually, inducing the user to live more comfortably by his further self-enlightening in two closely-related subjects: “BIOculture of the Individual” and “the American Natural Hygienic System”, and by gradual, bit by bit, switching of the user to his own “BIOcultural Way of Thinking” and to his own the Natural Hygienic life-style and diet; and
(b) execution means for executing of the algorithm.

11. The apparatus according to claim 1, the apparatus as “the BIOcultural microprocessor toy for the American Natural Hygienic system”, wherein:
(a) the memory means are destined also for storing information regarding:
(i) a biological knowledge database for preliminary self-enlightening of the user in the educational subject “Natural Hygiene and the American Natural Hygienic system” and for subsequent simple, plain, easy-to-understand using of the American Natural Hygienic system to preserve own good health or to restore health in a state of disease without the assistance of some medical professionals, without the employment of some drugs (chemotherapy) or other medical means and resources, without of some the effect of something foreign to the human body, but only by internal resources of the body and the healing power that resides in the body and is one of the cardinal functions of the living organism, in other words, only by the processes of self-healing and self-restoration, biological in character, that occur in the body and belong to the organism;
(ii) an algorithm permitting the user to get the biological knowledge in an easy playing manner, and, later on, gradually, inducing the user to live more comfortably by his further self-enlightening in two closely-related subjects: “BIOculture of the Individual” and “the American Natural Hygienic System”, and by gradual, bit by bit, switching of the user to his own “BIOcultural Way of Thinking” and to his own the Natural Hygienic life-style and diet; and
(b) execution means for executing of the algorithm.

12. The apparatus according to claim 1 for general microcomputerization of the American Natural Hygienic system at whole, the apparatus as “the BIOcultural microprocessor guide for the American Natural Hygienic system at whole”, wherein:
(a) the memory means are destined also for storing information regarding:
(i) a guidelines database of the American Natural Hygienic system relatively at least one of:
how the user can take the Natural Hygienic effect by the choice of food based upon biological and physiological norms which take into account that the value of the food to the user is partly determined by its digestibility and by the user's present nutritive needs and powers of digestion and assimilation and utilization of the food at the time, because the user have not the same digestive abilities under the varying circumstances of life, health, ill health, or emotional stress, and also the norms take into account that only the foods produced Mother Nature—natural foods, fresh foods, green foods, whole, unprocessed foods, unrefined foods, foods that have not lost their substances nor had their values deteriorated by heating, drying, cooking, canning, and refining processes—only these Nature's foods are full of the elements of superior nutrition and proper nourishing the user,
how the user can take the Natural Hygienic effect by the choice of way of food combining at the single meal which takes into account that the changes through which foods go in the processes of digestion are effected by enzymes and the conditions under which these enzymes can act are sharply defined, it becomes necessary to heed the rules of correct food combining that have been carefully worked out on a basis of the chemistry of digestion,
how the user can take the Natural Hygienic effect by the choice of way of eating which takes into account that there are certain physiological limitations of the digestive glands and of the digestive enzymes and juices, that it should be considered in planning a meal for either the well or the sick, in planning food combinations at the single meal, etc., that it is important to respect this digestive limitations for better nutrition and proper nourishing the user, and
how the user can take the Natural Hygienic effect by the choice of way of living, which must supply all the requisites of physiology, such as fresh air, rest, sleep, sunshine, exercise, emotional poise, etc.;
(ii) an algorithm which makes at list one of said choices simple, plain, easy-to-understand for the user;
(iii) an algorithm for pursuing by the user at least one of four legitimate objectives of remedial care of the sick:
the removal of the biological and physiological cause or causes of sickness, but not medical symptoms of this sickness,
the conservation and hoarding of the powers of life,
promotion of elimination of toxic accumulations within the organism, and
the proper supply of the physiological needs of the organism; and
(b) execution means for executing of said algorithms.

13. The apparatus according to claim 1, the apparatus as “the BIOcultural microcomputer for testing of digestive efficiency of food combinations at the single meal”, wherein:
(a) the memory means are destined also for storing information regarding:
(i) natural foods databases.
(ii) a database of food-combining guidelines, and
(iii) an algorithm for:
selecting by the user a combination of foods from among those in all foods databases in the memory in order to produce a mark characterizing digestive efficiency of the food combination,
producing the mark for the food combination selected by the user for testing its digestive efficiency, and
presenting the mark for the food combination to the user; and
(b) execution means for executing of the algorithm.

14. The apparatus according to claim 13, the apparatus as “the BIOcultural microcomputer for testing of digestive efficiency of way of eating at whole”, wherein:
(a) the memory means are destined also for storing information regarding:
(i) a database of eating guidelines at least one of:
Eat your food in proper combinations: Never eat carbohydrate foods and acid foods at the same meal, Never eat a concentrated protein and a concentrated carbohydrate at the same meal, Never consume two concentrated proteins at the same meal, Do not consume fats with proteins, etc.,
Eat only when hungry, Always eat moderately,
Never eat when in pain, mental and physical discomfort, or when feverish, Never eat during or immediately before or after work or heavy mental and physical effort,
Do not drink with meals,
Thoroughly masticate and insalivate all food, etc., and
(ii) an extended algorithm, which further is destined also for:
selecting by the user an eating manner on the basis of all eating guidelines in the memory in order to produce a mark characterizing digestive efficiency of the eating manner,
producing the mark for the eating manner, and
presenting the mark for the eating manner to the user; and
(b) the execution means are destined also for executing of the extended algorithm.

15. The apparatus according to claim 14, the apparatus as “the BIOcultural microcomputer against abdominal discomforts and stomach distresses”, which is supplied with a feedback function—at the start of usage, the microcomputer will give recommendations on base of science inlaid in microcomputer memory, but later, of the second (the user's) experimental base to be accumulated, checking individual peculiarities of digestion, the user's way of eating and living, and current self-control of the user on his own estimations,
(a) wherein the memory means are destined also for storing information regarding a database of indigestion symptoms (“Catalogue of Symptoms of gastro-intestinal indigestion in healthy digestion system”) at least one of:
flatulence,
abdominal distention (the accumulation of gas in the abdomen),
a sense of discomfort running into pain in the abdomen,
gastric distress (“heartburn”),
gas,
the foul and unpleasant odor from the stools and from the expelled gases (the reeking decomposition which begins in the stomach and continues in the intestine),
the bad breath that grows out of gastro-intestinal fermentation and putrefaction,
acid (sour) eructations (belchings),
mucus flow,
nervousness,
sleepless and unrefreshing nights,
furred tongue in the morning,
absence of desire for food,
constipation,
much foul stools, loose stools, impacted stools, pebbly stools, much foul gas, colitis, hemorrhoids, bleeding with stools from putrefaction occurring in the colon,
etc.; and
(b) wherein the memory means are destined also for receiving and retaining a database of information regarding the user's registered eating manners along with its corresponding the user's marks based upon indigestion symptoms, a posteriori—after eating by the manners, in order to use the information by a more extended algorithm for further digestive marking of that person's eating manners, and where the database is supplemented by the user in the course of time; and
(c) comprising input means for entering the information into the memory.

16. The apparatus according to claim 1, wherein:
(a) the memory means are destined also for storing information regarding:
(i) a biological knowledge database for the illustration, to the user, of the physiological principle: “WHAT to eat is important, but thrice more important is—HOW to eat, what is the way of eating” that is for illustration of digestive enzymes' properties and, in this connection, enzymatic limitation of digestion to the user;
(ii) an algorithm permitting the user to get the biological knowledge in an easy playing manner, and, later on, gradually, inducing the user to live more comfortably by his further self-enlightening in the educational subject “BIOculture of the Individual” and by gradual, bit by bit, switching of the user to his own “BIOcultural Way of Thinking”; and
(b) execution means for executing of the algorithm.

17. The apparatus according to any said claim, wherein:
(a) the memory means are destined also for storing information regarding:
(i) an algorithm for attach the apparatus to the network of similar devices for organization and realization, within the network, of a prize cognitive-entertaining game between the participants, and
(ii) an algorithm of the prize entertaining-cognitive collective game—the algorithm allows, firstly, to determine the completeness and depth of cognition, by the player, the biological knowledge in the memory of the apparatus, secondly, it allows to put marks in a rating system, thirdly, it gives possibility to accumulate rating marks and to choose a winner; and
(b) execution means for executing of the algorithms.

18. A technological method of the making of any said apparatus in the part of preliminary preparing of its internal informative stuffing and in the part of further realization of this stuffing in the making of the apparatus, said method comprising the steps of:
(a) making use of the available information from the “Computerized Global Humanitarian BIOcultural Genetic Public Health” principles as an internal informative stuffing of any demanded apparatus at its production;
(b) restocking and modernizing of this information in the principles in a course of time;
(c) developing and perfecting of these principles by means of the “Computerized Global Humanitarian BIOcultural Genetic Public Health” Internet-site system as a technical means intended specially for realization of the technological method;
(d) making of new models and perfecting of the old models of any claimed apparatus during their production based on more complete and more perfect information from the “Computerized Global Humanitarian BIOcultural Genetic Public Health” principles, being a result of the lower enumerated steps;
(e) publishing of the “Computerized Global Humanitarian BIOcultural Genetic Public Health” principles confirmed by the Editorial board of the Internet-site on its pages to make the principles attainable to anyone user of the Internet;
(f) offering to the visitor of the Internet-site,—wishing to use the “Computerized Global Humanitarian BIOcultural Genetic Public Health” principles for support and recovery of health and having got some individual experience of usage of the principles,—to set questions and to express the requests to professional biologists, physiologists and geneticists;
(g) publishing of the questions and requests of users on the pages of the Internet-site for making these questions and requests attainable for any indicated specialist having an Internet access;
(h) offering to professional biologists, physiologists or geneticists, wishing to answer questions and requests, to formulate and to sent the reply on the Internet-site in the form of the next “Computerized Global Humanitarian BIOcultural Genetic Public Health” principle and necessary authorized comments to it;
(i) analyzing of the replies obtained by the Editorial board of the Internet-site; afterwards the replies worth some peculiar attention are to be additionally reviewed as it is practiced in the academic journals: with the assistance of so called “black opponents” from permanent authors having in the not less than three own publications “Computerized Global Humanitarian BIOcultural Genetic Public Health” Internet-site;
(j) making the final decision, by Editorial Board of the Internet-site, to publish the given reply on Internet-Site pages as a new “Computerized Global Humanitarian BIOcultural Genetic Public Health” principle or not; and
(k) making use of so obtained information for re-formulation of “Computerized Global Humanitarian BIOcultural Genetic Public Health” principles as an internal informative stuffing of any claimed device in its production and further modernization in proper time—thus, with growth and accumulation of this information, and through it, the science and technical art of Computerized Global Humanitarian BIOcultural Genetic Public Health (Health without Health Service) will be developing and perfection will be reached in the production of any claimed apparatus in preparation of its internal informative stuffing.

19. An Internet-site system as the technical means specially intended for realization of the technological method according to claim 18, said the Internet-site system comprising:
(a) a computer having a memory;
(b) a database in the memory for storing information regarding the “Computerized Global Humanitarian BIOcultural Genetic Public Health” principles;
(c) an application program, realizing an algorithm for supporting of the “Computerized Global Humanitarian BIOcultural Genetic Public Health” principles, is destined to provide:
(i) publishing of the “Computerized Global Humanitarian BIOcultural Genetic Public Health” principles, approved by Editorial board of the Internet-site, for making the principles accessible to any person having an Internet access;
(ii) offering to the visitors of the Internet-site wishing to use the “Computerized Global Humanitarian BIOcultural Genetic Public Health” principles for the support and recovery of health (for those having some individual experience of an application of the principles) to set questions and express requests to the professional biologists, physiologists and geneticists;
(iii) publishing of the users' wishes and requests on the Internet-site to make these matters attainable to any indicated specialist having Internet access;
(iv) offering to the biologists, physiologists and geneticists wishing to reply, to formulate and send replies to the Internet-site in a form of the “Computerized Global Humanitarian BIOcultural Genetic Public Health” principle and the authorized comments to them; and
(v) receiving and registration of the replies in the Internet-site.

20. The Internet-site system according to claim 19, comprising also:
(a) an application program realizing an algorithm for organizing and carrying out prize entertainment individual or collective game on the Internet-site to allow the visitors of the Internet-site in easy playing manner to cognize the essence and principles of four closely related educational subjects:
“BIOculture of the Individual”.
“Natural Hygiene”,
“the American Natural Hygienic system”, and
“the science and art of Computerized Global Humanitarian BIOcultural Genetic Public Health (Health without Health Service)”,
and then to elaborate gradually, in the participants of the game, the so-called “BIOcultural Way of Thinking” to induce them for more comfortable living by switching to the Natural Hygienic life-style and diet; and
(b) execution means for executing of the algorithm.
